(19) United States
(12) Patent Application Publication
(10) Pub. No.: US 2004/0049408 A1
(43) Pub. Date: Mar. 11, 2004

(54) Process for reducing the cost associated with the prevention and treatment of pressure ulcers

(76) Inventors: Anne Coble Voss, Columbus, OH (US); Stacy A. Bender, Pickerington, OH (US); Abby S. Cook, Gahanna, OH (US); Kathleen E. Mayer, Columbus, OH (US)

Correspondence Address: ROSS PRODUCTS DIVISION OF ABBOTT LABORATORIES, DEPARTMENT 108140-DS/1, 625 CLEVELAND AVENUE, COLUMBUS, OH, 43215-1724, US

(21) Appl. No.: 09/794,566

(22) Filed: Feb. 27, 2001

Related U.S. Application Data
(60) Provisional application No. 60/186,639, filed on Mar. 3, 2000.

(51) Int. Cl. G06F 17/60

(52) U.S. Cl. 705/3; 705/2

(57) ABSTRACT

A process for reducing the cost associated with providing patient care including the costs associated with the prevention and treatment of pressure ulcers is provided. The process provides for the review of the present status and medical history of a patient, and the presence of one or more triggers is then evaluated. The process then matches each one of the triggers with a plurality of protocols. One or more protocols are then performed, dependent upon each of the triggers matched. The ongoing status of the patient is then monitored to determine any change therein, and the performance of the protocols is correspondingly adjusted. In one aspect of the invention at least a portion of the process is performed by a risk evaluation unit, wherein information associated with the present status, medical history, and ongoing status is supplied thereto. The process further generates a report including an intervention schedule. In another aspect of the invention, data including incidence rates of patients developing a pressure ulcer, costs for treating a pressure ulcer, cost associated with implementing a preventative measure, and an adjustment factor to the incidence rate corresponding to the implementation of the preventative measure is provided in an economic model. The economic model then determines an anticipated change in treatment costs corresponding to the anticipated reduction in pressure ulcers resulting from the implementation of the preventative measure. The economic model then compares the change in treatment costs to the cost of implementing the corresponding preventative measure, and produces the results of the comparison.

This application claims the benefit of U.S. Provisional Application No. 60/186,639, filed Mar. 3, 2000.

### FIELD OF THE INVENTION

The invention pertains to a process for reducing the cost and increasing the quality associated with providing patient care. More specifically, the invention pertains to a process for reducing the costs associated with the prevention and treatment of pressure ulcers.

### BACKGROUND OF THE INVENTION

Pressure ulcers are defined as localized areas of tissue necrosis that develop when soft tissue is compressed between a bony prominence and an external surface for a prolonged period of time. Millions of dollars are spent each year on pressure ulcer prevention and management. In fact at least one source, Bergstrom et al., Pressure Ulcer Treatment, Clinical Practice Guideline No. 15, published by the U.S. Department of Health and Human Services, Public Health Service, Agency for Health Care Policy and Research, AHCPR Publication No. 95-0652, states that over one million people will develop pressure ulcers each year. Furthermore it has been estimated, that the national cost associated with the treatment of pressure ulcers is approximately 1.335 billion dollars per year, Miller et al., Cost Implications of the Pressure Ulcer Treatment Guideline, Center for Health Policy Studies. In addition to being expensive to treat, pressure ulcers also contribute to varying degrees of discomfort, as well as increased susceptibility to other ailments, such as infection.

Many factors or indicators have been linked to an individual's increased or decreased likelihood of developing a pressure ulcer. Individuals who can be attributed with a number of positive indicators, are identified as being at-risk. As people age or suffer varying degrees of decreased mobility they tend to exhibit more of the factors which would identify them as being at-risk. Consequently, a high percentage of at-risk individuals can be found in assisted living or long-term care facilities.

One of the difficulties in pressure ulcer prevention lies in the fact that pressure ulcer prevention has often been based on clinical judgement, intuition and/or expert opinion. In many instances standard procedures for preventing pressure ulcers have not been established within a given facility. Consequently, patient care not only varies between facilities, but often varies between caregivers within a given facility. As a result, the specific incidence rate of developing pressure ulcers for patients of a particular assisted living or long-term care facility can vary.

Some long-term care facilities have reported prevalence rates as low as 2.4 percent, (Peterson et al., The epidemiology of pressure sores, Scandinavian Journal of Plastic and Reconstructive Surgery and Hand Surgery, 1971, 5:62-66). Other facilities have reported rates as high as 23 percent, (Langemo et al., Incidence of pressure sores in acute care, rehabilitation, extended care, home health, and hospice in one locale, Decubitus, 1989, 2:42). Incidence rates ranging as high as 24 percent have been reported, (Bergstrom et al., Multi-site study of incidence of pressure ulcers and the relationship between risk level, demographic characteristics, diagnoses, and prescription of preventative interventions, Journal of the American Geriatrics Society, 1996, 44:22-30). As a result, certain preventative measures designed to decrease the risk of developing pressure ulcers for different long-term care facilities will have a varying impact.

However despite having varying effects, pressure ulcer preventative measures, in addition to reducing a patient's susceptibility of developing pressure ulcers, often have the added benefit of reducing the severity of a pressure ulcer and/or reducing the time required for recovery from a pressure ulcer, when a pressure ulcer does occur. One estimate generally identifies a reduction of 20 percent in healing times due to the implementation of nutrition support, Van Risjwijk et al., Predictors of time to healing deep pressure ulcers, Ostomy/Wound Management, 1994, 40:40-48.

These and other benefits must be weighed against the cost associated with implementing the preventative measures, including the cost of the resources devoted to implementing the preventative measure and the increased level of intrusiveness for the patient. While most pressure ulcers are preventable, in some instances it is unrealistic or may be in conflict with the overall plan of care to subject a patient to aggressive preventative measures. Furthermore even in facilities where aggressive preventative measures are practiced, there is no guarantee that pressure ulcers will not occur. At some point the costs associated with implementing additional preventative measures, to both the patient and the facility, will outweigh the benefits of the corresponding reduction in the probability of developing a pressure ulcer.

Consequently, it would be beneficial to develop a process by which the change in costs for the overall treatment and prevention of pressure ulcers for a particular preventative measure can be predetermined with a reasonable degree of accuracy prior to actual implementation of the measure. Furthermore it would be beneficial to develop a process, which includes a straight forward decision tree that can be implemented universally for the prevention of pressure ulcers, and which maintains a high level of care while reducing the cost associated with maintaining the high level of care. Still further, a structured process which selectively administers one or more of a plurality of protocols, dependent upon the corresponding triggers present in a particular patient, would similarly be beneficial.

### SUMMARY OF THE INVENTION

A process for reducing the cost associated with providing patient care including the costs associated with the prevention and treatment of pressure ulcers is provided. The process provides for the review of the present status and medical history of a patient, and the presence of one or more triggers is then evaluated. The process then matches each one of the triggers with a plurality of protocols. One or more protocols are then performed, dependent upon each of the triggers matched. The ongoing status of the patient is then monitored to determine any change therein, and the performance of the protocols is correspondingly adjusted.

In one aspect of the invention at least a portion of the process is performed by a risk evaluation unit, wherein information associated with the present status, medical history, and ongoing status is supplied thereto. The process further generates a report including an intervention schedule.

In another aspect of the invention, a process for reducing the cost associated with providing patient care including the costs associated with the prevention and treatment of pressure ulcers is provided. Data including incidence rates of patients developing a pressure ulcer, costs for treating a pressure ulcer, cost associated with implementing a preventative measure, and an adjustment factor to the incidence rate corresponding to the implementation of the preventative measure is provided in an economic model. The economic model then determines an anticipated change in treatment costs corresponding to the anticipated reduction in pressure ulcers resulting from the implementation of the preventative measure. The economic model then compares the change in treatment costs to the cost of implementing the corresponding preventative measure, and produces the results of the comparison.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 is a flow diagram illustrating a process for reducing the cost associated with providing patient care including the cost associated with the prevention and treatment of pressure ulcers in accordance with the present invention;

FIG. 2 is a flow diagram illustrating a nutrition management protocol for use in the process of FIG. 1;

FIGS. 2A-2C illustrate a suitable form for use in the management and record keeping of the patient's progress in regards to the nutrition management protocol illustrated in FIG. 2;

FIG. 3 is an alternative nutrition management protocol to the nutrition management protocol illustrated in FIG. 2, which additionally incorporates the use of an anabolic steroid, for use in the process of FIG. 1;

FIGS. 3A-3C illustrate a suitable form for use in the management and record keeping of the patient's progress in regards to the nutrition management protocol (w/anabolic steroid) illustrated in FIG. 3;

FIG. 4 is a flow diagram illustrating an incontinence prevention protocol for use in the process of FIG. 1;

FIG. 4A illustrates a suitable form for use in the management and record keeping of the patient's progress in regards to the incontinence prevention protocol, illustrated in FIG. 4;

FIG. 5 is a flow diagram illustrating an incontinence management protocol for use in the process of FIG. 1;

FIGS. 5A-5E illustrate a suitable form for use in the management and record keeping of the patient's progress in regards to the incontinence management protocol illustrated in FIG. 5;

FIG. 6 is a flow diagram illustrating a pressure management protocol for use in the process of FIG. 1;

FIGS. 6A-6B illustrate a suitable form for use in the management and record keeping of the patient's progress in regards to the pressure management protocol illustrated in FIG. 6;

FIG. 7 is a flow diagram illustrating an economic model;

FIG. 8 is an isometric view of a system on which at least portions of the process and corresponding protocols, illustrated in FIGS. 1-6, can be performed, and at least portions of an economic model, illustrated in FIG. 7, can be performed; and

FIG. 9 is a schematic diagram illustrating the system illustrated in FIG. 8.

### DETAILED DESCRIPTION OF THE PREFERRED EMBODIMENTS

While this invention is susceptible of embodiment in many different forms, there are shown in the drawings and will be described herein in detail specific embodiments thereof with the understanding that the present disclosure is to be considered as an exemplification of the principles of the invention and is not intended to limit the invention to the specific embodiments illustrated.

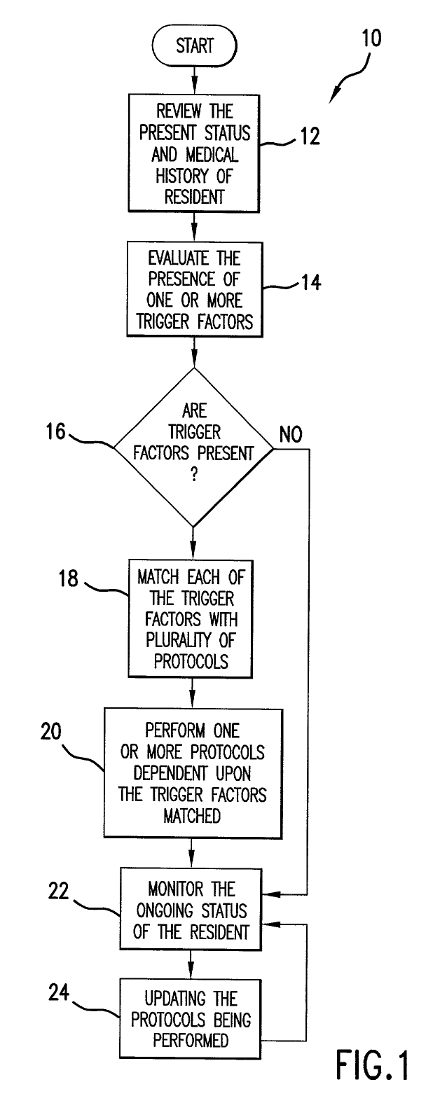

FIG. 1 illustrates a flow diagram of a process 10 for reducing the cost associated with providing patient care including the cost associated with the prevention and treatment of pressure ulcers in accordance with the present invention. Specifically, the process 10 includes an initial review 12 of all new patients including the patient's present status and medical history. The patient is then evaluated 14 for the presence of one or more risk factors for pressure ulcer development. A determination 16 is then made as to whether the triggers for the specific protocols are present.

If triggers are present, the triggers are matched 18 with one or more of a plurality of protocols, and the protocols which are matched are then performed 20. The specific protocols are targeted to address the triggers present. In this way, additional care can be targeted to the patients who are likely to have a positive response or receive a benefit from the additional care. Furthermore, additional care can be more closely tailored to the specific needs of the patient, and to those areas where they are likely to have the greatest beneficial impact.

The ongoing status of the patient is then monitored 22, with changes in the patient's status noted. In the event the status of the patient changes, the protocols being performed 20 are adjusted 24 as necessary.

As noted above, past efforts for pressure ulcer prevention have often been based on clinical judgement, intuition and/or expert opinion. Furthermore previous guidelines for pressure ulcer prevention have largely been based on expert opinion and/or panel consensus. In contrast thereto, the present process was developed using research-based evidence. Much of the research-based evidence was collected as part of the National Pressure Ulcer Long-term Care Study (NPULS). In connection with the study, 110 long-term care facilities participated, and data was collected for 2,490 adult patients, who where either at-risk of developing a pressure ulcer or had an existing pressure ulcer. Over 500 patient, treatment and outcome characteristics were obtained for each patient over a 3-month period.

As a result of the review of the data collected in connection with the study, several trends were not only identified, but also quantified. Based upon the review of the data collected from the study, triggers were identified and specific prevention protocols developed. Examples of some of the trends which were determined from the study as identifying a patient as being more or less likely to develop a pressure ulcer are noted below.

Trends which identify a patient as being more likely to develop a pressure ulcer include the following.

(1) Males are 40 percent more likely to develop a pressure ulcer than females. One explanation identifies a trend in male patients, where male patients tend to be older and/or more debilitated than female patients, when they enter a long-term care facility.

(2) Patients who are 85 years or older are 30 percent more likely to develop a pressure ulcer. As noted previously, as patients age they tend to suffer decreased mobility and exhibit more of the factors, which identify them as being at-risk for developing a pressure ulcer.

(3) Patients with a history of tobacco use are 76 percent more likely to develop a pressure ulcer. Tobacco use has been associated with impaired circulation which can contribute to increased risk of developing pressure ulcers.

(4) Patients with a recent history of a pressure ulcer in the past ninety days are 187 percent more likely to develop a pressure ulcer. Patients who have had a previous pressure ulcer have weaker skin integrity where the pressure ulcer was located, so that area of the skin is prone to future skin breakdown.

(5) Patients who are dependent or require extensive assistance in seven or more activities of daily living, including locomotion, transfer, bed mobility, dressing, eating, toilet use, and bathing, are 38 percent more likely to develop a pressure ulcer. The degree of assistance required for activities of daily living are probable risk factors for pressure ulcer development since they are associated with mobility, pressure, nutrition, and/or incontinence.

(6) Patients with diabetes are 67 percent more likely to develop a pressure ulcer. Patients with diabetes often have impaired circulation, which as noted above in connection with tobacco use, can contribute to an increased risk of developing pressure ulcers.

(7) Patients with significant recent weight loss (greater than or equal to five percent in the last thirty days, or greater than or equal to ten percent in the last one hundred and eighty days) are 74 percent more likely to develop a pressure ulcer. Patients with weight loss often have a compromised nutritional status which can lead to an increased risk of developing pressure ulcers.

(8) Patients with signs and symptoms of dehydration are 42 percent more likely to develop a pressure ulcer. Patients with dehydration have decreased oxygen transport to the tissues and likely also have decreased nutritional status, which contribute to an increased risk of developing pressure ulcers.

(9) Patients who use mechanical devices for urine containment for fourteen days or more are 103 percent more likely to develop a pressure ulcer. One explanation is that patients with catheters are turned and repositioned less frequently than recommended, which can lead to pressure injury and increased risk of developing pressure ulcers. They are also more likely to develop infections, which contribute to a general decline in the patient's overall health.

(10) Patients who use static pressure reduction devices for fourteen days or more are 51 percent more likely to develop a pressure ulcer. Use of protective devices may be improper or may discourage other preventative measures from being taken. Furthermore, patients who use these devices often already have signs of early skin breakdown, which likely prompted the use of the device initially.

(11) Patients who are missing documentation in the cognitive assessment questions of the Minimum Data Set (MDS) were 67 percent more likely to develop a pressure ulcer. One explanation identifies patients with missing documentation regarding cognitive impairment as not being monitored as carefully as they should be. Furthermore, the patient may have cognitive impairment which can lead to an increased risk of developing pressure ulcers due to limited mobility, decreased oral intake, etc.

(12) Patients who are missing documentation regarding diet type were 147 percent more likely to develop a pressure ulcer. Similar to patients missing documentation regarding the MDS cognitive assessment questions, patients with missing documentation of diet type may also not be monitored as carefully as they should be, and may have a compromised nutritional status, which can lead to an increased risk of developing pressure ulcers.

Trends which identify a patient as being less likely to develop a pressure ulcer include the following.

(1) Patients with fluid orders including increased fluids, thickened liquids (dysphagia) or IV liquids, are 35 percent less likely to develop a pressure ulcer. Patients who are receiving fluid orders are more likely to be receiving adequate fluid intake, which insures skin hydration and helps prevent skin breakdown and pressure ulcers.

(2) Patients who are on standard medical nutritional supplements (e.g. ENSURE®) for twenty-one days or more are 63 percent less likely to develop a pressure ulcer. Patients who are receiving standard medical nutritional supplements are receiving additional calories, protein, vitamins and minerals, which can improve their nutritional status and help prevent skin breakdown and pressure ulcers.

(3) Patients who receive a snack (e.g. cheese and crackers) for twenty-one days or more are 49 percent less likely to develop a pressure ulcer. Patients who are receiving snacks are similarly receiving additional calories, proteins, vitamins and minerals, that can improve their nutritional status and help prevent skin breakdown and pressure ulcers.

(4) Patients who are on house shakes (e.g. a milk shake) for twenty-one days or more are 28 percent less likely to develop a pressure ulcer. Similar to patients who are receiving standard medical nutritional supplements and snacks, patients who receive house shakes are similarly receiving additional calories, proteins, vitamins and minerals that can improve their nutritional status and help prevent skin breakdown and pressure ulcers.

(5) Patients who are on high calorie/high protein (e.g. TWOCAL HN®, ENSURE PLUS®) or disease specific (e.g. GLUCERNA®, NEPRO®) enteral feeding for twenty-one days or more are less likely to develop a pressure ulcer (88 percent less likely for those patients receiving disease specific formula, 72 percent less likely for those patients receiving high calorie/high protein formula). Patients who are receiving high calorie/high protein or disease specific enteral feeding are more likely to be receiving adequate calories, protein, fluid and other nutrients, which insures skin hydration and good nutritional status, and helps prevent skin breakdown and pressure ulcers.

(6) Patients who use disposable briefs for fourteen days or more are 40 percent less likely to develop a pressure ulcer. Patients with disposable briefs are more likely to be turned at the recommended times during the day, since their brief has to be changed, which can help prevent pressure injury and exposure to moisture which are risk factors for developing pressure ulcers.

(7) Patients who are on antidepressants are 38 percent less likely to develop a pressure ulcer. Patients on antidepressants are generally more mobile (more active and not just lying in bed), eating better and in a better state of mind, which can help prevent pressure injury and poor nutritional status which are risk factors for developing pressure ulcers.

(8) Patients who are in facilities with registered nurse hours to patient per day ratios of 0.25 or more are 40 percent less likely to develop a pressure ulcer. The more time the registered nurse is able to spend with the patient, the more likely the patient is receiving adequate and appropriate care including pressure ulcer prevention interventions and techniques (e.g. turning).

(9) Patients who are in facilities with certified nursing assistant hours to patient per day ratios of two or more are 45 percent less likely to develop a pressure ulcer. The more time the certified nursing assistant is able to spend with the patient, the more likely the patient is receiving adequate and appropriate care including pressure ulcer prevention interventions and techniques (e.g. help with eating).

From the data collected, three targeted pressure ulcer prevention protocols were developed. Specifically, a nutrition management protocol, an incontinence protocol including both an incontinence prevention protocol and an incontinence management protocol, and a pressure management protocol were developed. The nutrition management protocol is directed to treating patients at-risk of experiencing compromised nutritional status. The incontinence prevention protocol is directed to treating patients at-risk of developing incontinence. The incontinence management protocol is directed to treating patients once they are incontinent. The pressure management protocol is directed to treating patients at-risk for experiencing prolonged physical contact with at least one portion of their body against a hard surface.

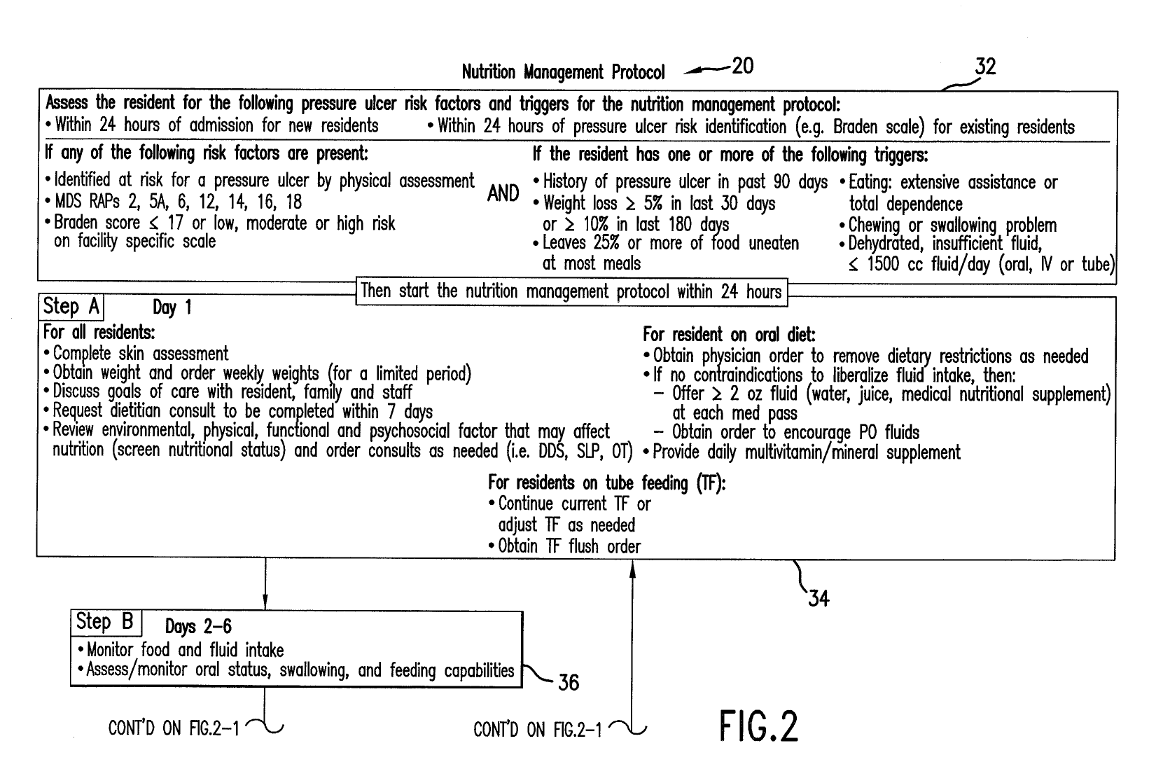

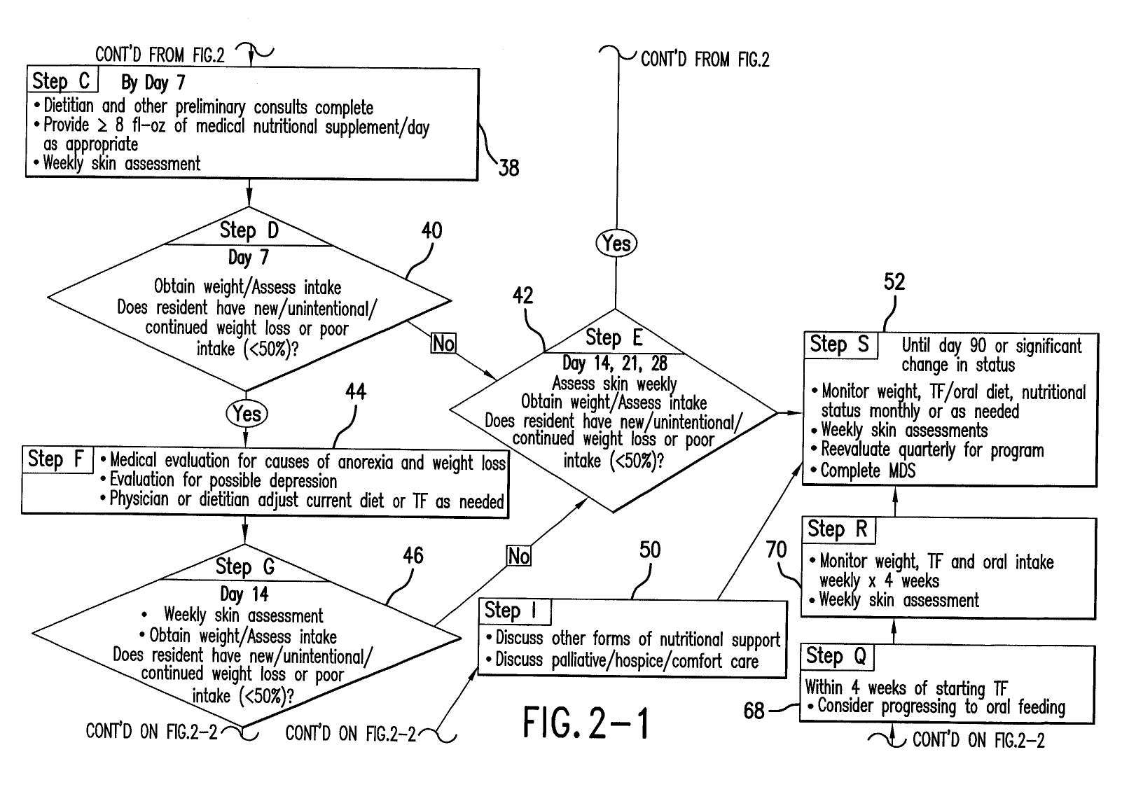

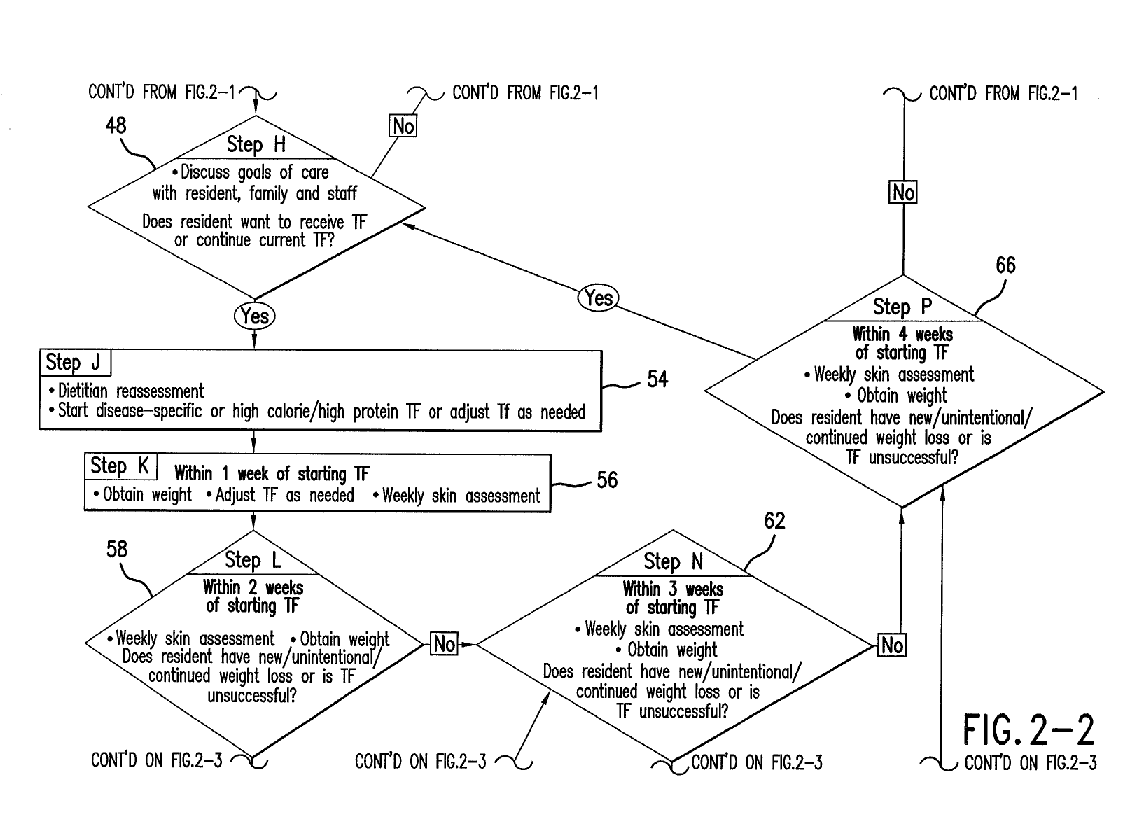

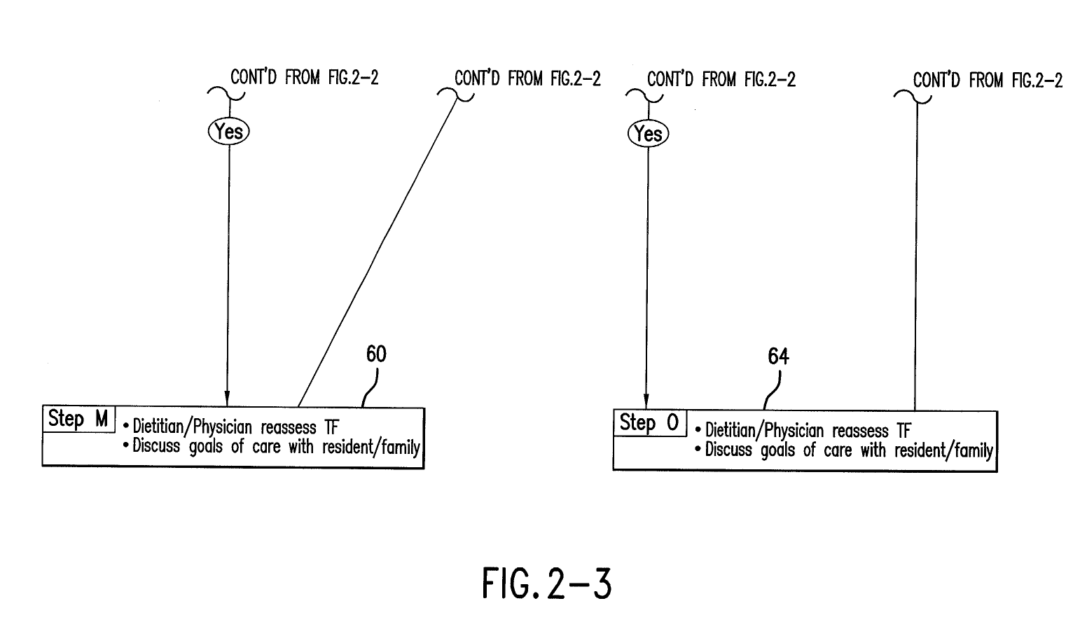

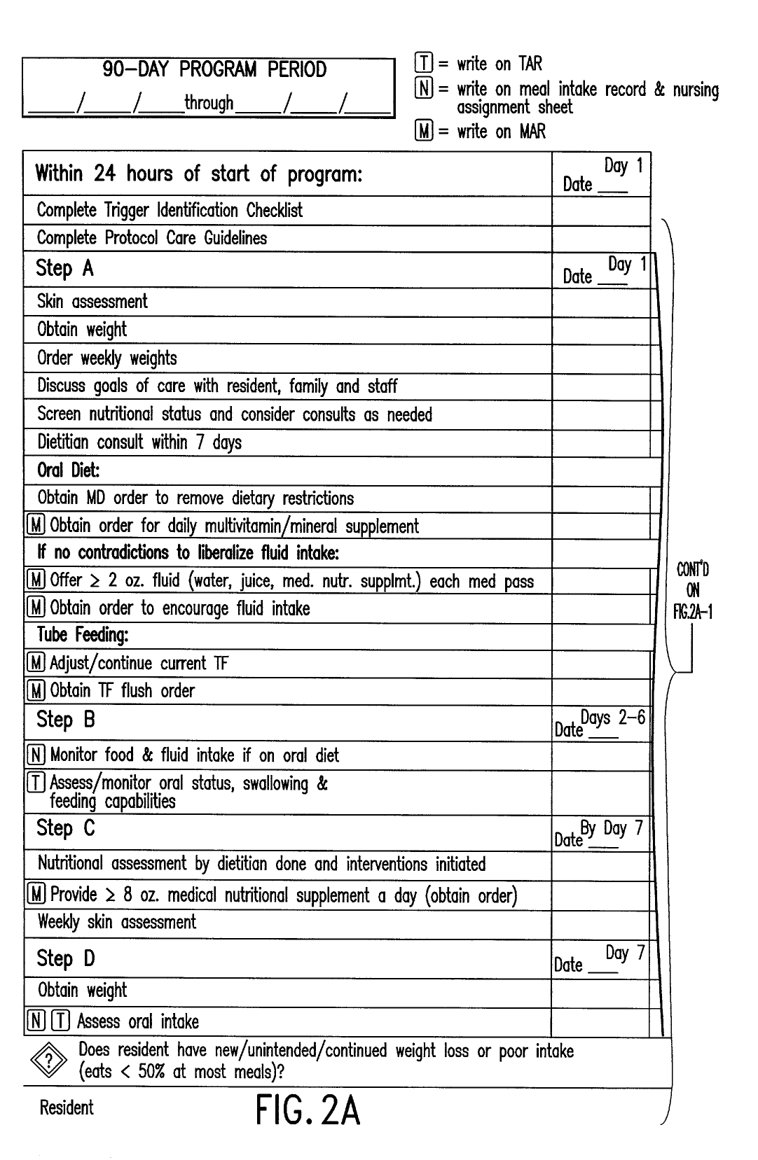

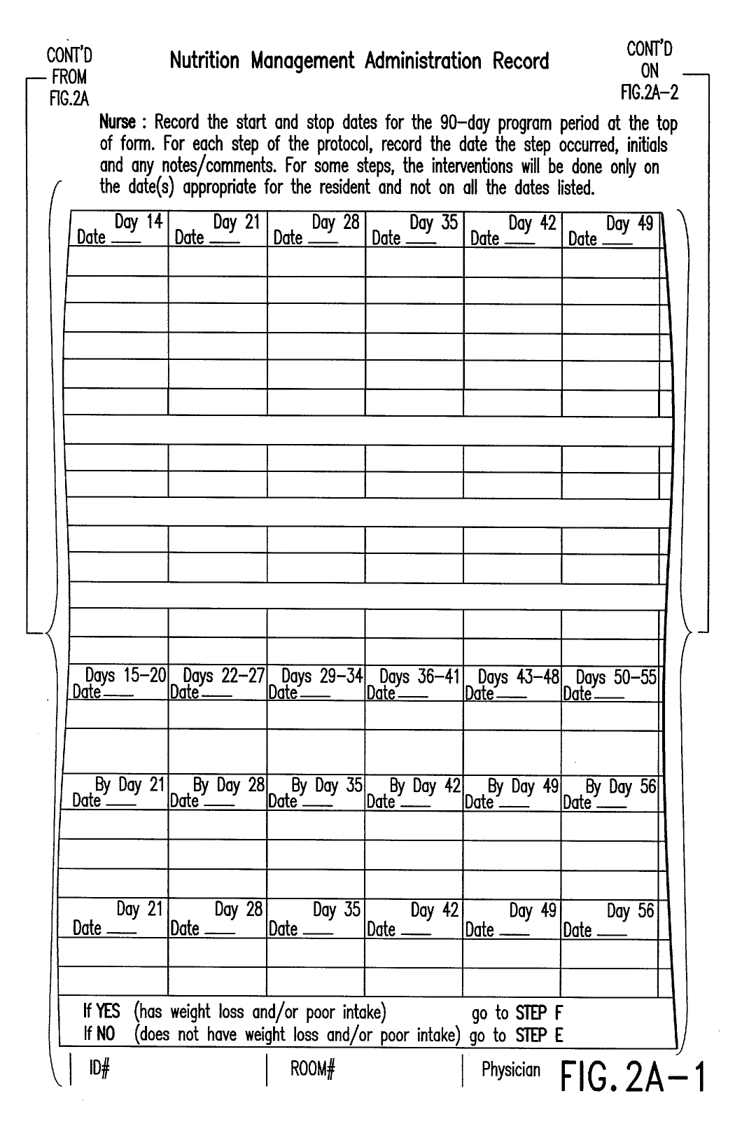

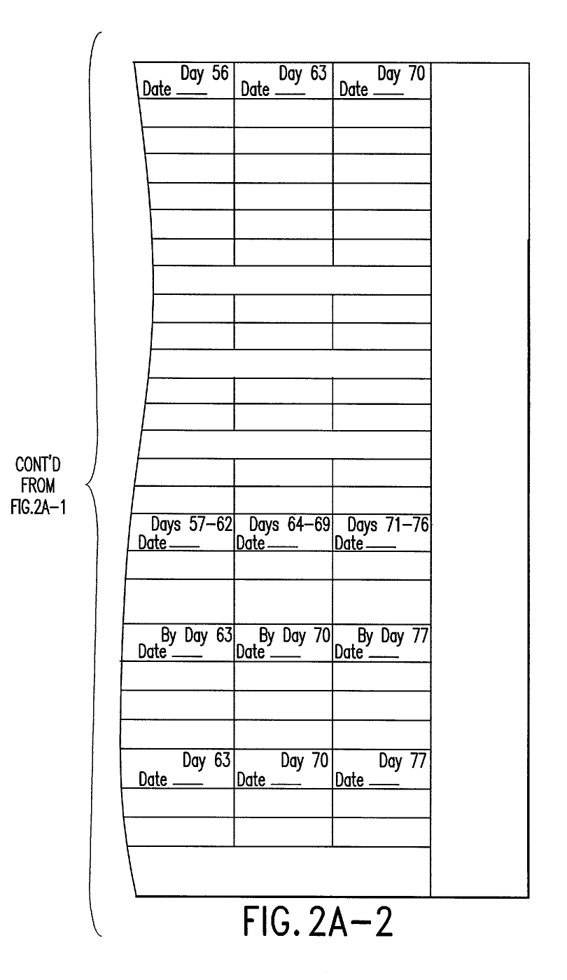

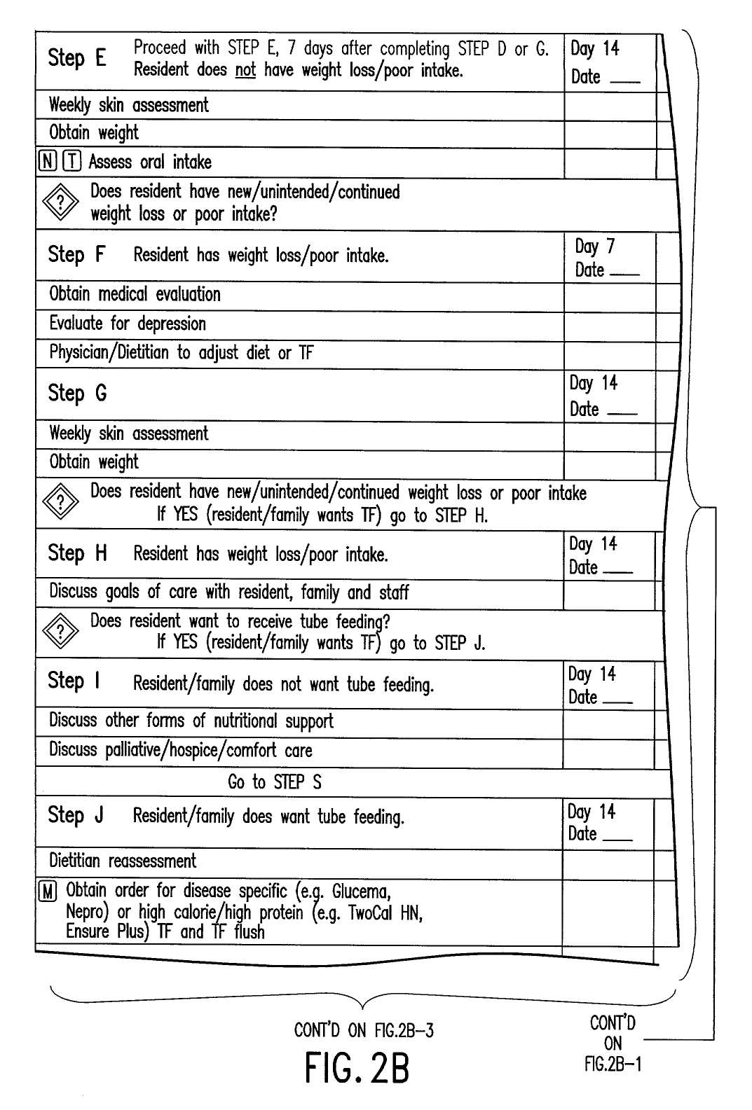

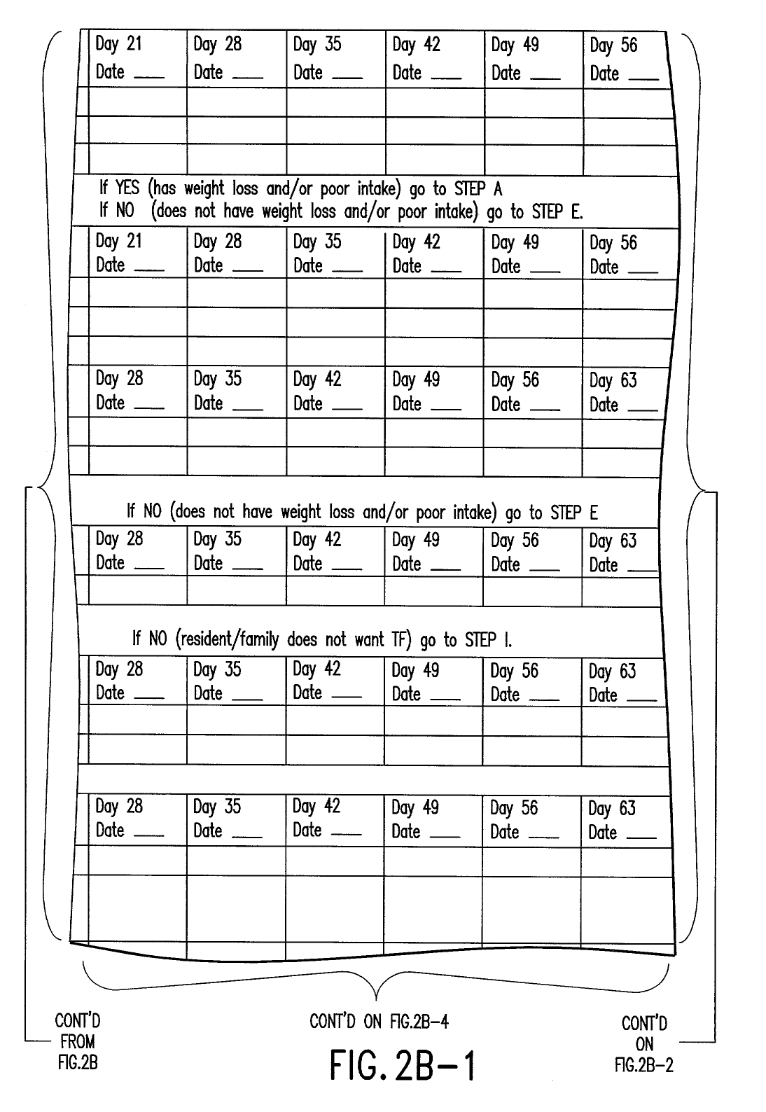

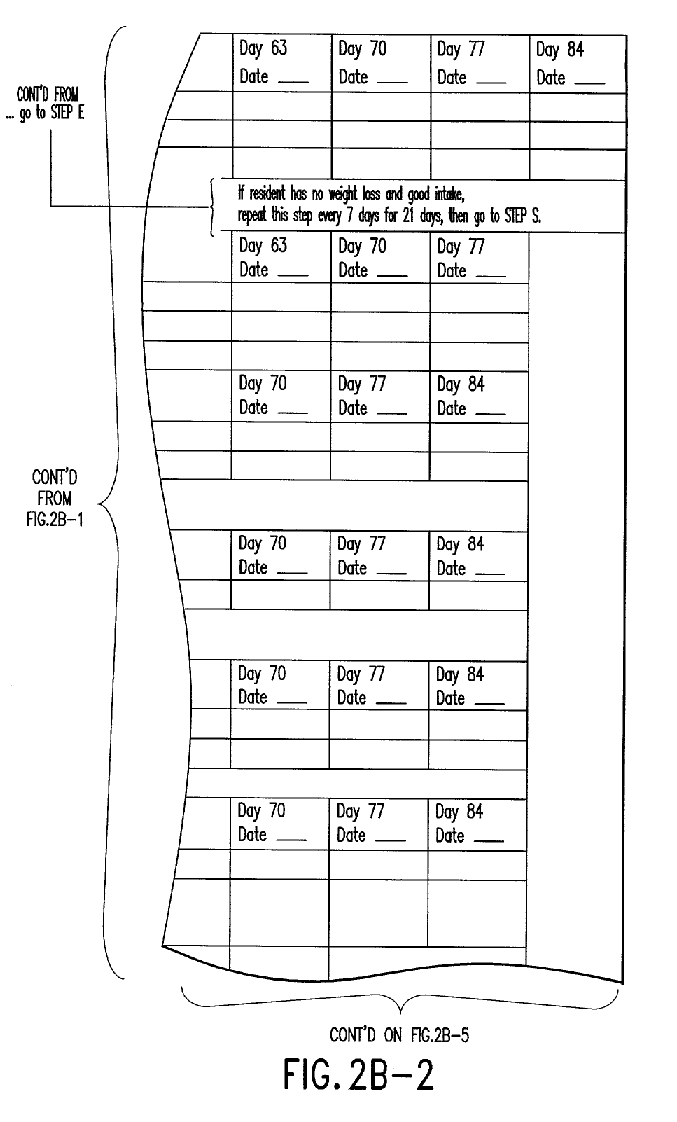

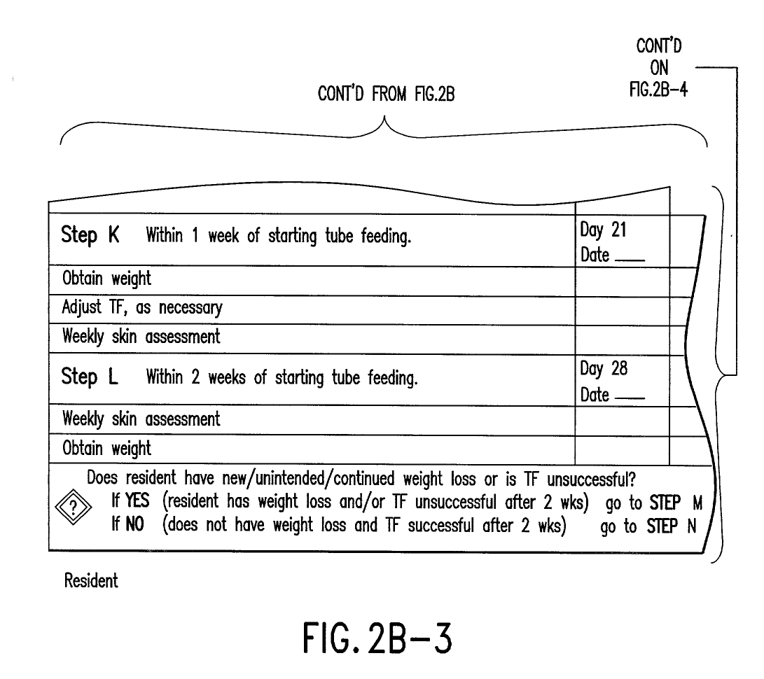

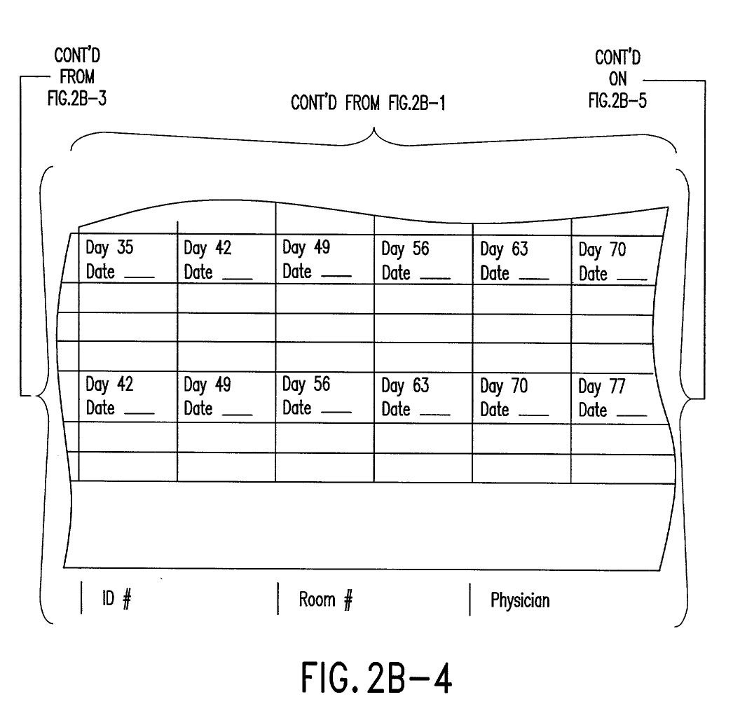

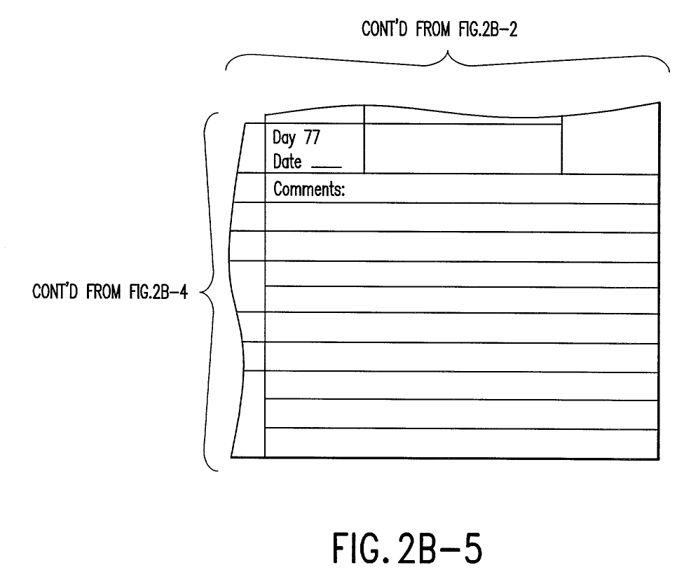

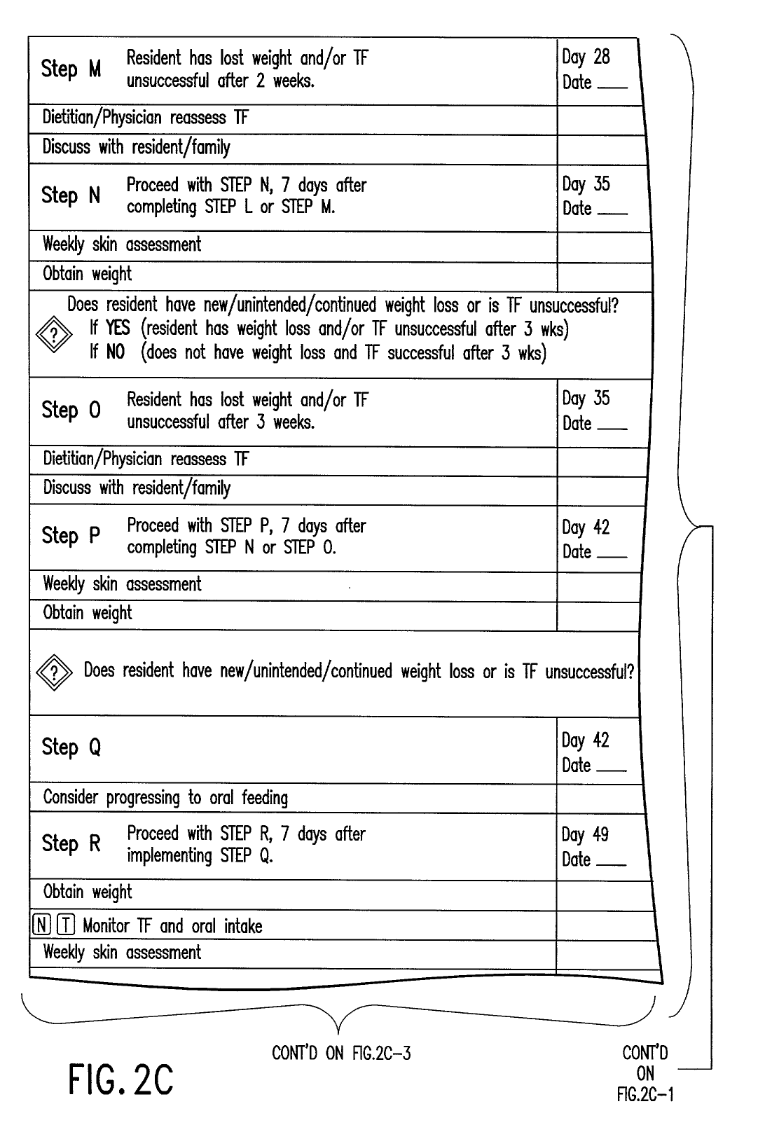

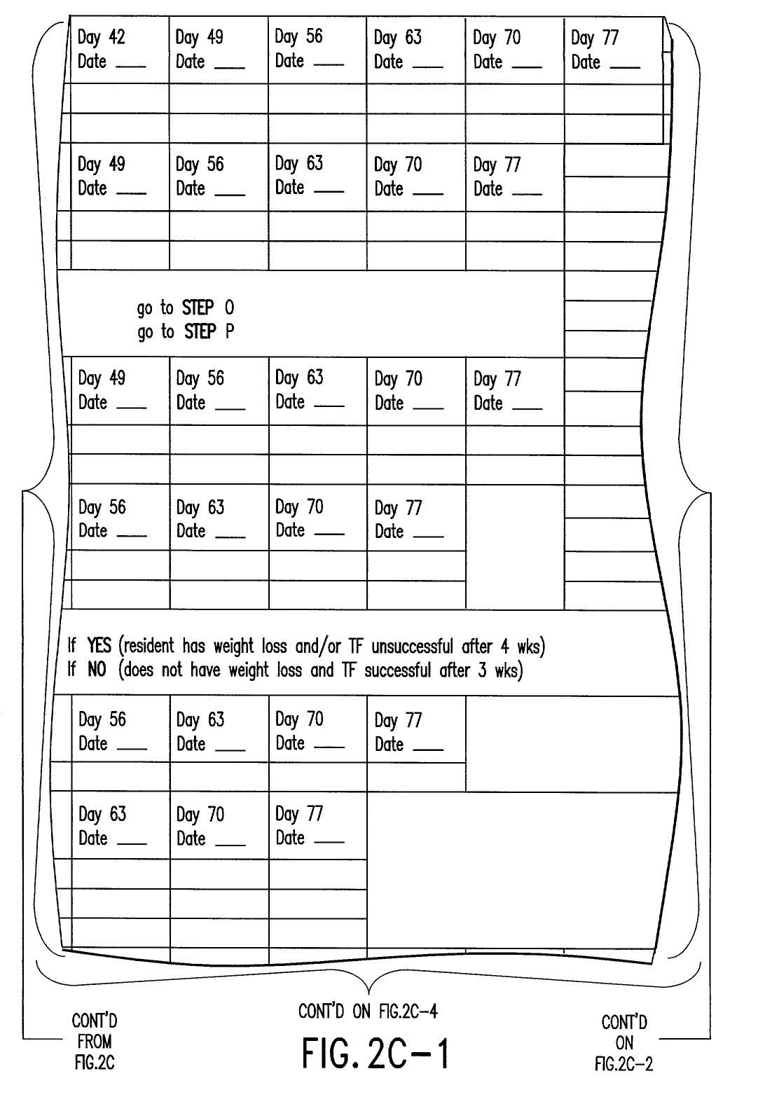

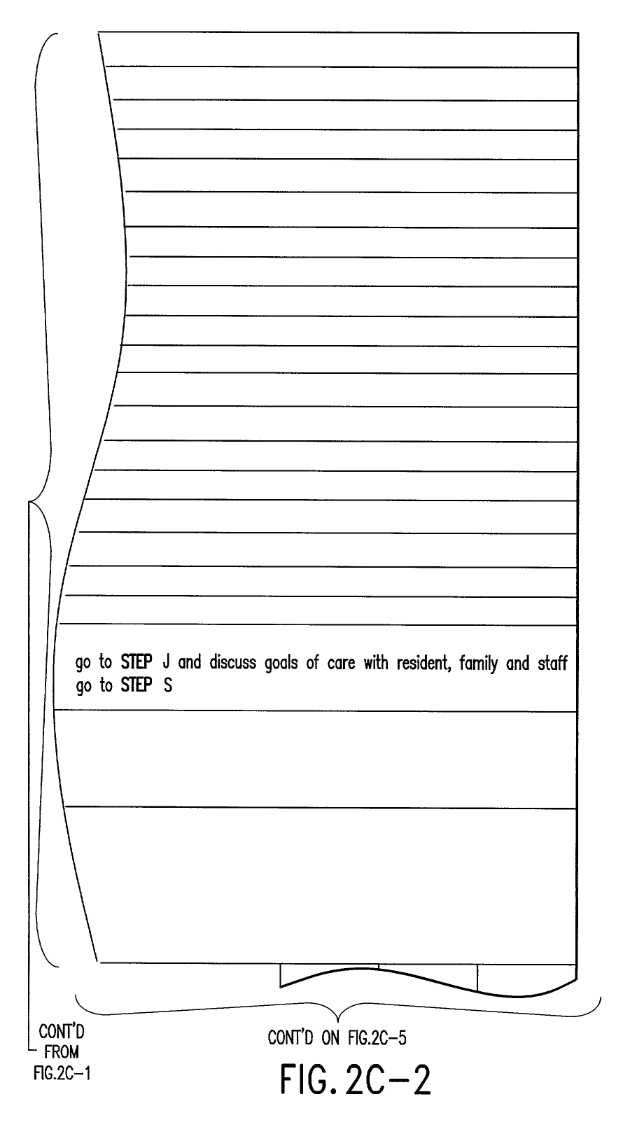

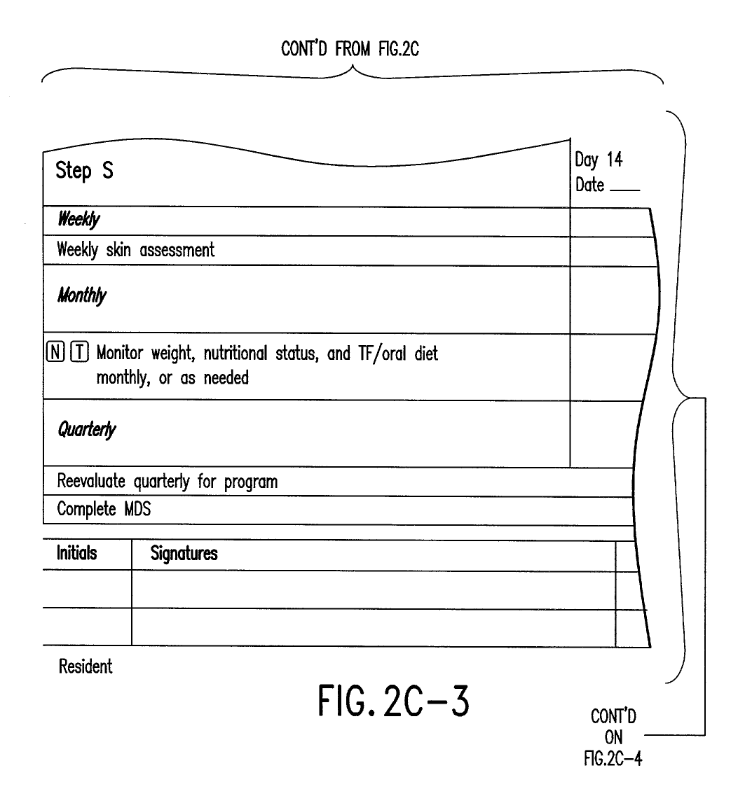

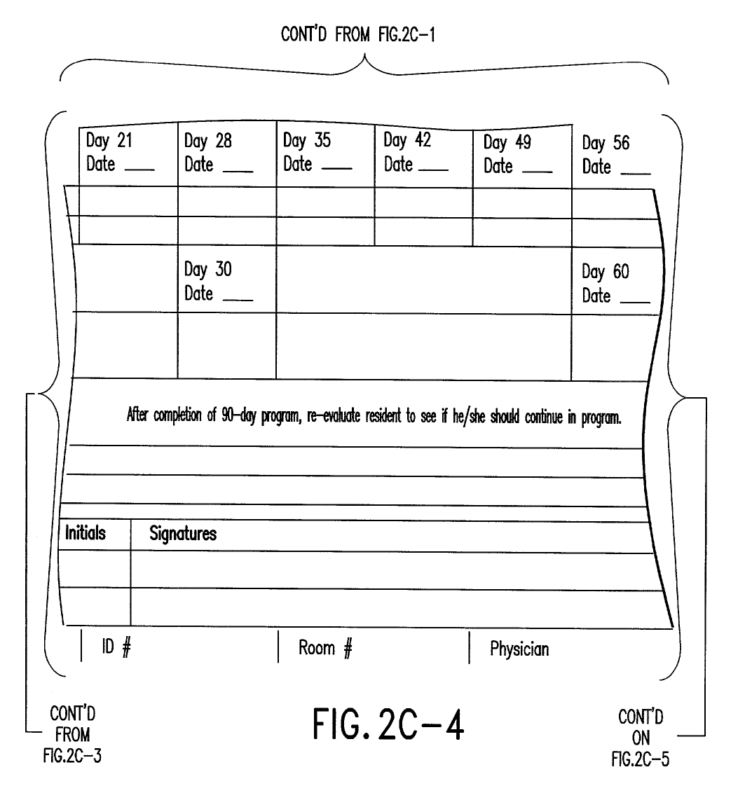

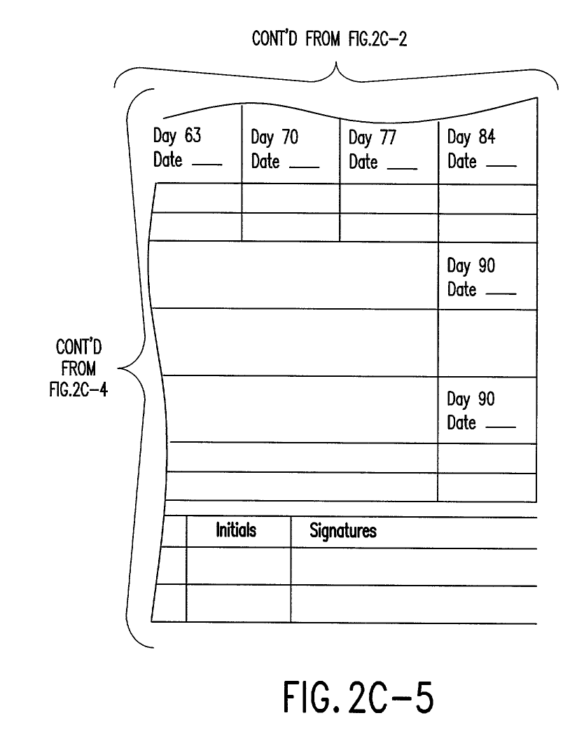

A set of triggers have also been identified for each of the prevention protocols, which identify when each of the protocols should be selectively implemented in connection with a particular patient's care. The three prevention protocols are illustrated and explained in greater detail in connection with FIGS. 2-6.

FIG. 2 illustrates a flow diagram of a nutrition management protocol 30 for the prevention of pressure ulcers. The nutrition management protocol is directed towards maintaining adequate nutritional status by providing proper dietary and fluid intake, wherein a certain minimal nutritional intake is required for maintaining healthy tissue and/or repairing damaged tissue. In connection with the nutrition management protocol 30, the specific nutrition triggers for each patient are defined to include: (1) a recent history of having had a pressure ulcer; (2) weight loss of five percent or more in the last 30 days, or ten percent or more in the last 180 days; (3) leaves twenty-five percent or more food uneaten at most meals; (4) requires extensive assistance during eating; (5) has chewing or swallowing problems; and/or (6) is dehydrated. Initially, the protocol provides for the examination 32 of the patient and their medical history, within 24 hours of admission, for the presence of one or more of the triggers.

A patient may be having difficulty chewing food due to mouth pain, oral infections, missing teeth, ill-fitting dentures, jagged or broken teeth or fillings, or loose teeth. Signs and symptoms of a swallowing problem may include patient drooling, choking or coughing during or after meals including a moist cough after eating or drinking. Further symptoms include an inability of the patient to suck from a straw, pocketing of food in their cheek area, lack of a gag reflex, or gurgly voice quality. Still further symptoms include chronic upper respiratory infection, weight loss, or anorexia.

A dehydrated patient generally has a daily fluid intake which is less than 1500 cc of fluid per day.

If one or more of the nutrition triggers are present the patient is started 34 on the nutrition management protocol. Within 24 hours of starting the patient on the nutrition management protocol an initial skin assessment of the patient is made; goals are discussed with the patient, the patient's family, and staff; the present weight of the patient is obtained; consultation with a registered dietitian is requested for completion within the first seven days; and a review is made of environmental, physical, functional, and psychosocial factors.

An initial skin assessment generally includes reviewing the patient's skin and documenting skin color; skin temperature; skin turgor; discomfort over bony prominences; skin integrity; red, discolored or darkening skin areas; blisters; dry or rough skin; scabs; breaks or sores on the skin; drainage or puss; pain or soreness; swelling anywhere on the body; excessive moisture; and/or incontinence. If skin integrity is impaired the caregiver should document location of the impairment, depth of the impairment, size of the impairment, sinus tracks, undermining, tunneling, exudate, necrotic tissue, and/or presence of granulation tissue. The skin assessment is generally performed by a registered nurse or a licensed practical nurse.

The goals of patient care are discussed to insure that any treatment or interventions meet with the wishes of the patient and his or her family. Determining the patient's wishes includes consideration of any advanced directive, living will, and/or durable power of attorney for health-care.

Determining the patient's weight will provide a baseline against which future weight measurements can be compared. Tips for weighing patients include having the same caregiver perform the weight measurements of the patient, use of a properly calibrated scale, use of the same scale, having the patient wear the same amount of clothing every time, weighing the resident at the same time of day, and weighing the resident after toileting, if possible.

A consultation with a registered dietitian is necessary to assess the patient's current nutritional status, to recommend nutritional interventions, and develop a nutritional care plan for the patient.

A review of the patient's environmental, physical, functional and psychosocial factors is also beneficial to determine what additional items may be influencing nutritional status.

Examples of environmental factors include whether the patient is adapting to living in the facility, whether the patient has difficulty eating in a noisy dining room, or whether the patient likes the type of food served or the other patients they eat with.

Examples of physical factors include whether the patient has a medical condition that impairs their ability to eat or absorb nutrients from the food, whether the patient has trouble chewing or swallowing, whether the patient has mouth pain or soreness that impairs eating, or whether the patient is taking medication which affects their nutritional status.

Examples of functional factors include whether the patient has an impaired ability to eat or drink, or whether the patient has an impaired ability to feed themself.

Examples of psychosocial factors include whether their desire to eat has been affected as a result of dealing with their diagnosis, placement in the facility or family issues, or whether they are consciously refusing to eat due to their feelings about being institutionalized.

Sometimes it may be necessary to consult other specialists including dentists, speech language pathologists and occupational therapists, in reviewing the environmental, physical, funtional, and psychosocial factors.

A dentist should be consulted if the patient exhibits signs and symptoms of mouth sores, mouth pain, dry mouth, missing teeth, ill-fitting dentures, jagged or broken teeth or fillings, loose teeth, beefy red tongue, gum redness, bleeding gums, cracking and/or fissures, smooth tongue, oral infections, chewing and/or swallowing difficulties, poor oral hygiene, pain or clicking in the jaw.

A speech language pathologist should be consulted if the patient exhibits signs and symptoms of drooling, choking, coughing during or after meals, inability to suck from a straw, pocketing of food in the cheek area (the patient may not be aware of doing this), lack of a gag reflex, chronic upper respiratory infection, weight loss, anorexia, gurgly voice quality, moist cough after eating or drinking, complains of difficulty in swallowing, and/or complains of dry or painful mouth/throat.

An occupational therapist should be consulted if the patient is having difficulty eating, drinking, or feeding himself or herself. Difficulties with self-feeding may be due to limb weakness, poor body positioning, neglect, confusion, a neurologic or muscle deficit that prevents the patient from moving food from the utensil to the mouth, and/or physical limitations such as arthritis, paralysis, or vision problems.

For patients on an oral diet, the start of the nutrition management protocol further includes consulting with a physician to place the patient on the least restrictive diet possible (e.g. remove any calorie restrictions or any sodium restrictions). If no contraindications to liberalizing fluid intake exist, the periodic consumption of additional fluids should be encouraged, and a multivitamin/mineral supplement 34 should be provided.

Encouraging additional fluid consumption includes offering greater than or equal to two ounces of fluid at each medication pass. The patient should be provided with water or juice if extra hydration is required, and be provided with a medical nutritional supplement if the resident needs extra nutrition. In some instances a written order from the physician encouraging fluid intake is desirable. The recommended fluid intake levels should equal 30 cc of fluid per kilogram of body weight or at least 1500 cc of fluid per day.

For patients on tube feeding, current tube feeding may be continued. An investigation into the possibility of a better tube feeding product including any disease specific or high calorie/high protein tube feeding products should also be performed. Tube feeding should provide 30-35 calories and 1.25-1.5 grams of protein per kilogram of body weight per day. Additionally to insure proper hydration, a water flush order should be obtained. The recommended fluid intake levels should equal 30 cc of fluid per kilogram of body weight or at least 1500 cc of fluid per day.

During the next 2-6 days, while continuing to administer the nutrition management protocol, the fluid and food intake of the patient is monitored, as well as the oral status, swallowing, and feeding capabilities of the patient 36. By day 7, the preliminary assessments should be verified as complete, including the assessment by the registered dietitian, while daily medical nutritional supplements are provided as appropriate; and weekly skin assessments and weekly weight measurements are performed 38. A daily medical nutritional supplement could include eight ounces or more of the standard oral medical nutritional supplement each day or as appropriate to provide extra nutrition to meet the nutritional needs of the patient and to help prevent skin breakdown.

A determination is then made in connection with the patient's weekly weight measurement and present food intake 40. If no new, unintentional or continued weight loss occurs, and consumption of food provided to the patient remains above fifty percent, weekly skin assessments and weight monitoring and determinations 42 concerning weight loss and food intake are continued. If the status of the patient changes, the patient's status is reevaluated consistent with the start 34 of the nutrition management protocol.

If weight loss or poor food intake is observed at day 7, a medical evaluation should be requested to determine causes of anorexia or possible depression, and the diet or tube feeding should be adjusted as necessary 44. The patient's weekly status should be checked 46 again at day 14.

If the patient's status has stabilized, weekly skin assessments and weight monitoring should be continued as noted above in connection with determinations 42. If the patient continues to experience weight loss or has continued poor food intake, the goals of the care of the patient should be discussed with the patient, the patient's family and staff. Furthermore, a determination should be made 48 whether the patient would like to begin or continue tube feeding.

If the patient does not wish to begin or continue tube feeding, other forms of nutritional support, and/or implementing palliative, hospice or comfort care should be discussed 50. Weekly skin assessments, and weight and oral diet monitoring should be continued monthly, or as necessary 52.

Other forms of nutritional support include total parenteral nutrition or peripheral parenteral nutrition, where nutrition is given intravenously instead of nutrition being given through a feeding tube (only appropriate when the gastrointestinal tract cannot be used); fortified foods including foods fortified with extra calories and protein; smaller more frequent meals including three meals and three snacks between meals; and the use of oral medical nutritional supplements.

If the patient wishes to begin or adjust tube feeding, a reassessment by a registered dietitian should be provided 54 and tube feeding should be started or adjusted, preferably providing for a high calorie/high protein or disease specific tube feeding product.

Within one week of starting or adjusting tube feeding, weekly skin assessment and weight measurement should be performed 56. The tube feeding should be adjusted as necessary. Within two weeks of starting tube feeding, in addition to performing the weekly skin assessment and weight measurement, it should be determined 58 if the patient is experiencing new, unintentional or continued weight loss. If yes, a registered dietitian and physician should be consulted regarding a reassessment of current tube feeding, and this should be discussed with the patient and his or her family 60. Within three weeks of starting tube feeding weekly skin assessment and weight measurement should be performed, and it should be determined whether the patient is experiencing weight loss, essentially repeating the procedure for week two, including reassessment 64, if necessary. Within four weeks of starting tube feeding weekly skin assessment and weight measurement should be performed 66.

If the patient continues to experience problems with weight loss, the goals for the patient should be discussed and it should be reevaluated whether the patient wishes to continue tube feeding. If so, execution of the protocol is transferred to the beginning of the tube feeding sequence.

If the patient is not experiencing new, unintentional or continued weight loss oral feeding 68 should be considered. The weight of the patient should be continued to be monitored weekly, for the next four weeks, and weekly skin assessments 70 should be performed. Skin assessments should be continued weekly. The weight and the oral diet of the patient should be monitored monthly, or as necessary 52.

When progressing from tube feeding to oral feeding it may be helpful to not stop tube feeding right away. A trial period of tube feeding plus oral diet is desirable. Tube feeding should be decreased as oral intake increases. Cessation of tube feeding should be considered when oral intake meets greater than or equal to 75 percent of the patient's nutritional needs. During the transitional feeding period, oral supplements and/or appetite stimulants should be used as needed. Furthermore cyclic tube feeding should be considered during the night or a specific part of the day to provide the nutrient and fluid requirements not met by oral intake. Still further, if the patient's nutritional needs cannot be met by oral intake during the transitional feeding period, a permanent maintenance tube feeding should be discussed with the patient, his or her family, and staff.

Until day 90 or a significant change in status, the patient's weight, tube feeding or oral diet, and nutritional status should be monitored at least monthly; skin assessments should be performed weekly; the protocol should be reevaluated quarterly or as necessary; and the Minimum Data Set (MDS) completed as indicated 52.

Consistent with good medical record keeping the patient's progress with regards to the selected course of treatment should be documented in, for example, the patient's chart. A suitable form for use in the management and record keeping of the patient's progress in regards to the nutrition management protocol 20 is illustrated in FIGS. 2A-2C.

By following the nutrition management protocol for pressure ulcer prevention when the patient exhibits the nutrition triggers, extra care can be provided to the patient for improved nutrition, since improved nutrition is likely to reduce the patient's likelihood of developing a pressure ulcer.

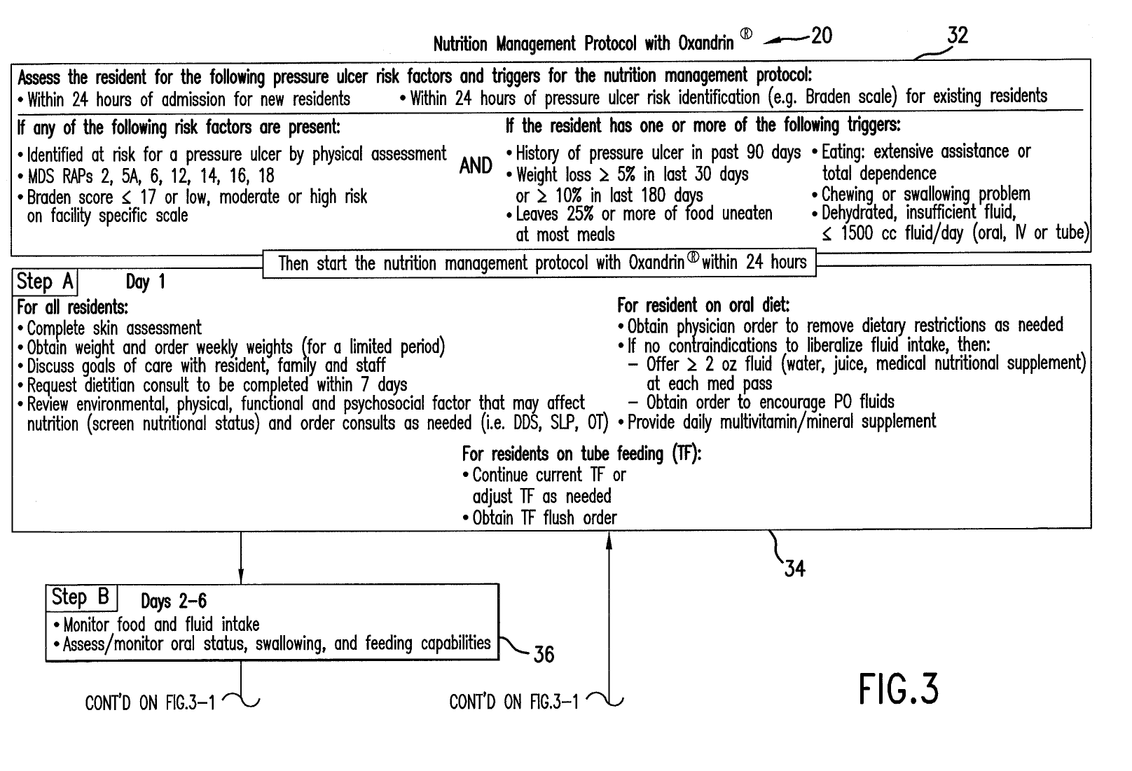

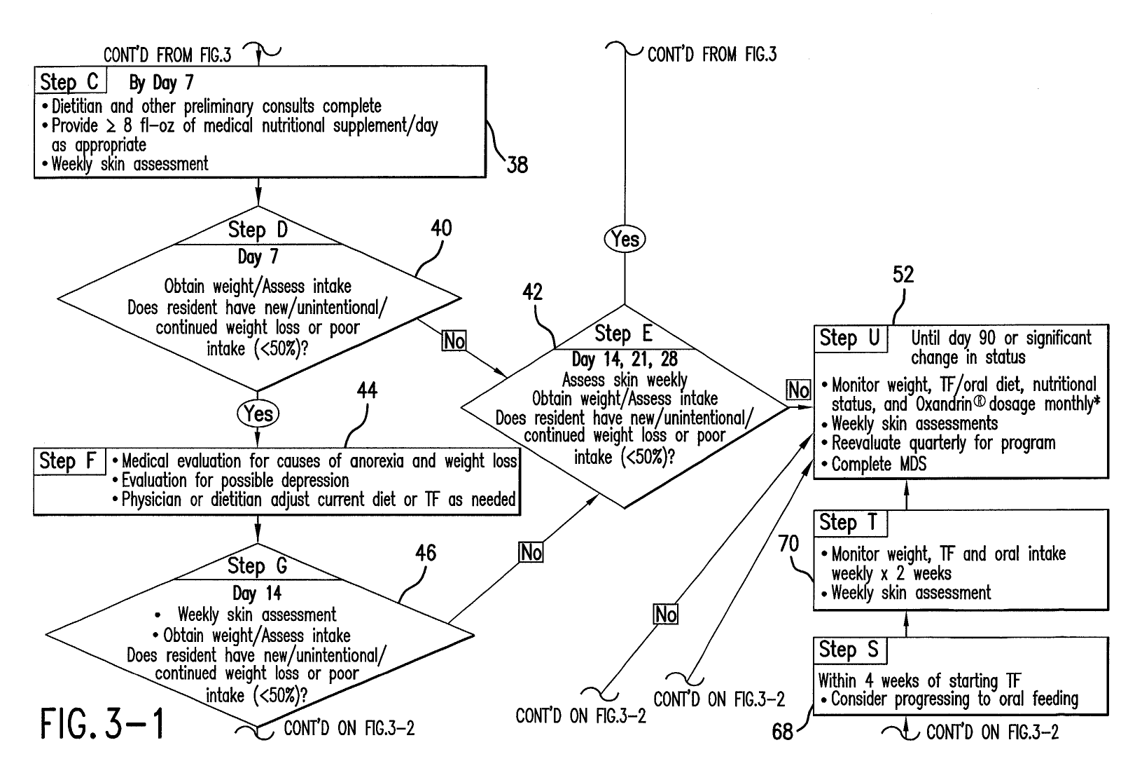

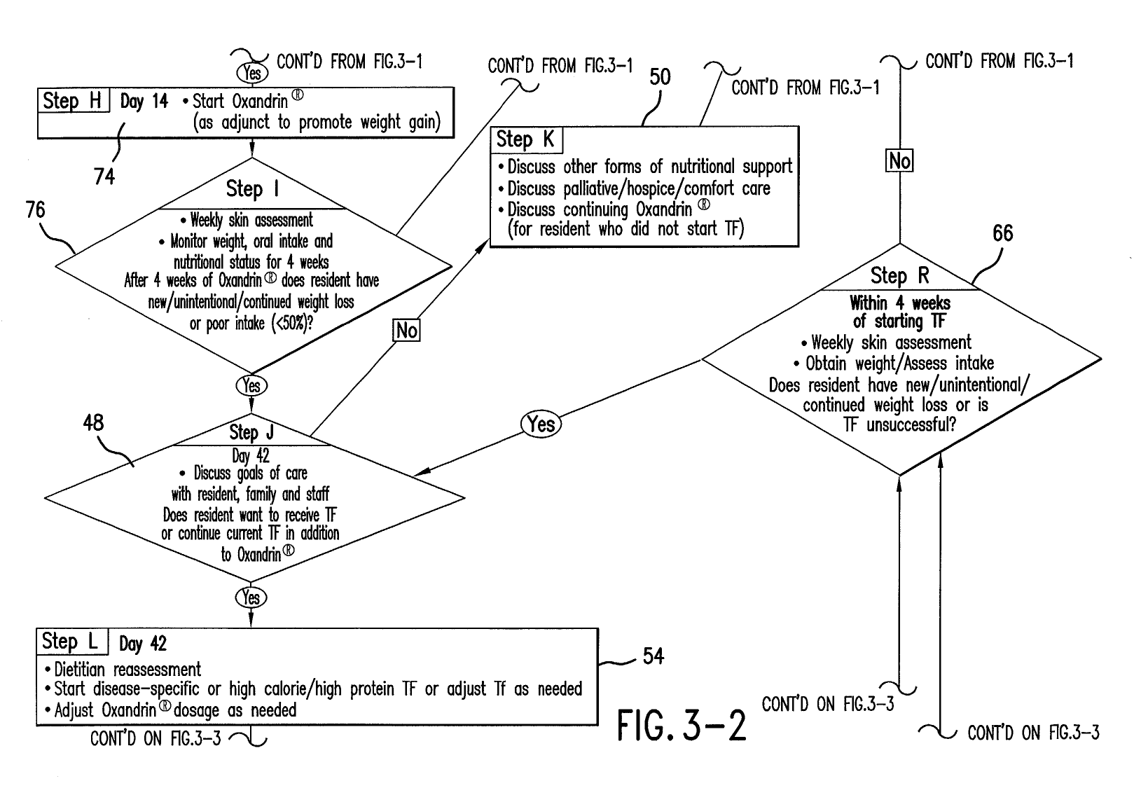

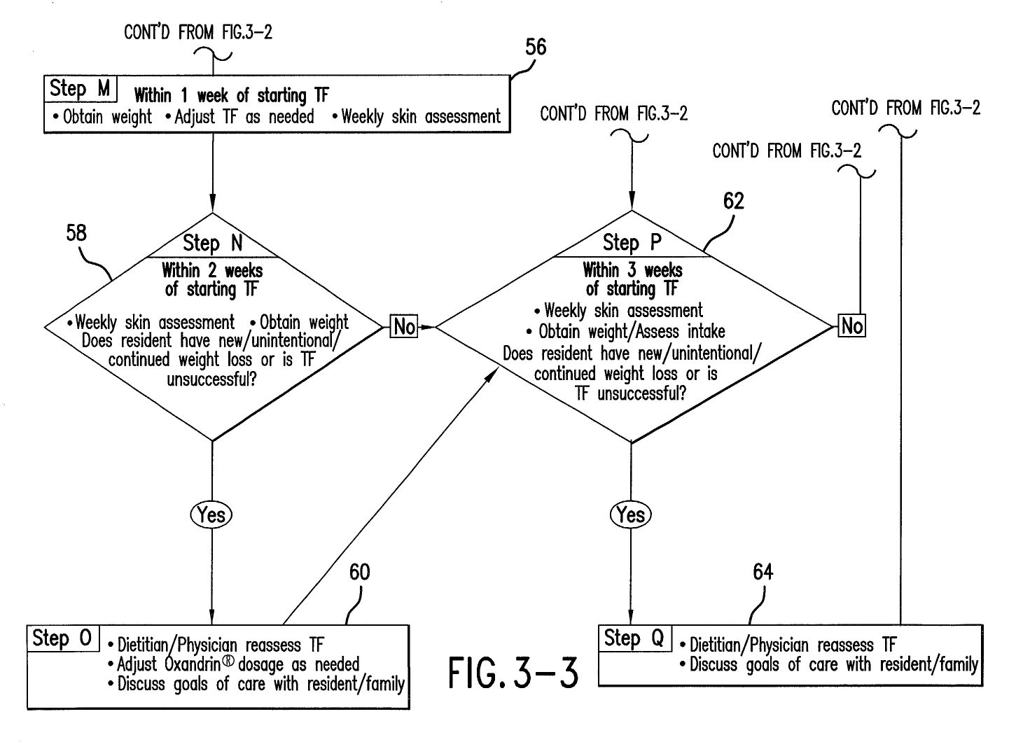

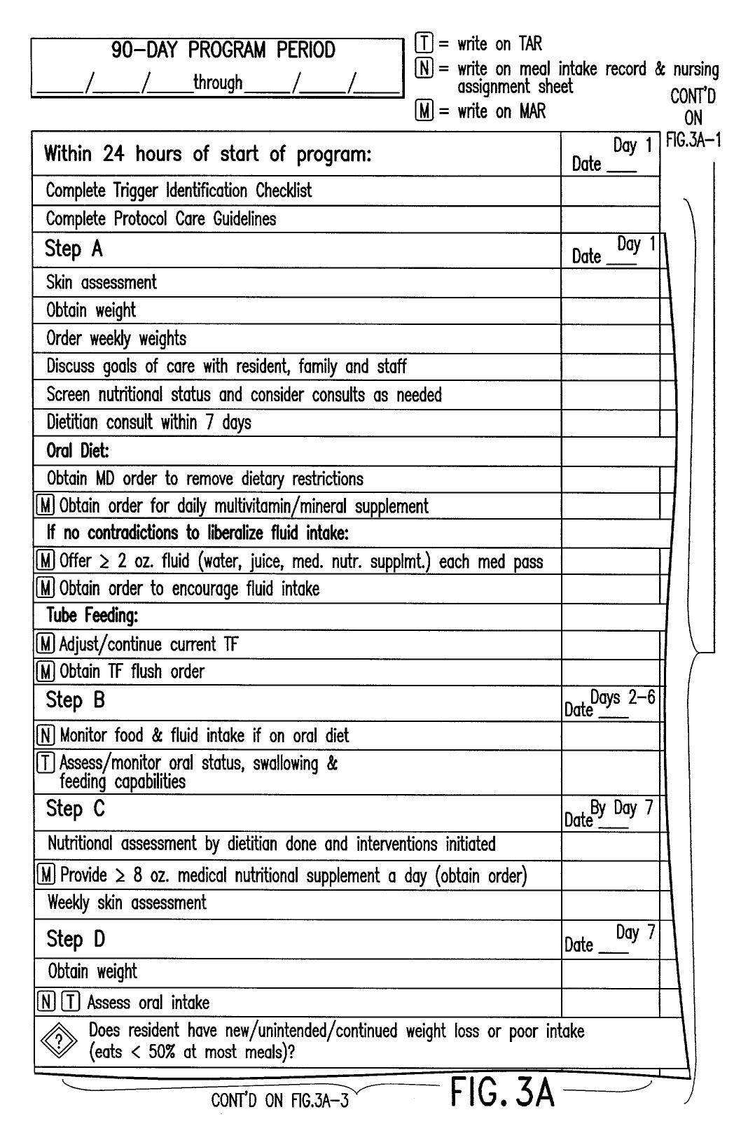

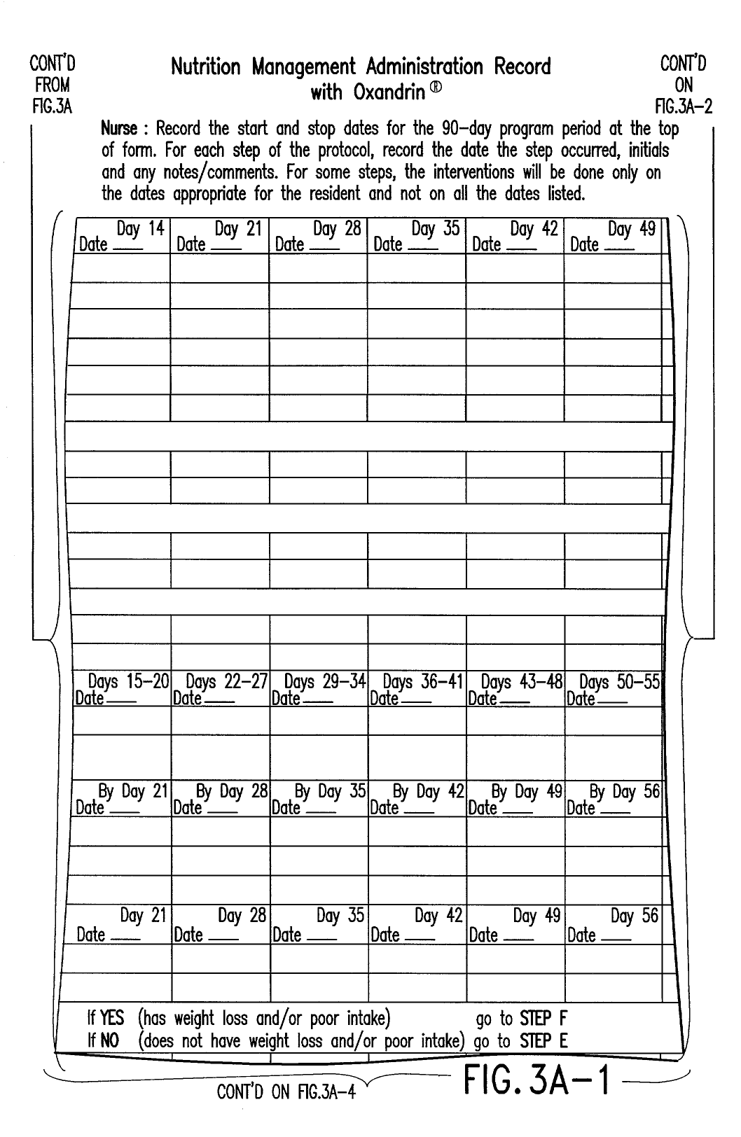

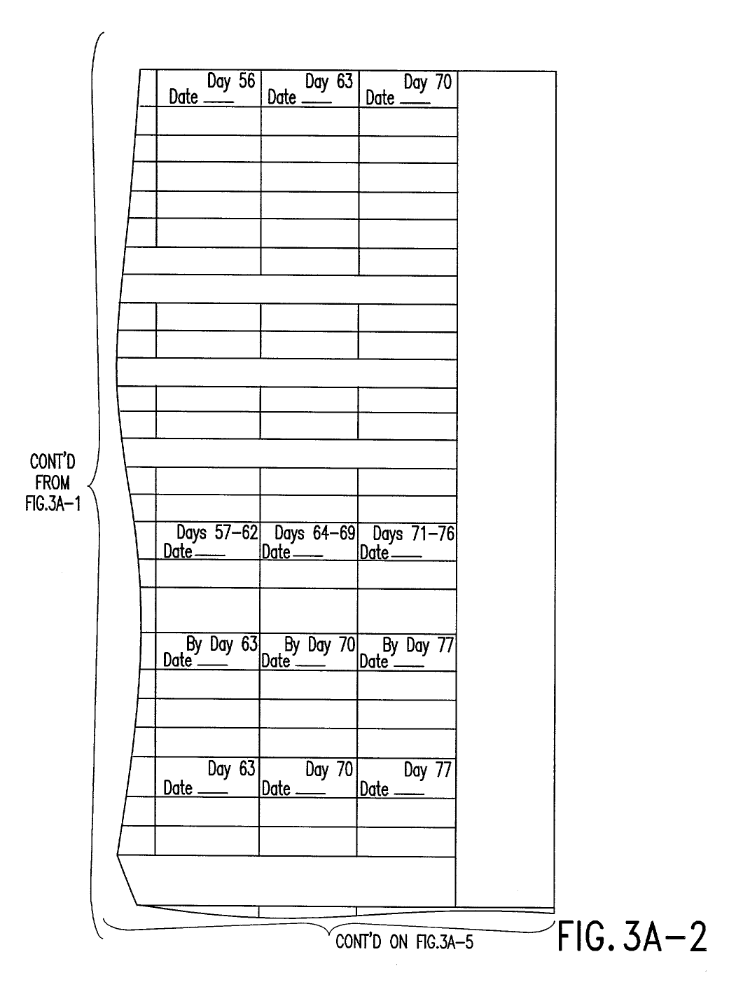

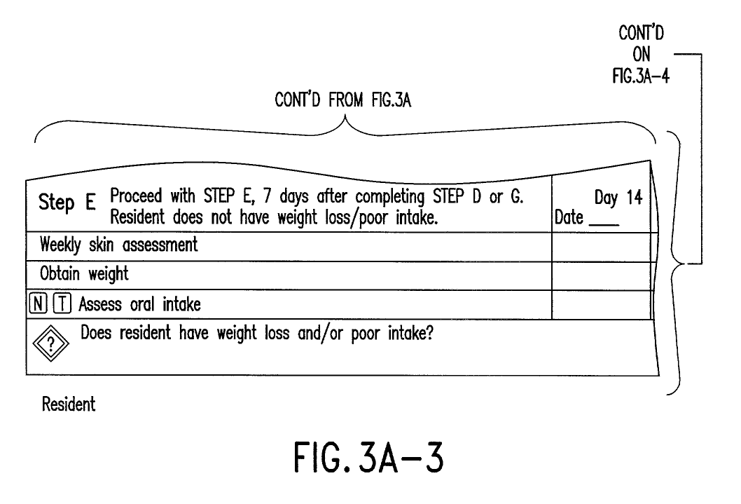

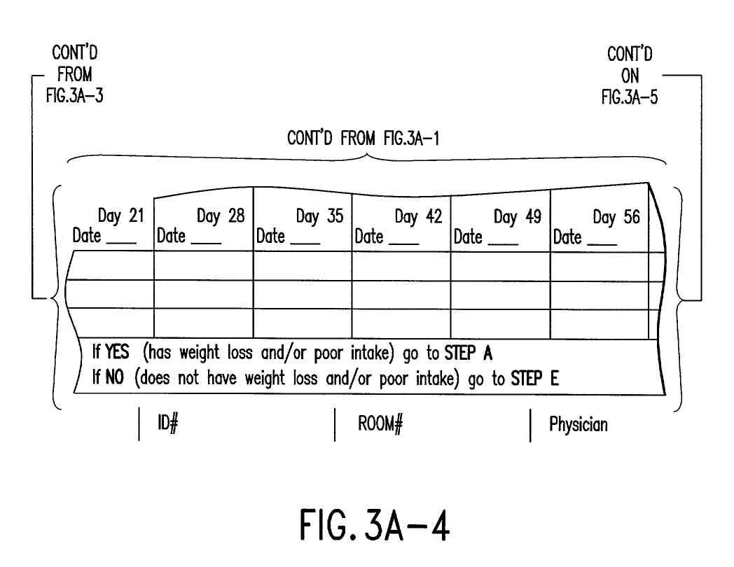

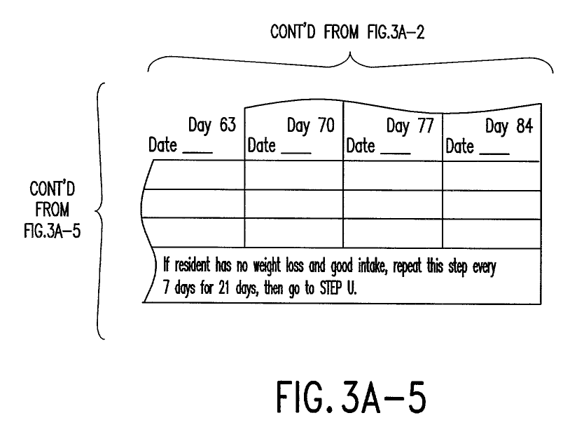

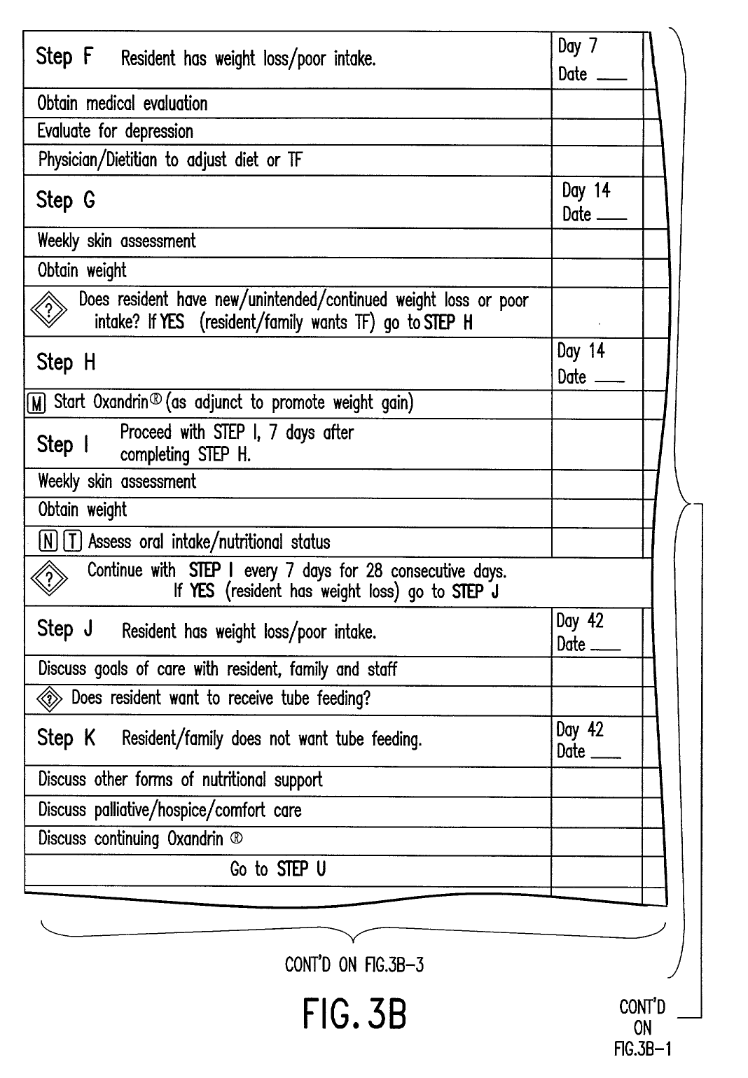

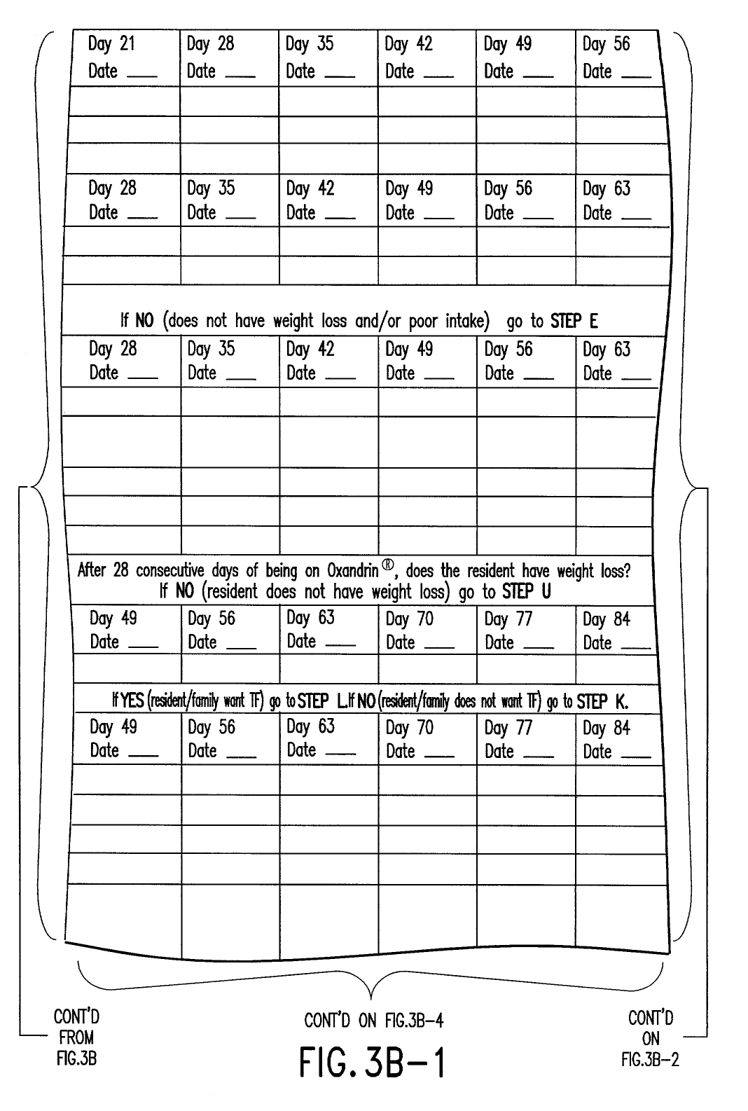

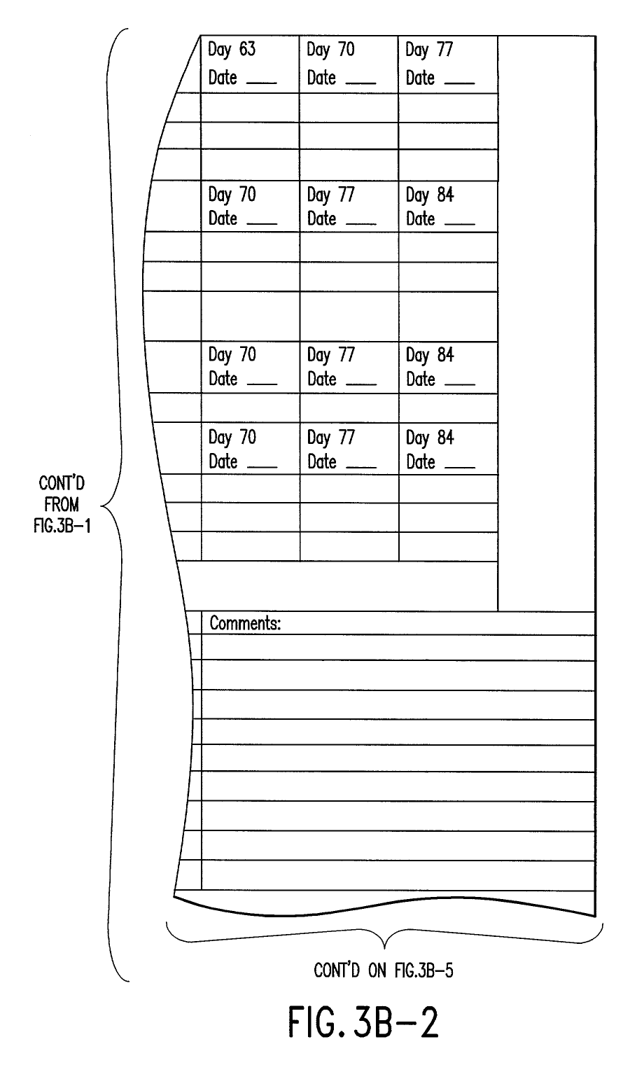

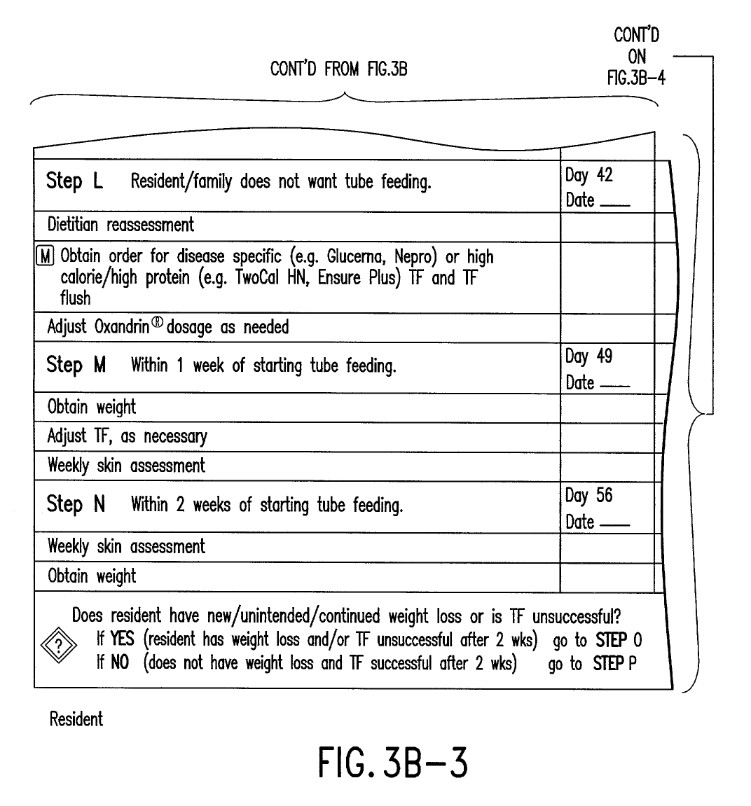

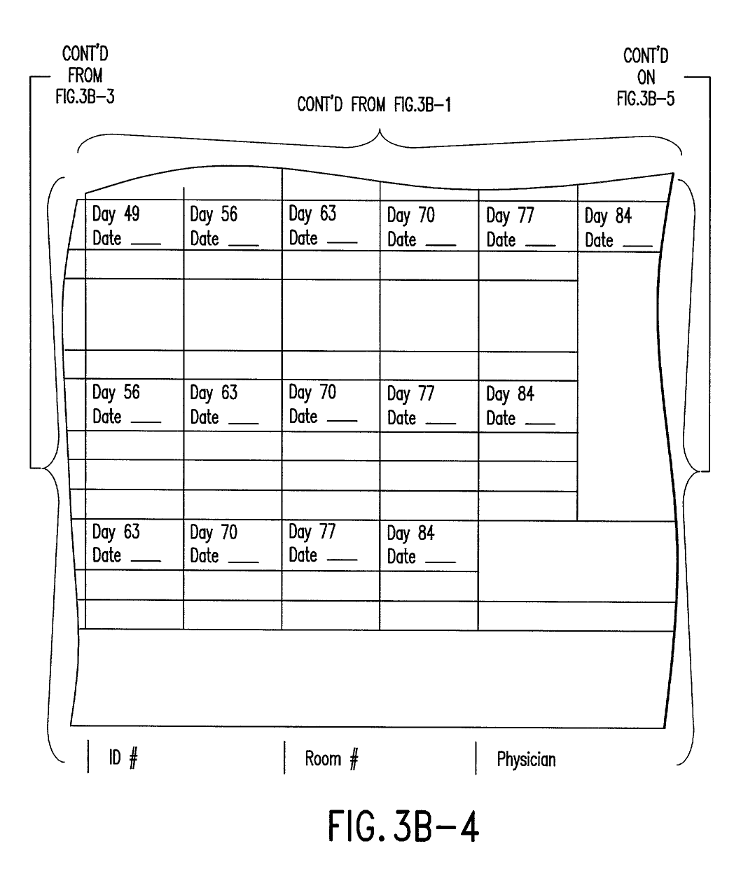

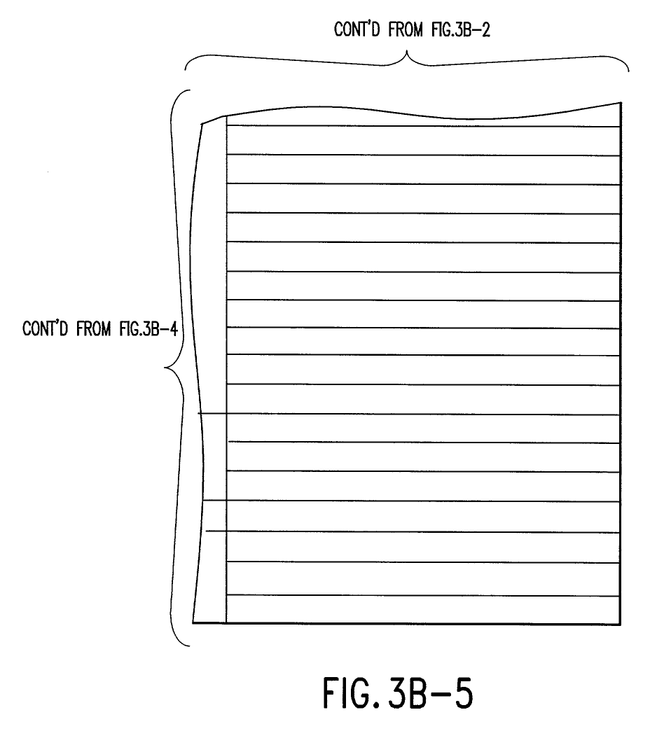

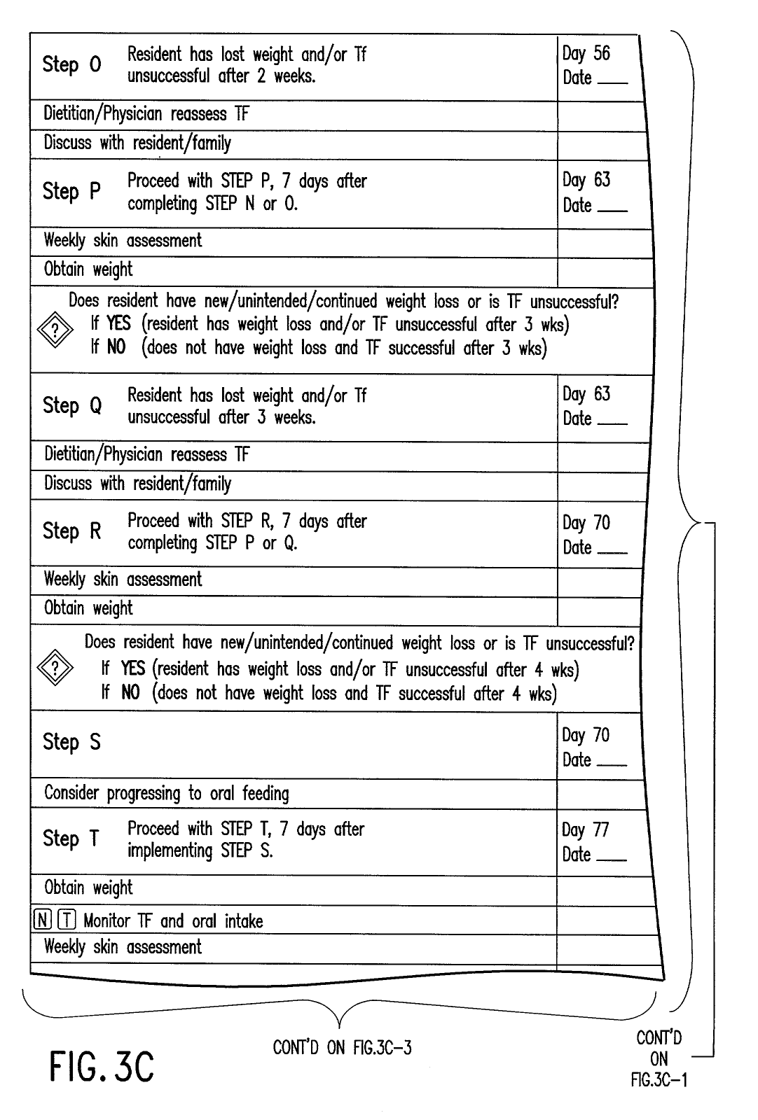

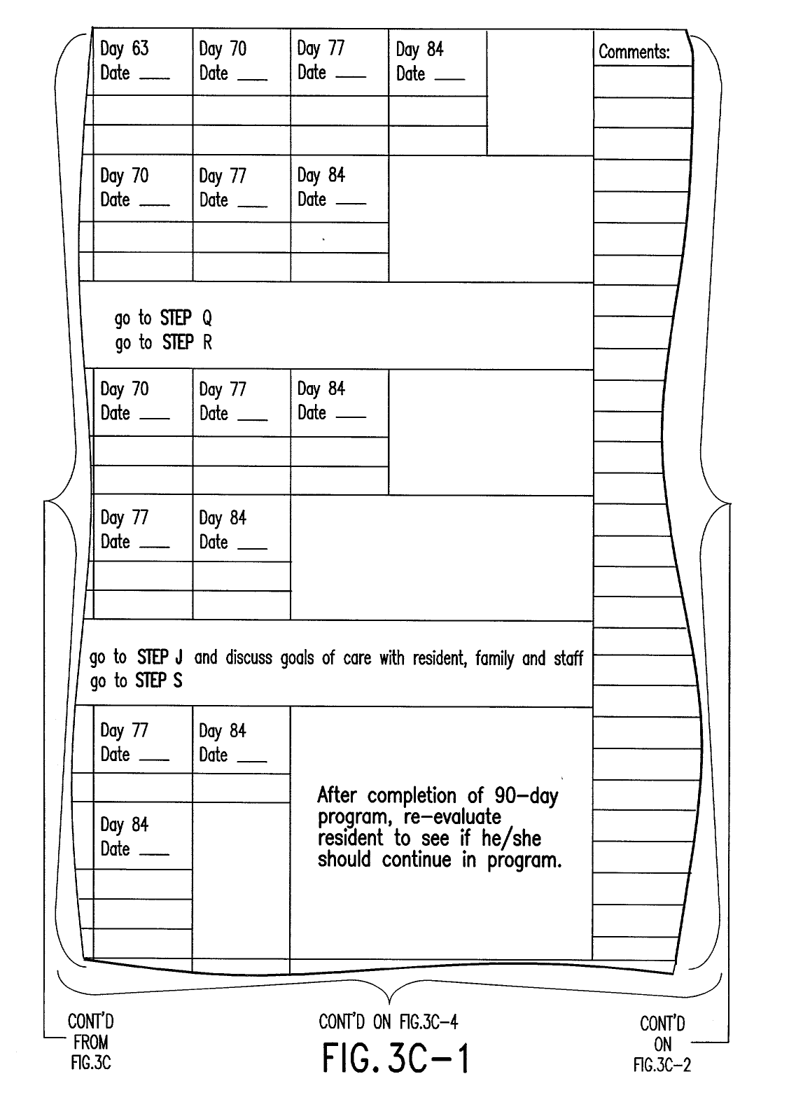

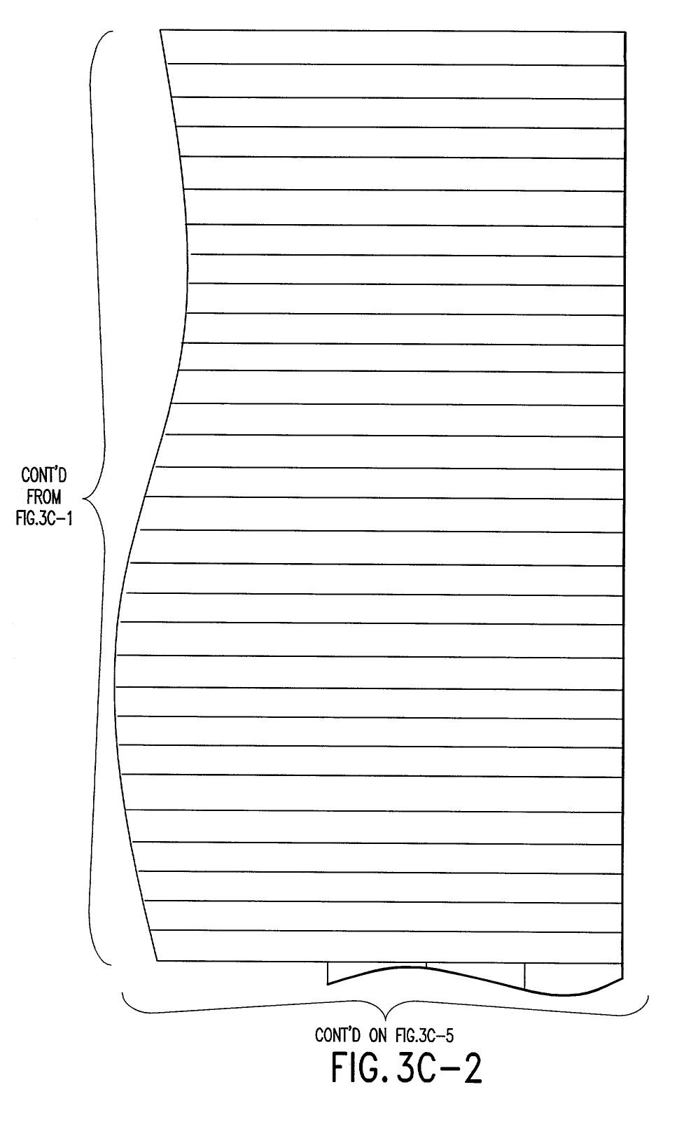

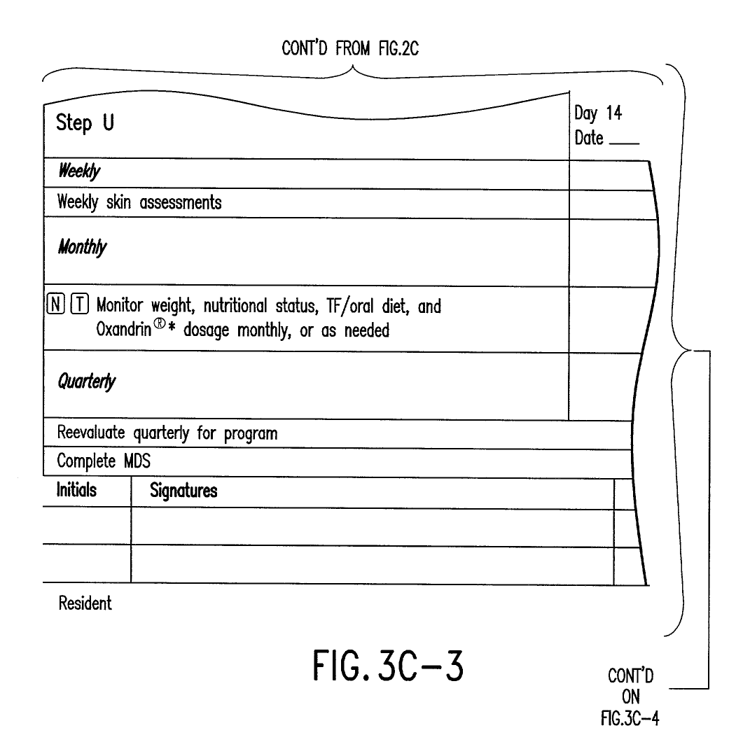

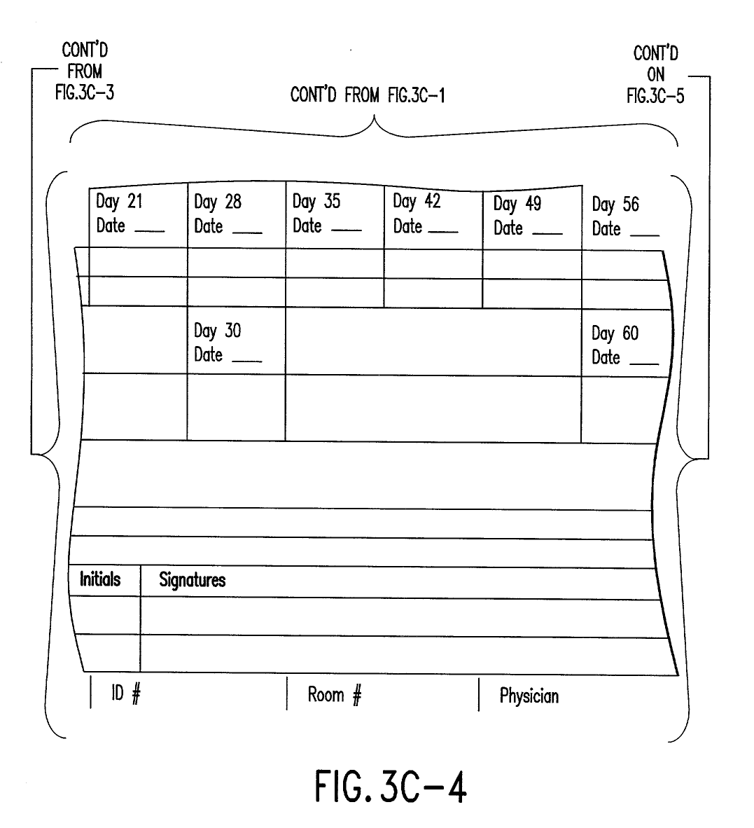

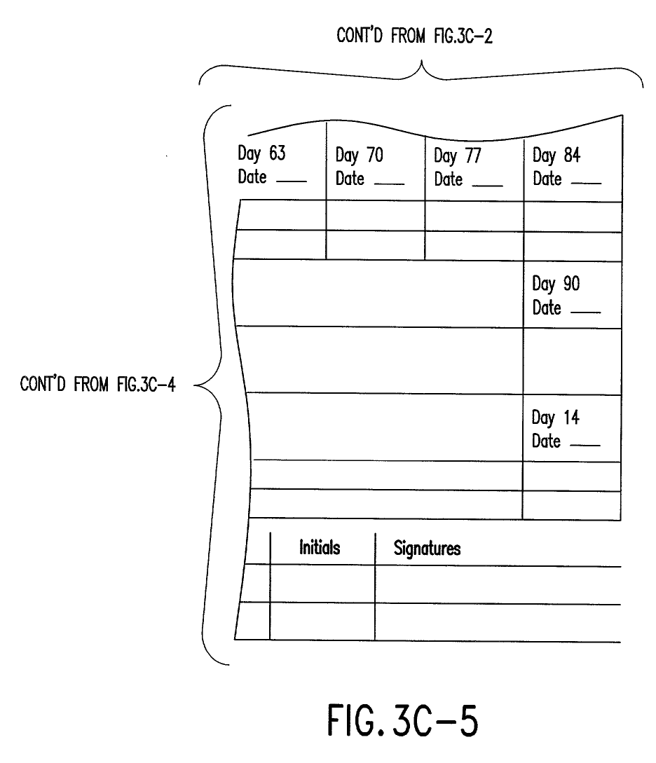

As an alternative to the nutrition management protocol 20 illustrated in FIG. 2, a further nutrition management protocol 72 which additionally incorporates the use of an anabolic steroid is illustrated in FIG. 3. An anabolic steroid is a synthetic derivative of testosterone, which promotes weight gain by stimulating the growth or thickening of the body's non-reproductive tract tissues including the skeletal muscles and bones. Several examples of anabolic steroids include OXANDRIN® manufactured for BTG Pharmaceuticals, WINSTROL® manufactured by Sanofi Pharmaceuticals, Inc., and ANADROL®-50 manufactured for Unimed Pharmaceuticals, Inc.

While the illustrated nutrition management protocol 72 in FIG. 3 makes specific reference to the use of the anabolic steroid OXANDRIN®, it should be recognized that other brands of anabolic steroids could alternatively be used. Like any other prescribed medication, the use of an anabolic steroid should be monitored by the appropriate medical personnel. An anabolic steroid like OXANDRIN® in the described protocol can be used for 2-4 weeks with intermittent repetitions.

The flow diagram of the nutrition management protocol 72 incorporating the usage of an anabolic steroid illustrated in FIG. 3 is generally consistent with the nutrition management protocol 20 illustrated in FIG. 2. Consequently like elements between protocols are numbered similarly. However the nutrition management protocol (w/anabolic steroid) 72 of FIG. 3 differs from the nutrition management protocol 20 of FIG. 2 in the following manner.

If after 14 days, the patient has new, unintentional, continued weight loss, or poor intake 46, the patient is started on an anabolic steroid, like OXANDRIN®, as an adjunct to promote weight gain 74. During the following 4 week period, weekly skin assessments are performed, and the patient's weight, oral intake, and nutritional status are monitored. A determination is then made as to whether the patient has new, unintentional, continued weight loss, or poor intake 76. If the patient does not have new, unintentional, continued weight loss, or poor intake, the patient's weight, diet, nutritional status, and anabolic steroid dosage are monitored monthly, or as needed. In addition, weekly skin assessments are performed, the Minimum Data Set (MDS) completed as indicated, and the patient evaluated quarterly or as necessary 52, until day 90 or there is significant change in the patient's status. If the patient does have new, unintentional, continued weight loss, or poor intake, the goals of care for the resident are discussed with the patient, the patient's family, and staff, and an evaluation is made as to whether to begin or continue current tube feeding in addition to the anabolic steroid 48.

Additionally, if the resident has been started on an anabolic steroid, its continued use and/or dosage levels are adjusted as needed and/or additionally assessed in connection with steps 50, 54, 60 and 64. Lastly, as part of step 70, the weight of the patient should be continued to be monitored weekly, for the next two weeks as opposed to four weeks, and weekly skin assessments performed.

FIGS. 3A-3C illustrate a suitable form for use in the management and record keeping of the patient's progress in regards to the nutrition management protocol (w/anabolic steroid) 72.

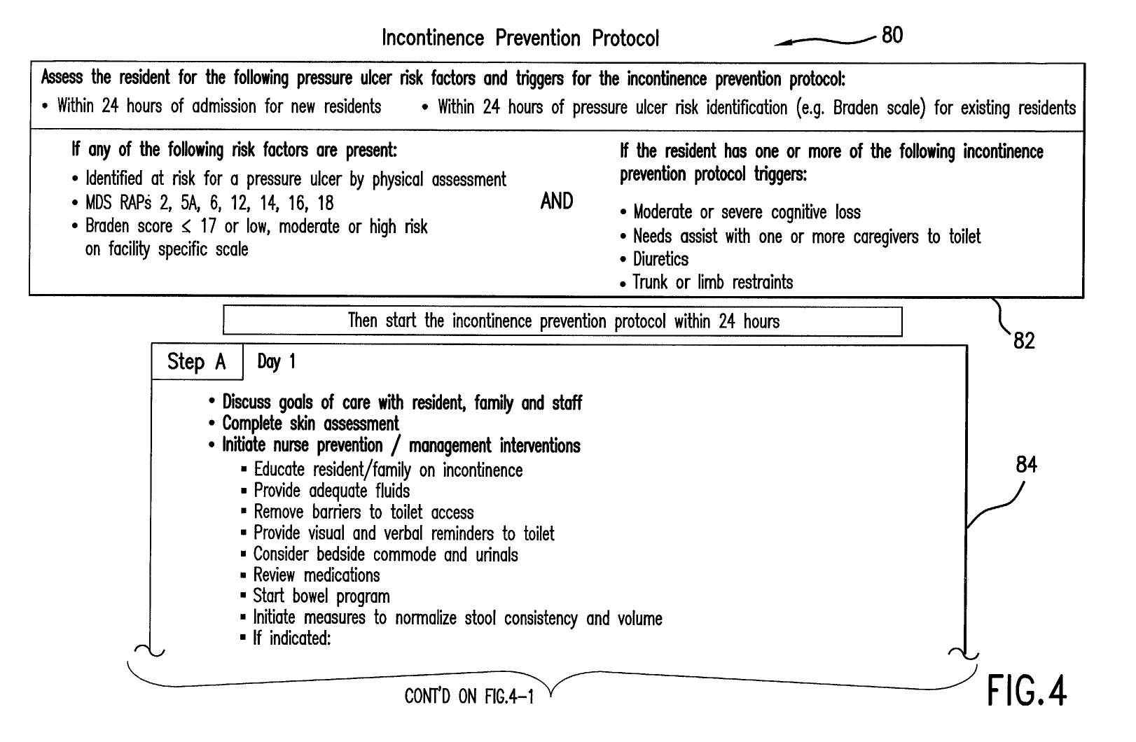

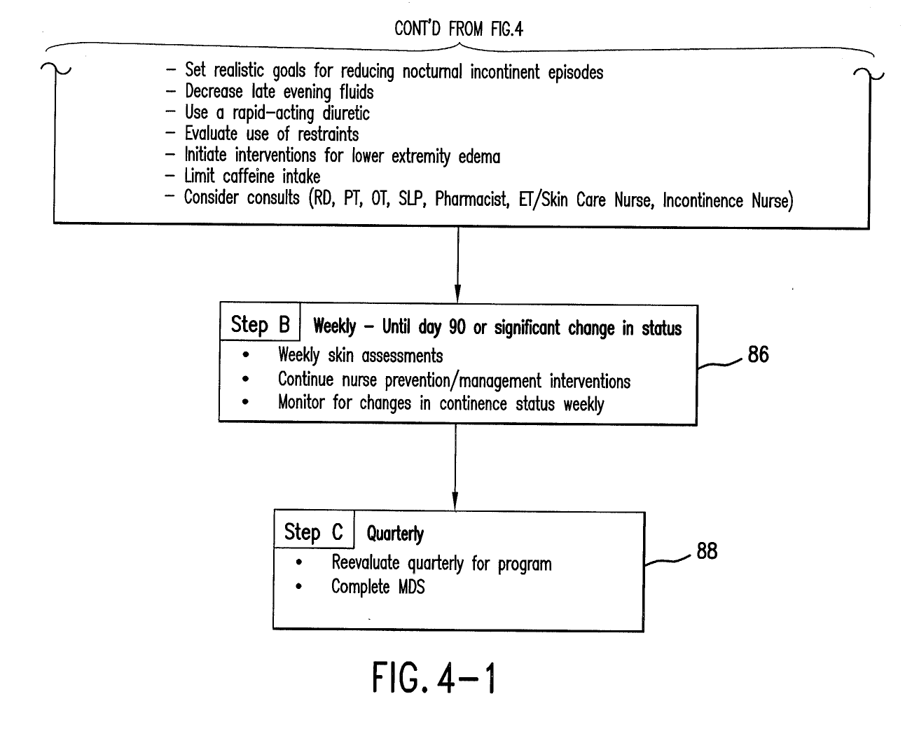

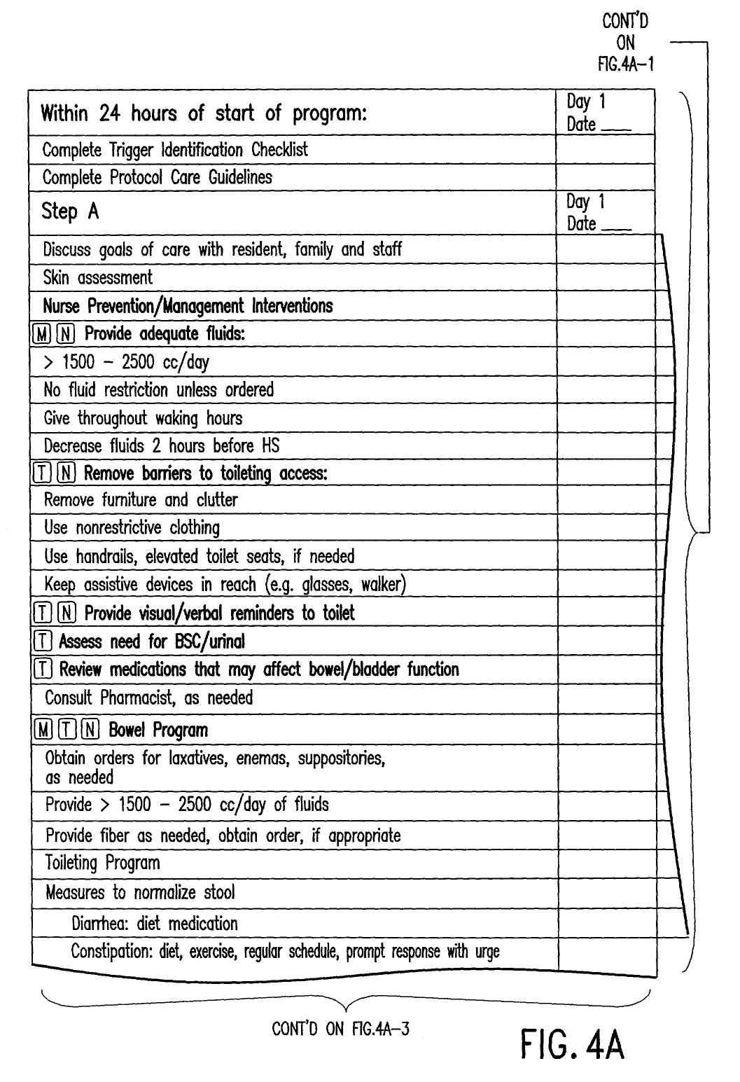

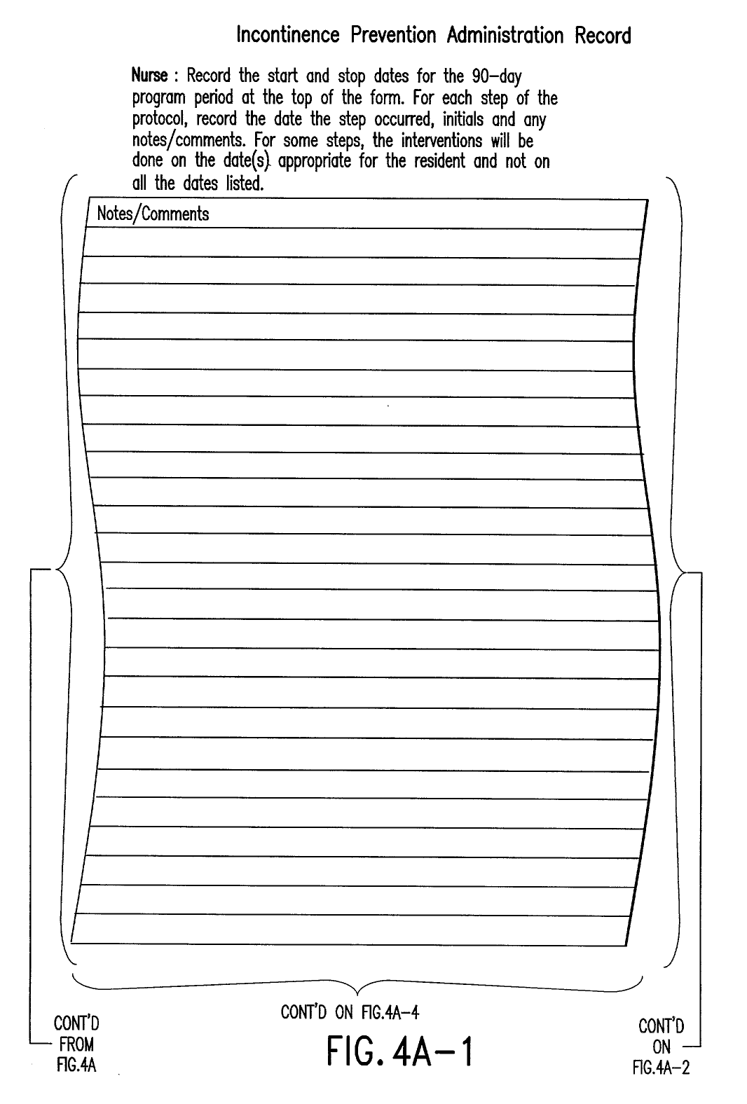

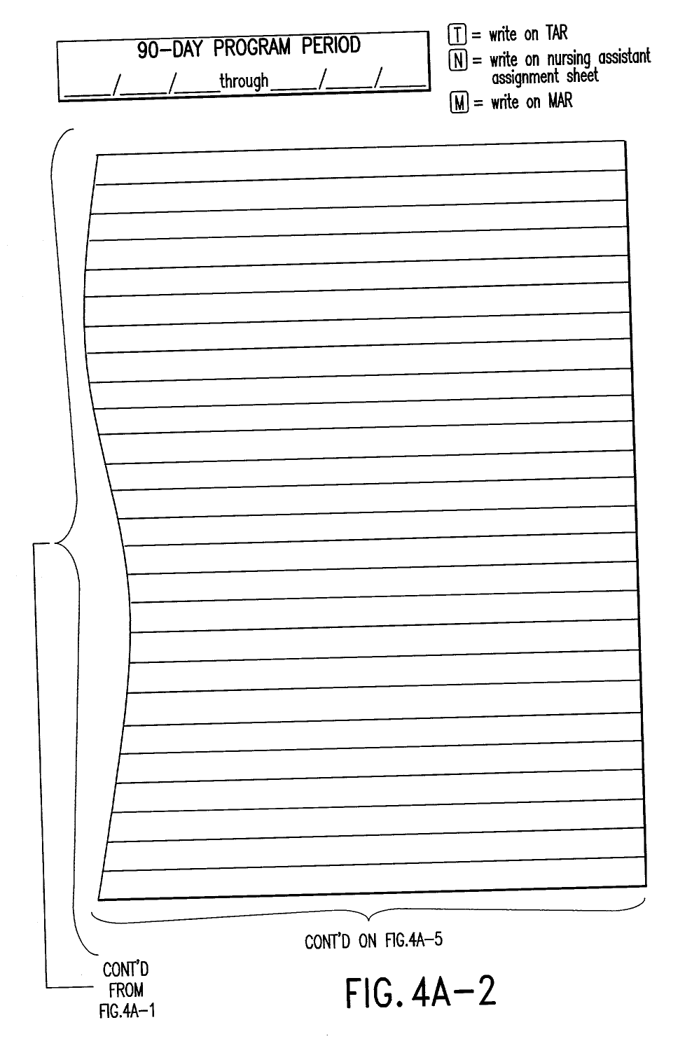

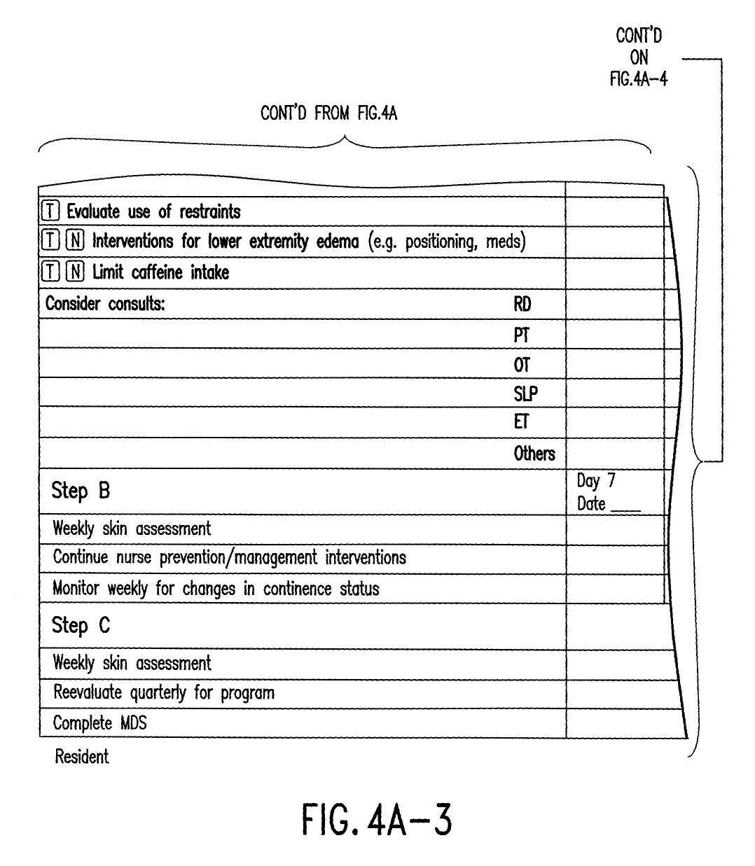

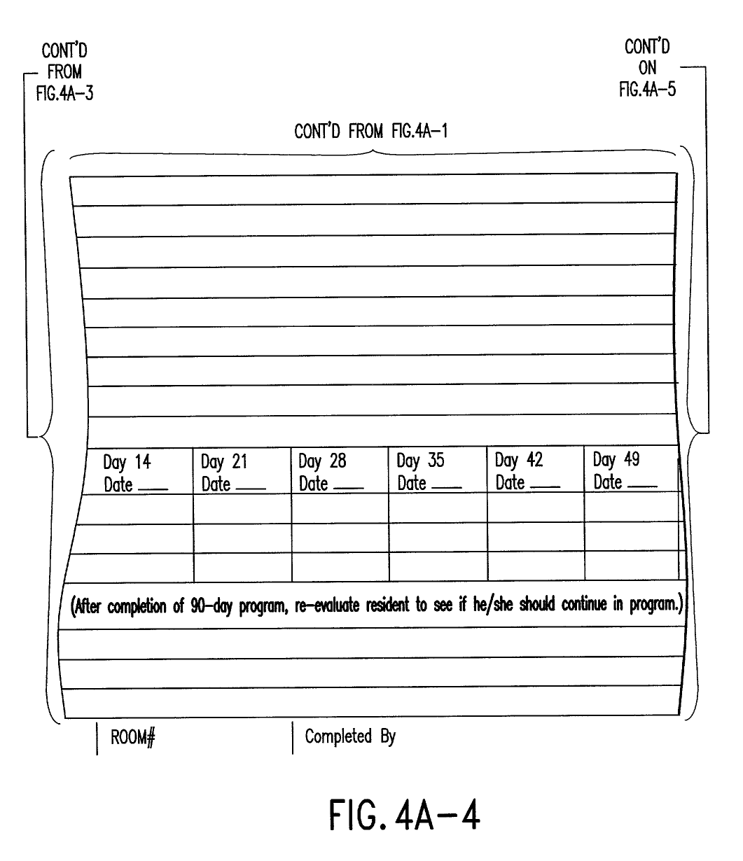

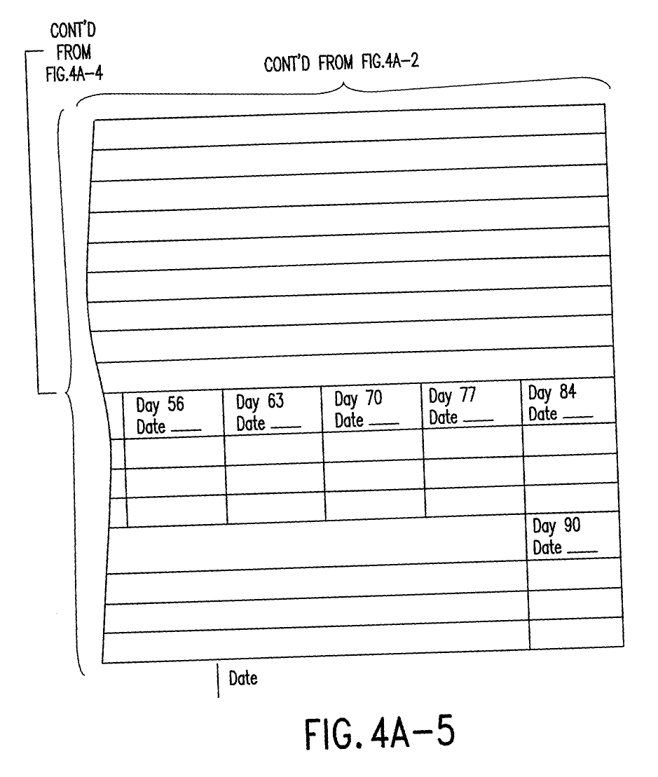

FIG. 4 illustrates a flow diagram of the first of two parts of an incontinence protocol for the prevention of pressure ulcers, specifically an incontinence prevention protocol 80. The incontinence prevention protocol 80 is directed toward treating patients at-risk of developing incontinence. In connection with the incontinence prevention protocol 80, the specific incontinence prevention triggers defined include when the patient: (1) has moderate or severe cognitive loss; (2) requires assistance from one or more caregivers to use the toilet; (3) uses diuretics; and/or (4) has trunk or limb restraints. Initially, the protocol provides for the examination 82 of the patient and the patient's medical history, within 24 hours of admission, for one or more of the triggers.

If one or more of the incontinence prevention triggers are present the patient is started 84 on the incontinence prevention protocol. Within 24 hours of starting the patient on the incontinence prevention protocol, goals are discussed with the patient, the patient's family and staff, and an initial skin assessment of the patient is made. Nurse prevention/management interventions are initiated including the education of the patient and the patient's family; the provision of adequate fluids; the removal of barriers to toileting access; the provision of visual and verbal reminders to toilet; consideration of the use of a bedside commode and urinal; a review of medications; measures to normalize stool consistency and volume; and the possible initiation of a bowel program.

Educating the patient and the patient's family includes identifying the risks for incontinence, explaining the plan of care to lessen the risks for incontinence, and providing a copy of a patient/caregiver pamphlet, (published by the Agency for Health Care Policy and Research).

Adequate fluids are provided to decrease the bladder irritants. Providing adequate fluids includes maintaining fluid intake at approximately 1500 cc of fluid to approximately 2500 cc of fluid per day, providing liquids to be sipped between meals, not limiting fluid intake, decreasing fluids approximately two hours before bedtime, assessing the patient's fluid consumption, and giving fluids throughout the waking hours so the urinary system does not have to handle a large volume of liquid in a brief period of time.

Removing barriers to toileting access includes decreasing clutter in and around the patient's toilet, removing obstacles in the pathway to the toilet, having the patient dress in comfortable clothing that is easy to remove, use of a night light so the patient can see a pathway to the toilet at night, improving environmental safety if necessary (e.g. use good lighting, install handrails, use elevated toilets), using simple containment garments that are similar to regular underpants, and keeping the patient's eye glasses handy.

Providing visual and verbal reminders to toilet include putting the word “bathroom” or “toilet” on the patient's bathroom door, putting a picture of a toilet on the patient's bathroom door, and/or the use of simple verbal or behavioral cues.

Reviewing medications includes the use of diuretics which can cause frequent urination, urgency and/or nocturia; the use of anticholinergics for peptic ulcer disease, COPD, anti-infectives containing anticholinergics, and anti-Parkinson medications, which can cause urinary retention, overflow incontinence, constipation and/or impaction; the use of psychotrophics, such as antidepressants or antipsychotics, which can cause anticholinergic actions, sedation, muscle relaxation, immobility and/or delirium; the use of cardiac medications, which can cause urinary retention; the use of narcotic analgesics, which can cause urinary retention, fecal impaction, sedation and/or delirium; the use of cold and allergy remedies, which can cause urinary retention; the use of antacids and laxatives, which can cause diarrhea and/or loose stools; the use of antacids and phosphate binders in kidney disease, which can cause constipation; the use of antibiotics, which can cause diarrhea; and the use of stool softeners and laxatives, which can cause diarrhea and/or loose stools.

In connection with measures to normalize stool consistency and volume, measures can be taken to minimize diarrhea. The dietitian can determine poorly tolerated foods which should be limited or avoided; can recommend foods that can thicken stool, such as rice, bananas, cheese and oatmeal; and can recommend foods to avoid, such as foods containing caffeine and alcohol, that can increase diarrhea. The pharmacist can review the patient's medications for those that contribute to diarrhea, such as antibiotics, hypotonic solutions, antacids with magnesium, and quinidine. Medications can be given to slow down bowel mobility or to thicken stool. However, medications to slow down bowel mobility are sometimes contraindicated if diarrhea is due to infection. Furthermore, long-term or aggressive antibiotic therapy can cause a fungal superinfection that can cause diarrhea.

In connection with measures to normalize stool consistency and volume, measures can be taken to minimize constipation. The patient can be urged to respond promptly when they feel the urge to have a bowel movement. The amount of fiber in the patient's diet can be increased with such foods as dried fruit, dried beans, fresh vegetables, wheat products, bran, prunes, and pear juice. The patient can be provided with adequate fluid intake. A regular exercise program of aerobic activity can be encouraged. Furthermore, a regular time for bowel movements can be established. A good time is 20 to 30 minutes after regularly scheduled meals.

Initiation of a bowel program can include the use of laxatives, enemas and suppositories, as necessary. Furthermore, fluid and fiber intake can be adjusted, as necessary. Still further, a stimulated defecation program can be initiated, as necessary. A candidate for a stimulated defecation program would be a patient who has sensory and motor dysfunction, which has been identified as a cause of bowel incontinence.

If necessary, the incontinence prevention protocol further includes decreasing late evening fluids, limiting caffeine intake, the evaluation of the use of restraints, consideration of the use of rapid-acting diuretics, intervention for lower extremity edema, or considering consultations with other specialists. The same procedure is generally continued weekly including weekly skin assessments 86.

When considering consultations with other specialists, a dietitian can assist with identifying bladder irritants, can provide substitutes to ensure optimal nutritional intake, and/or can recommend foods for establishing a regular bowel habit. A physical therapist can improve the patient's upper and lower extremity strength, gait, balanced, positioning and transfer techniques. The physical therapist can further help to teach the staff transfer techniques for the patient, and can help with pelvic floor strengthening exercises. An occupational therapist can help make the bathroom safer with adaptive aids, such as grab bars and raised toilets seats; can become involved in continence management by evaluating the patient's toileting behaviors; can help adapt undergarments and clothing for easy removal; and can work with the patient on toileting and dressing behaviors.

Until day 90 or there is a significant change in status, the incontinence prevention protocol 80 further provides for weekly skin assessments, continued nurse prevention/management interventions, and weekly monitoring for changes in continence status 86. The patient's status is reevaluated quarterly or as necessary, and the Minimum Data Set (MDS) completed 88 as indicated.

FIG. 4A illustrates a suitable form for use in the management and record keeping of the patient's progress in regards to the incontinence prevention protocol 80.

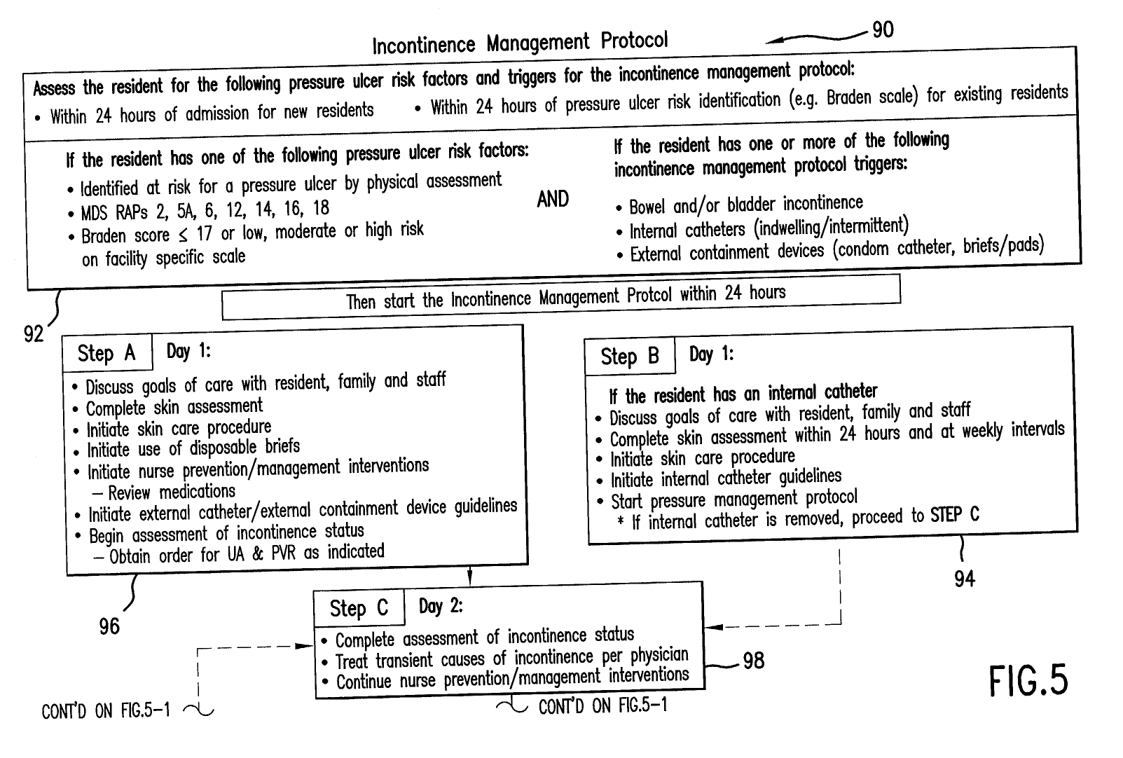

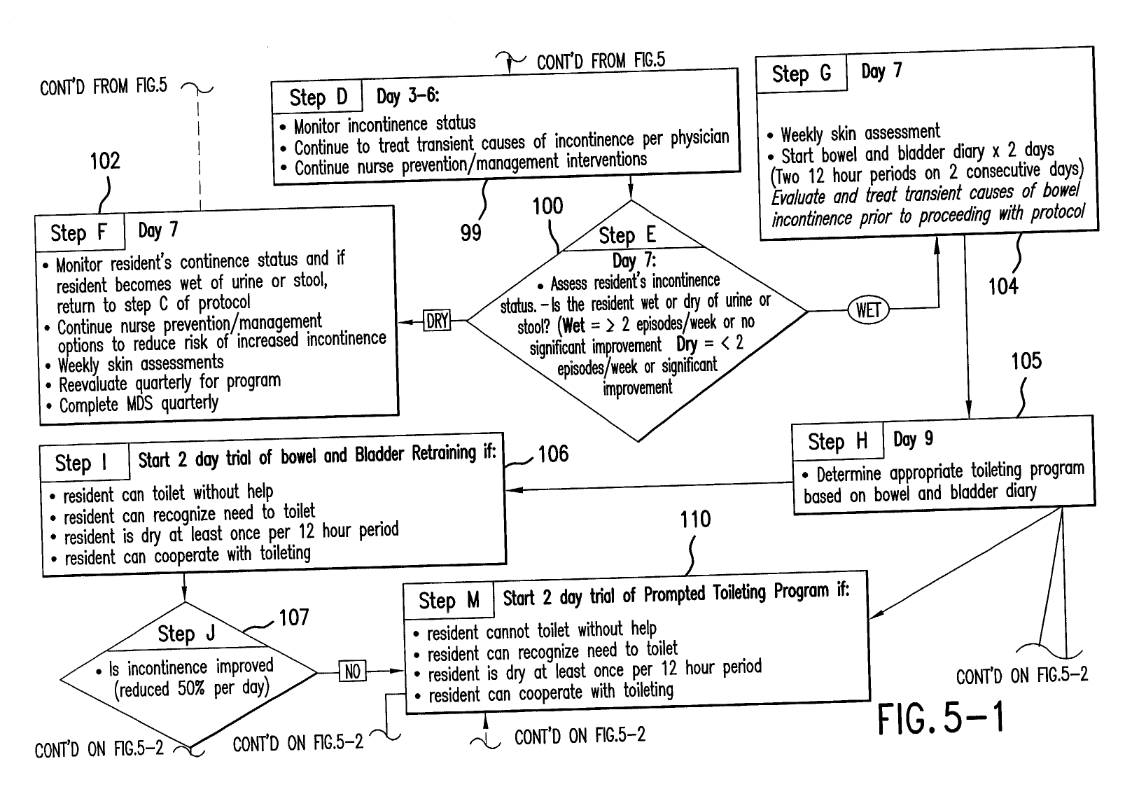

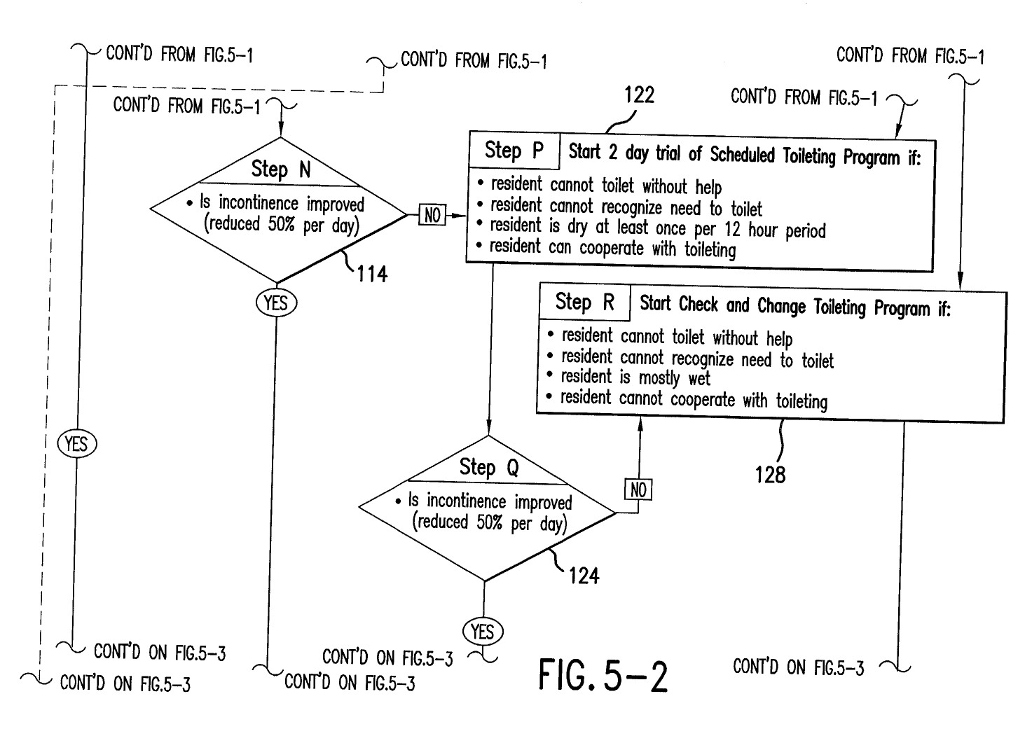

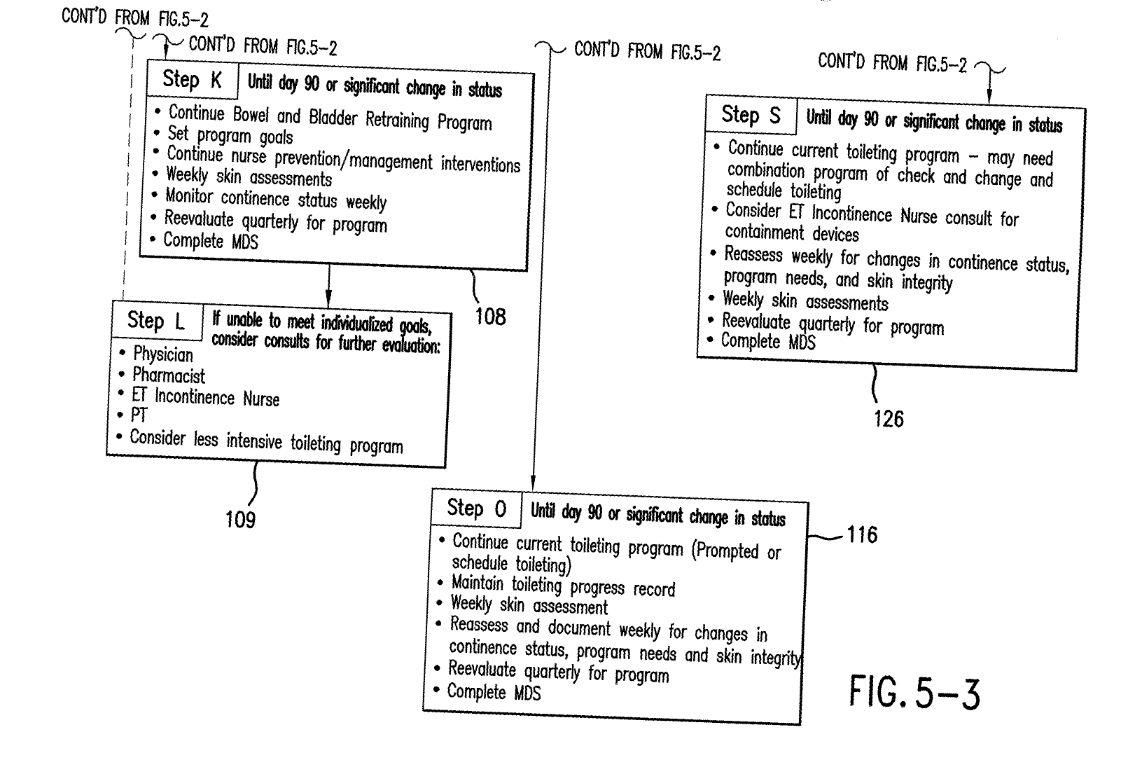

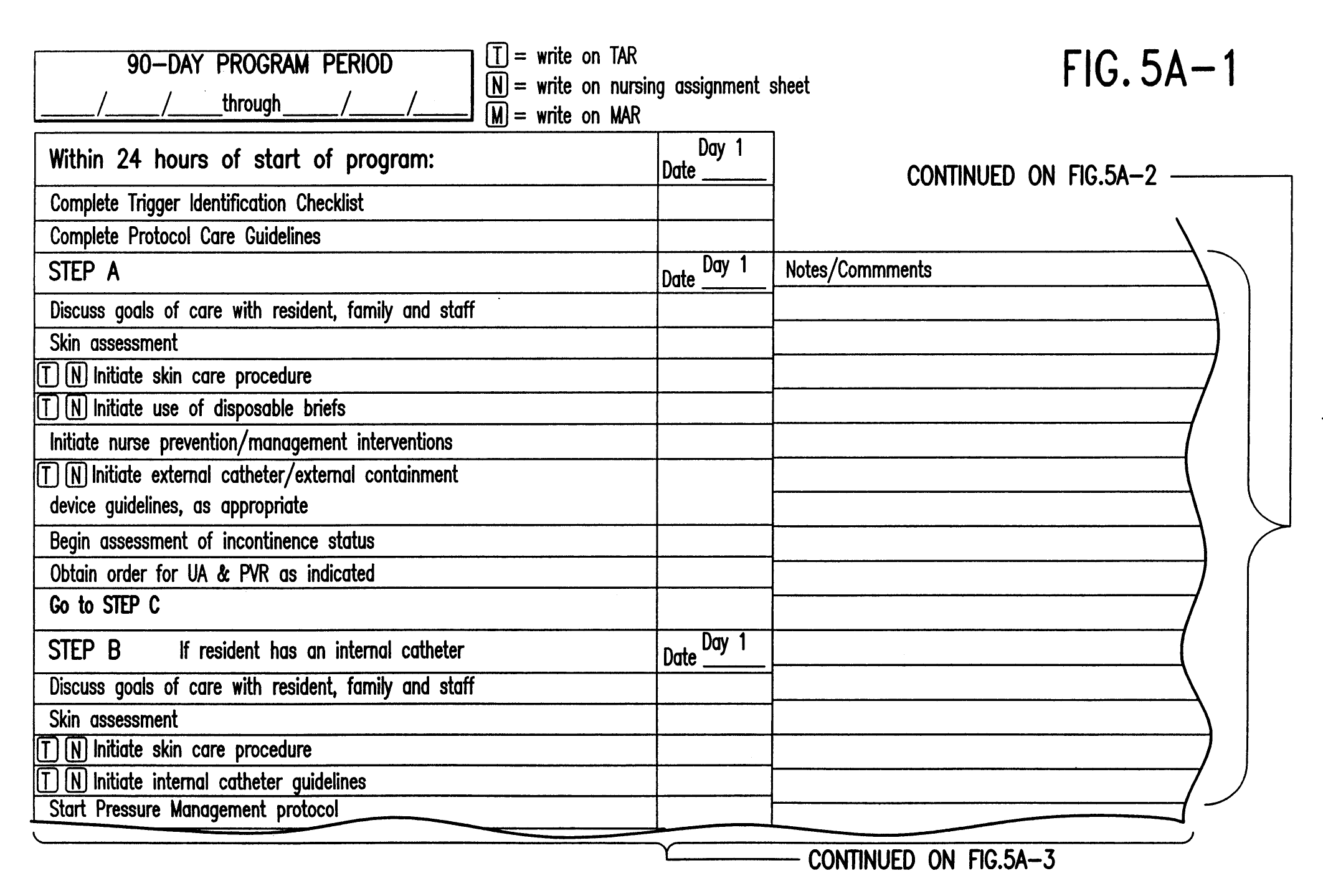

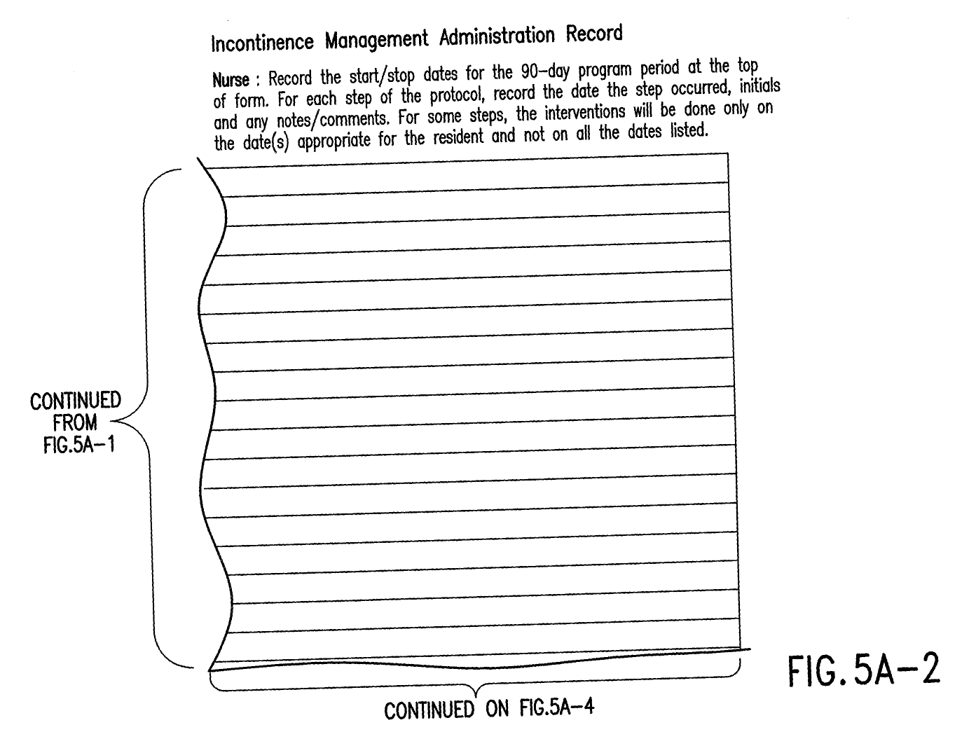

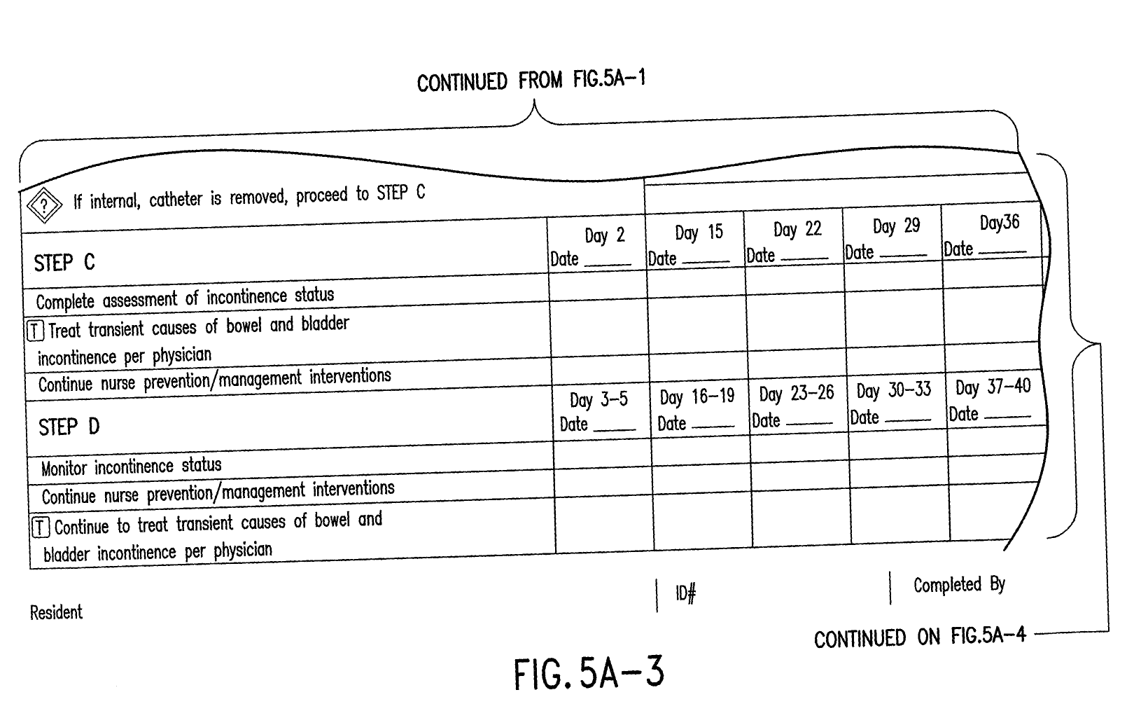

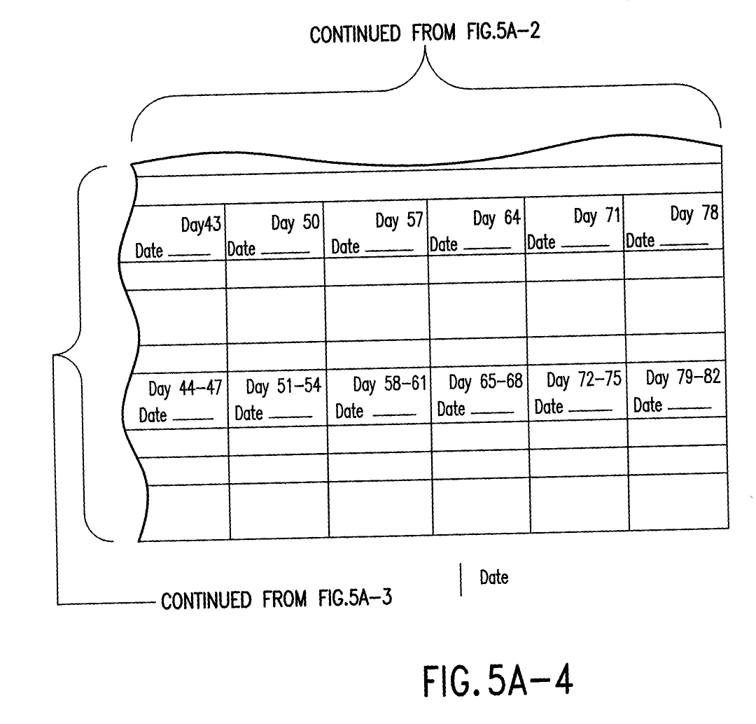

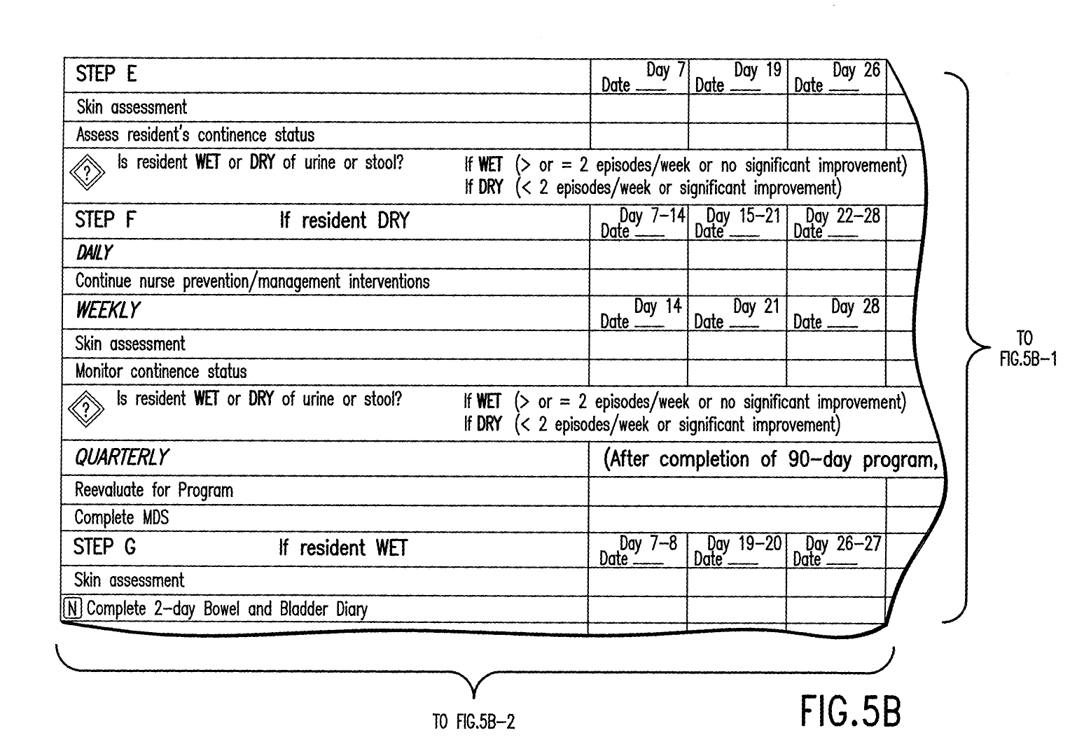

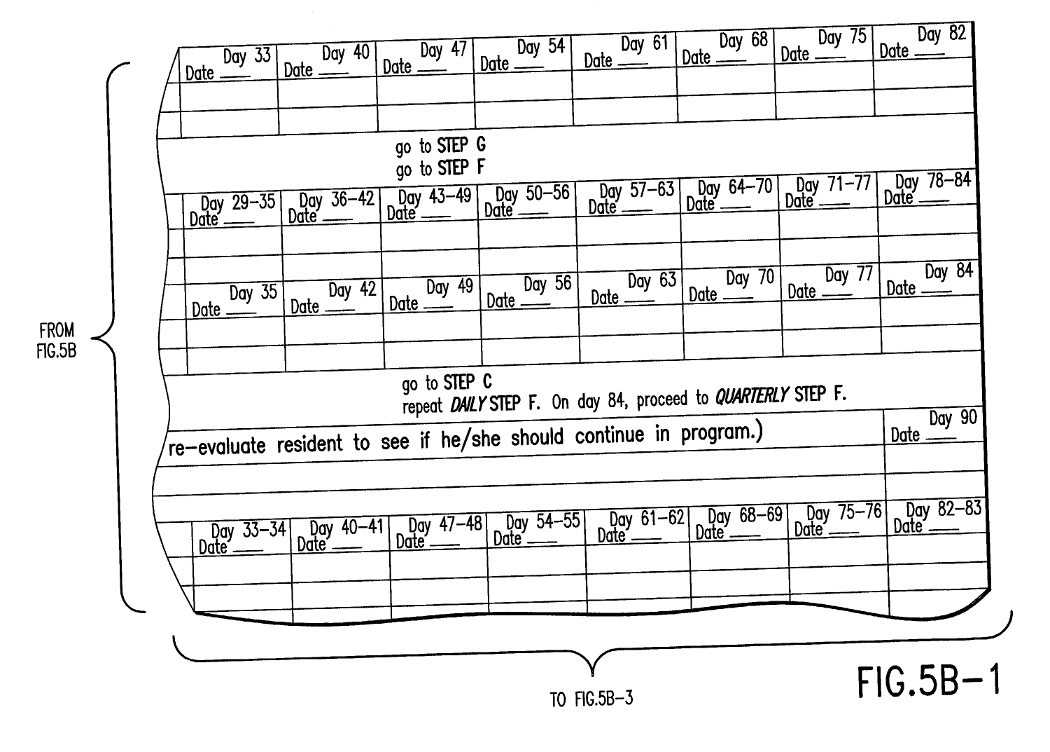

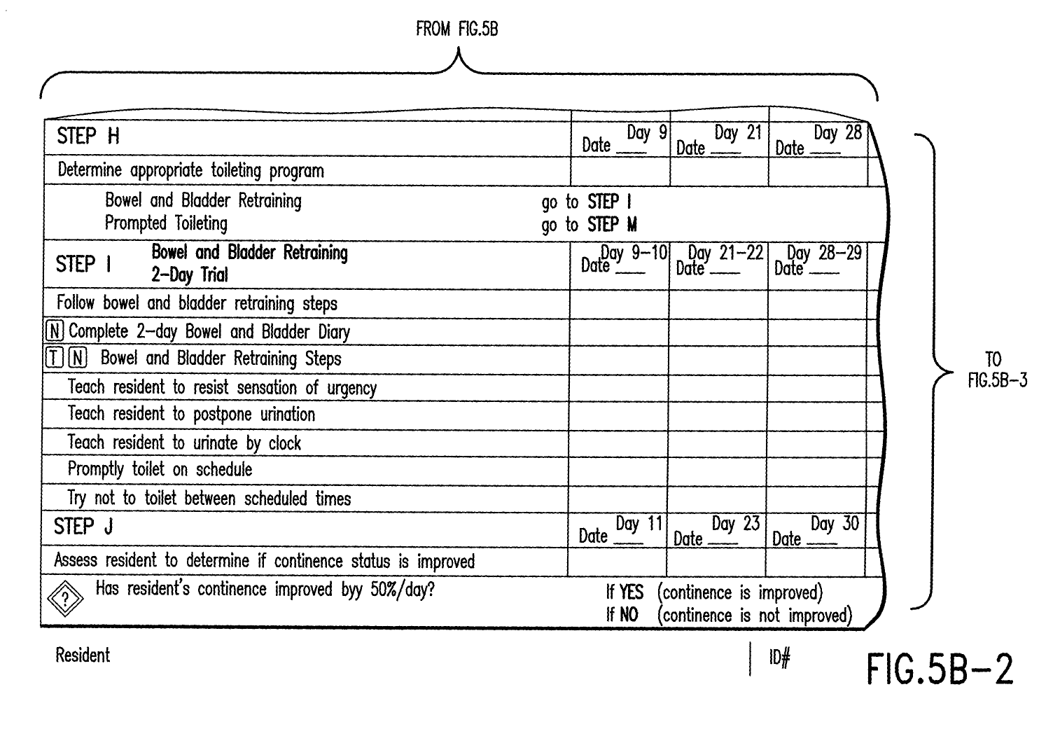

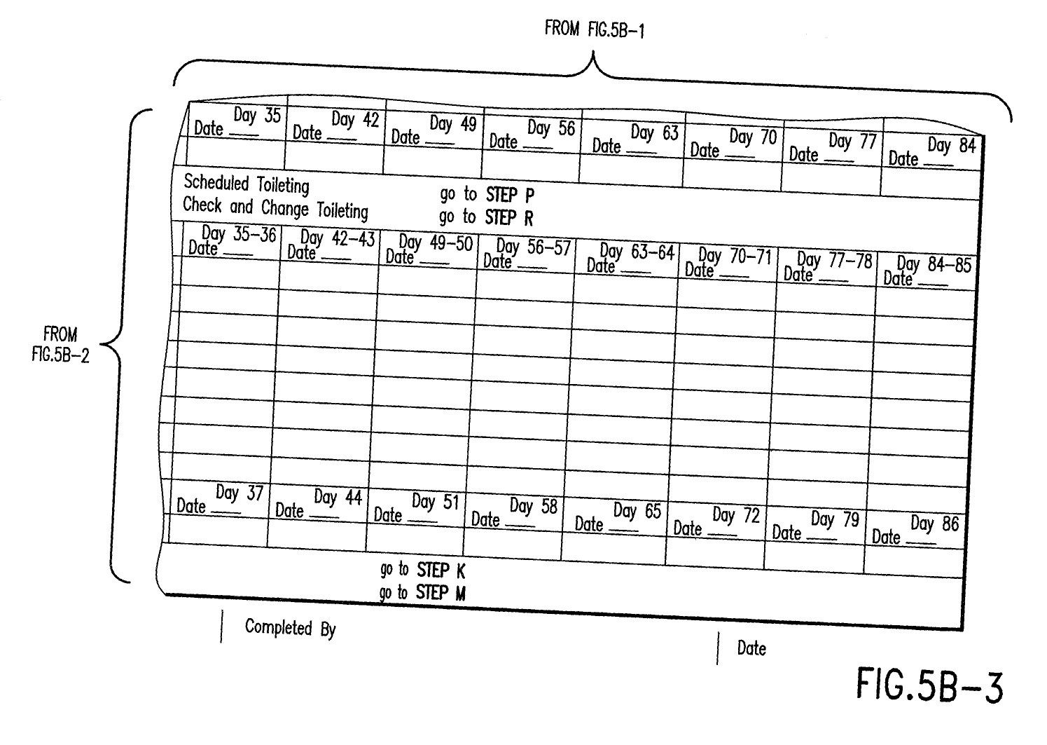

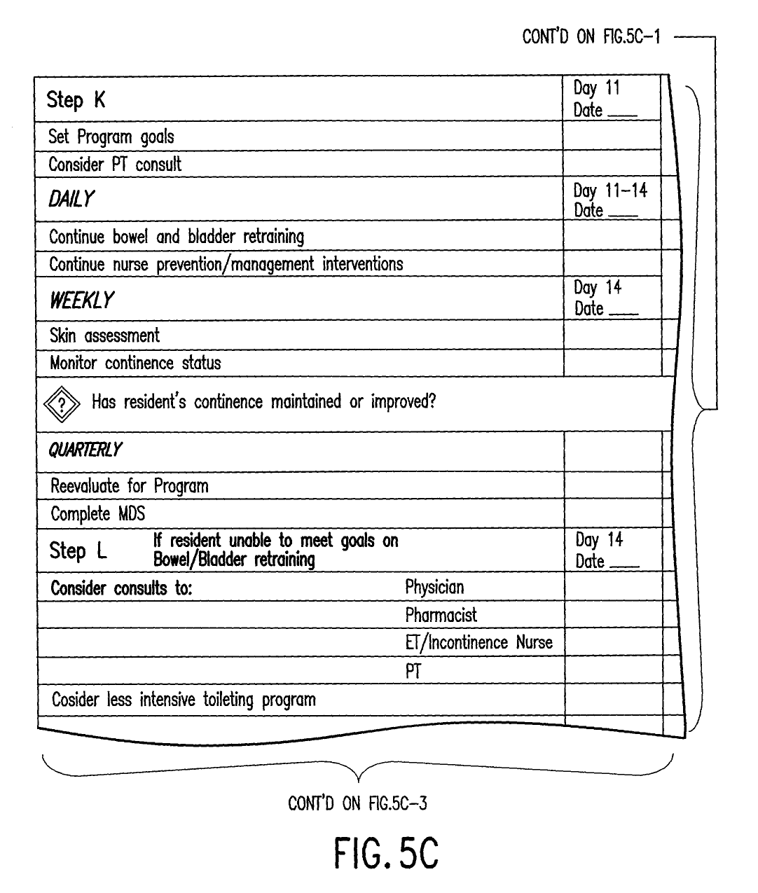

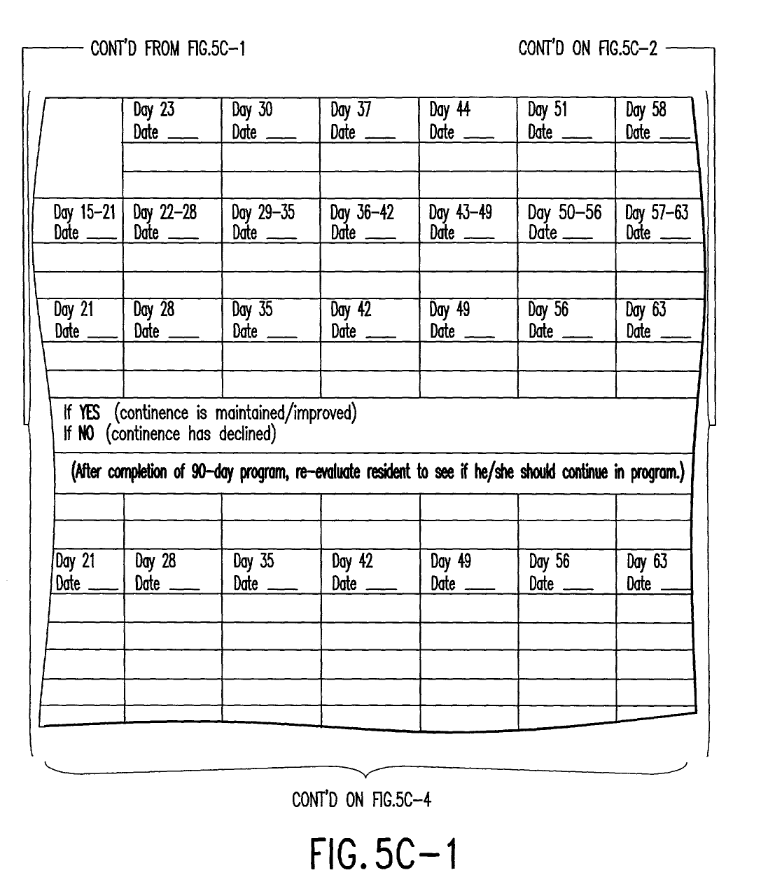

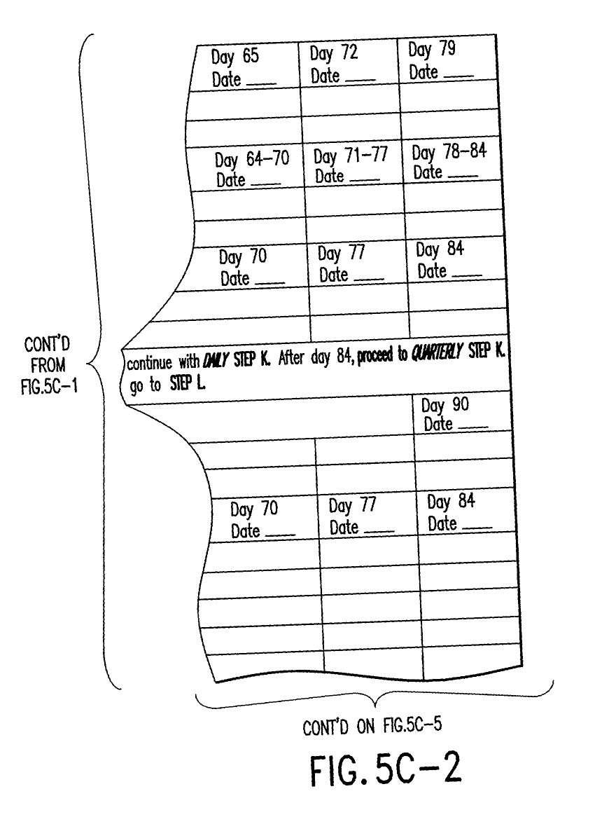

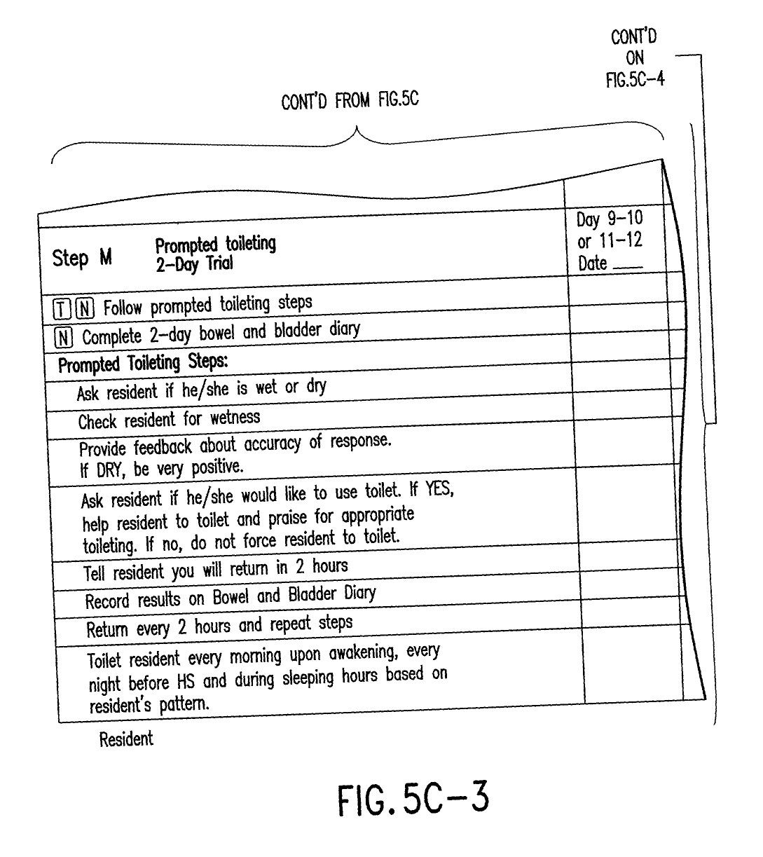

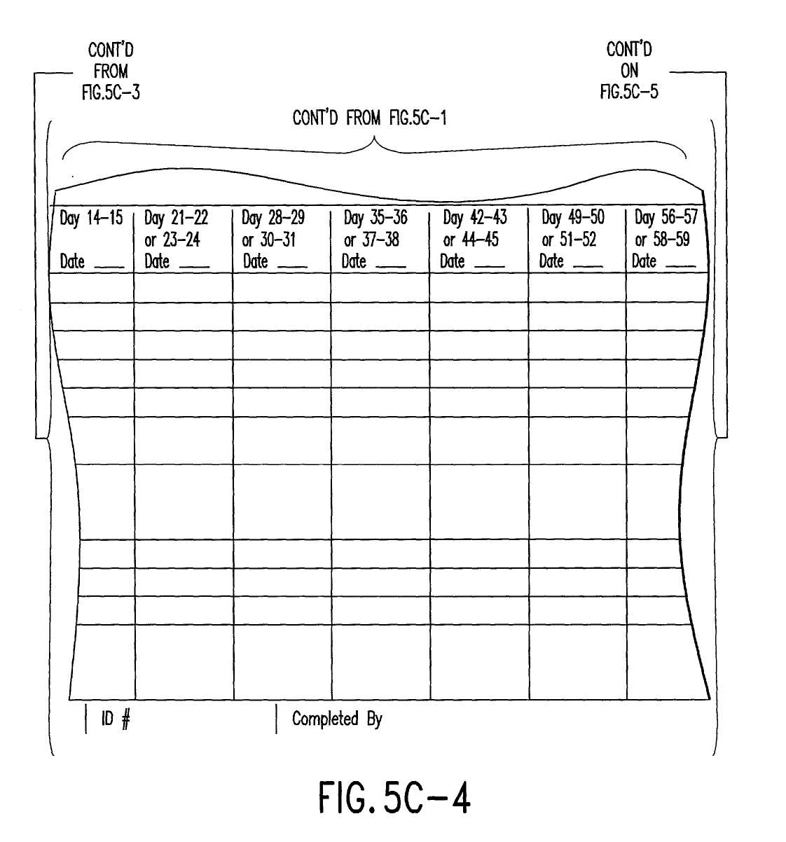

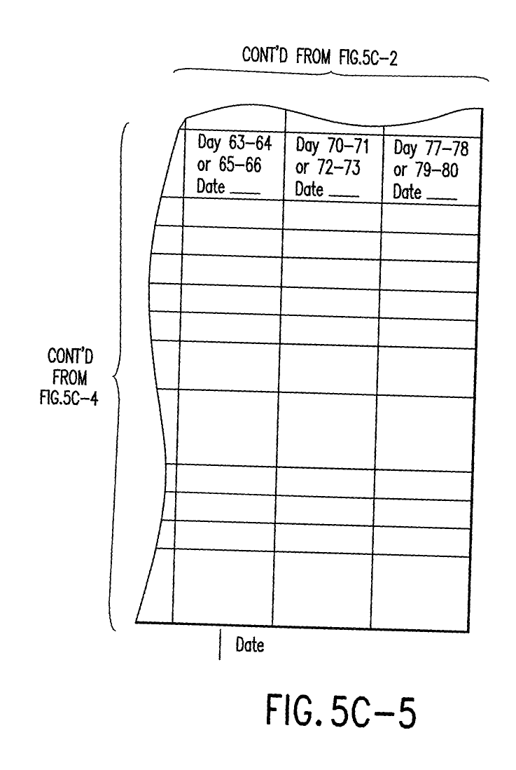

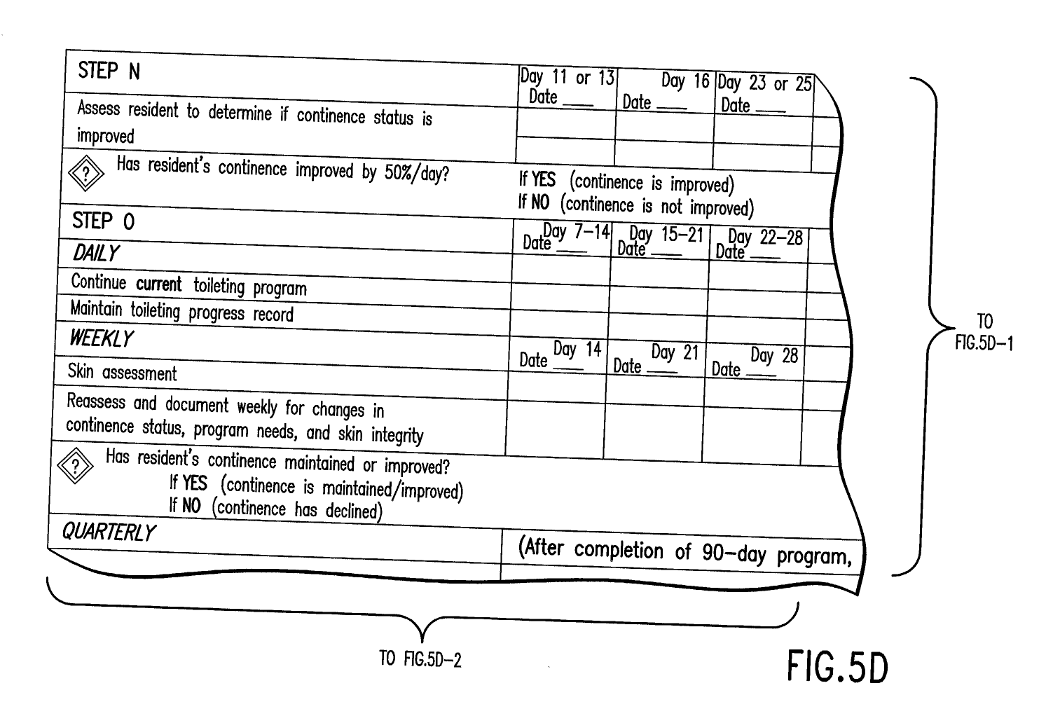

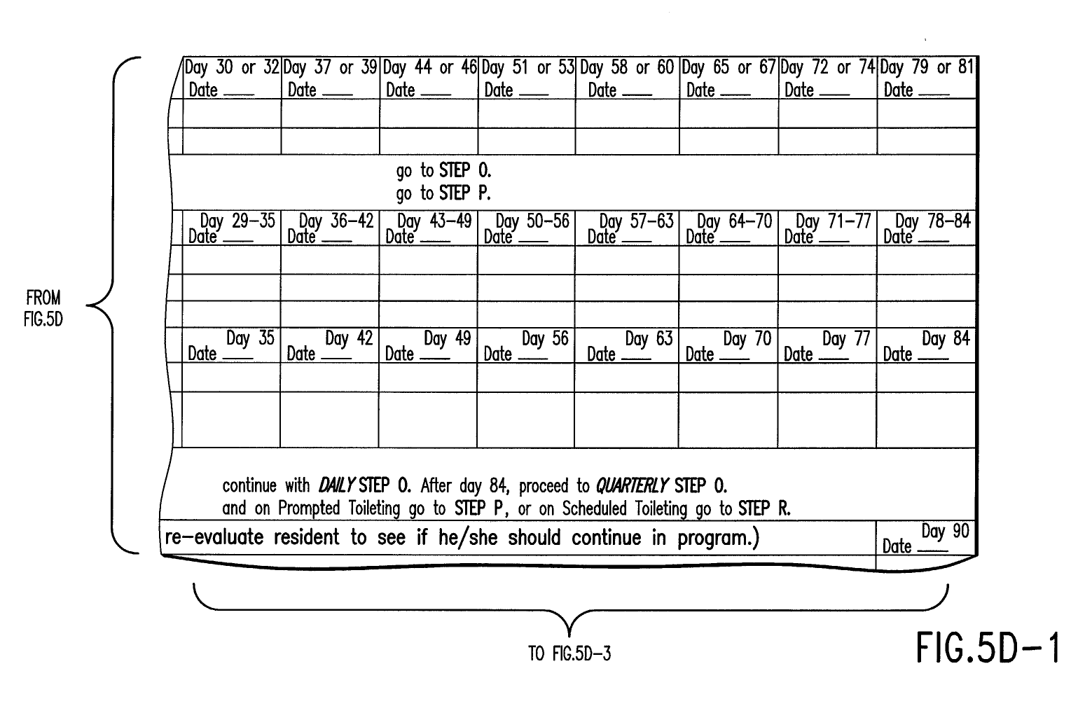

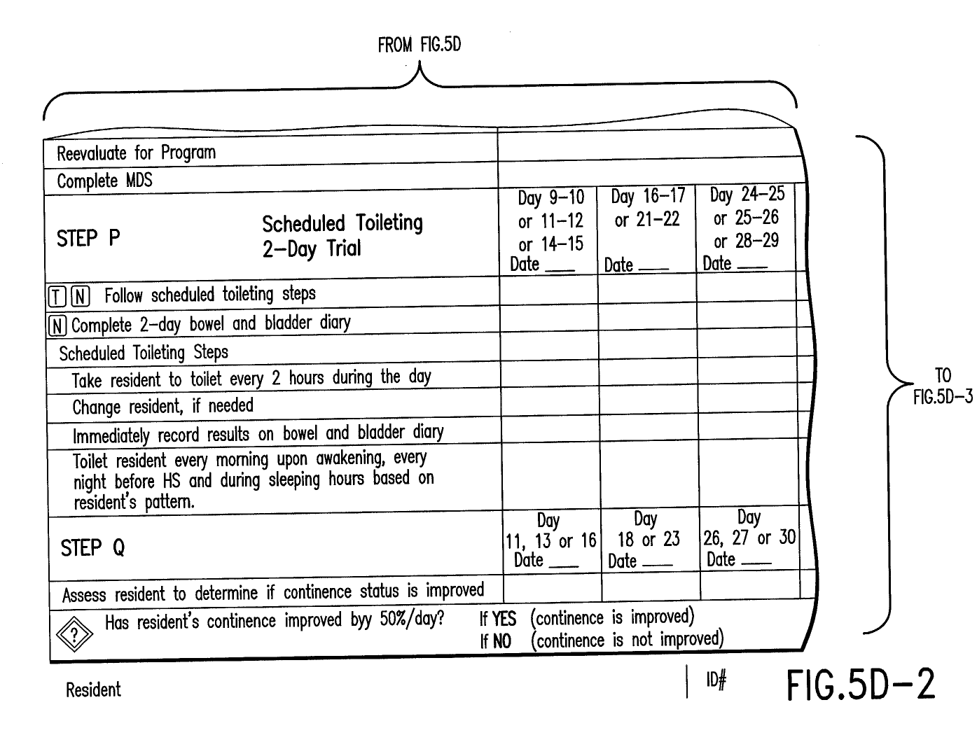

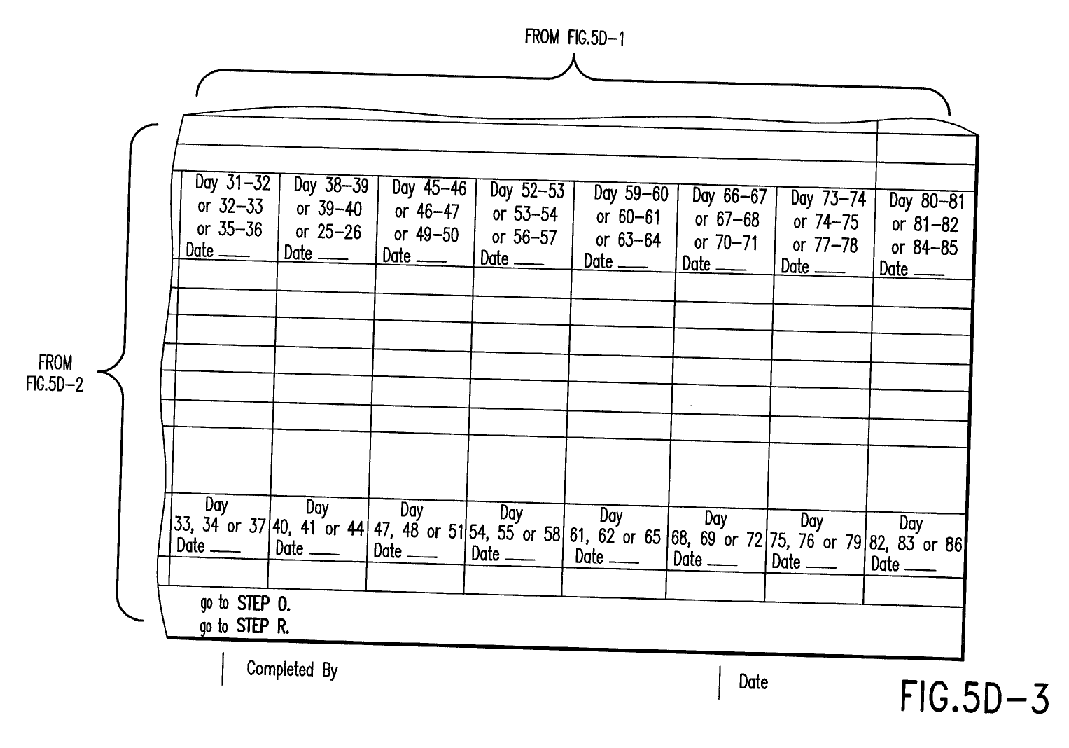

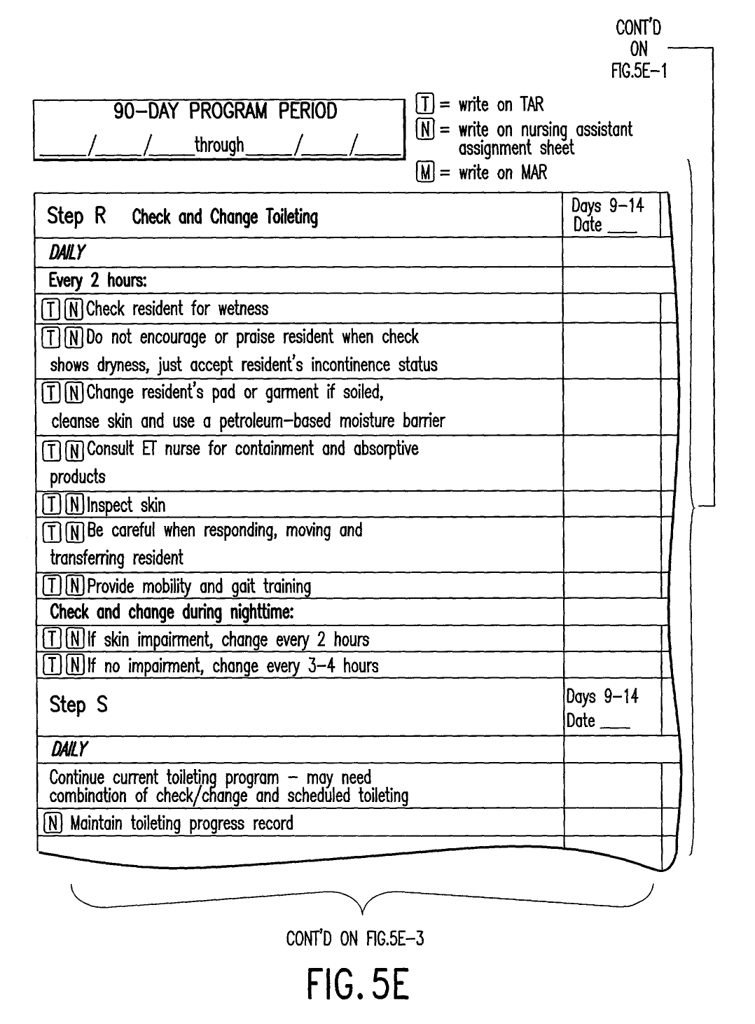

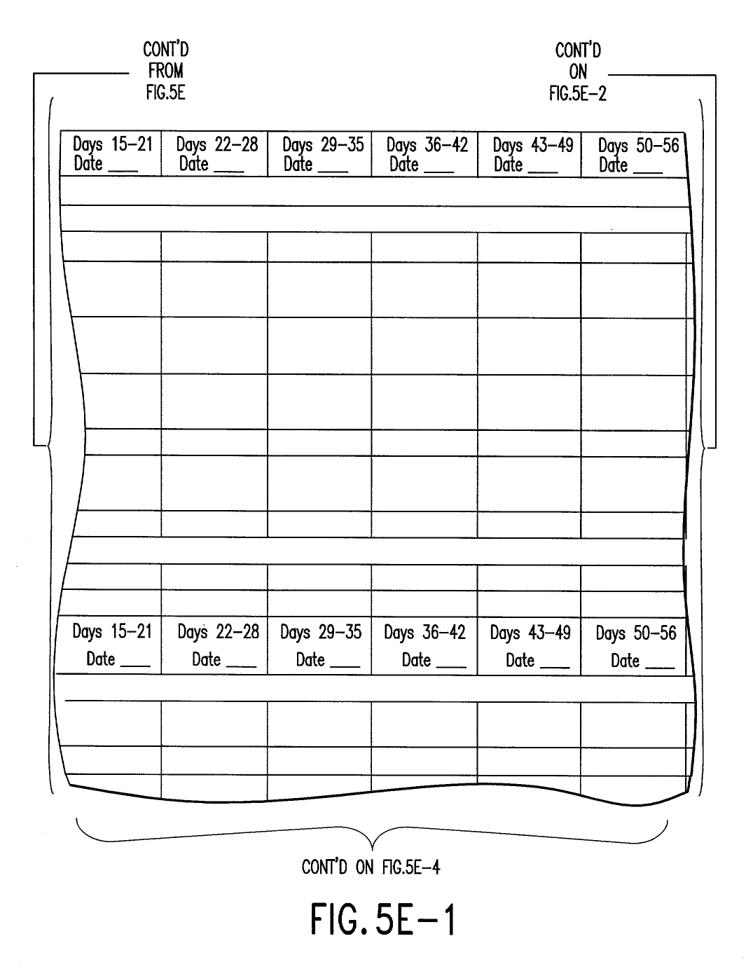

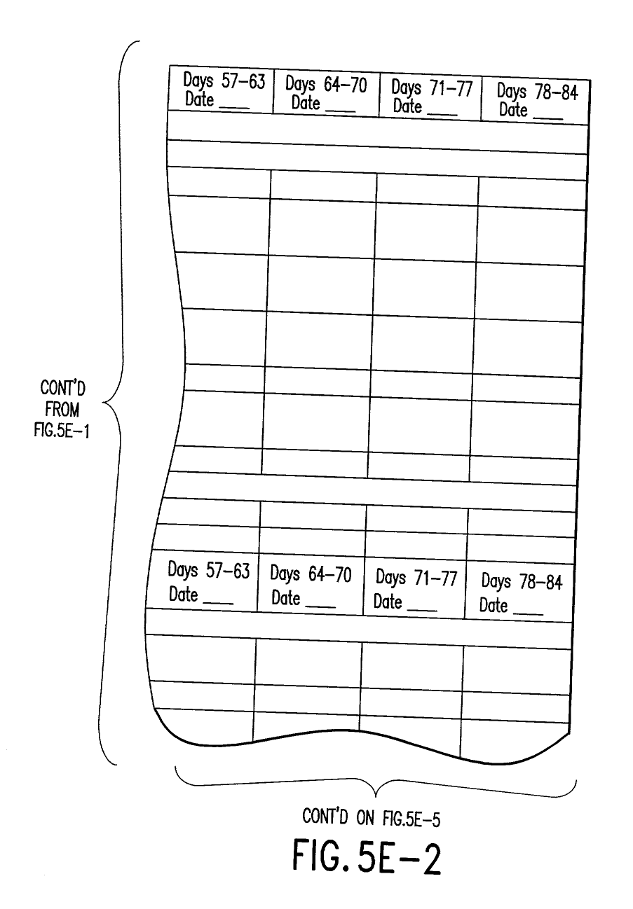

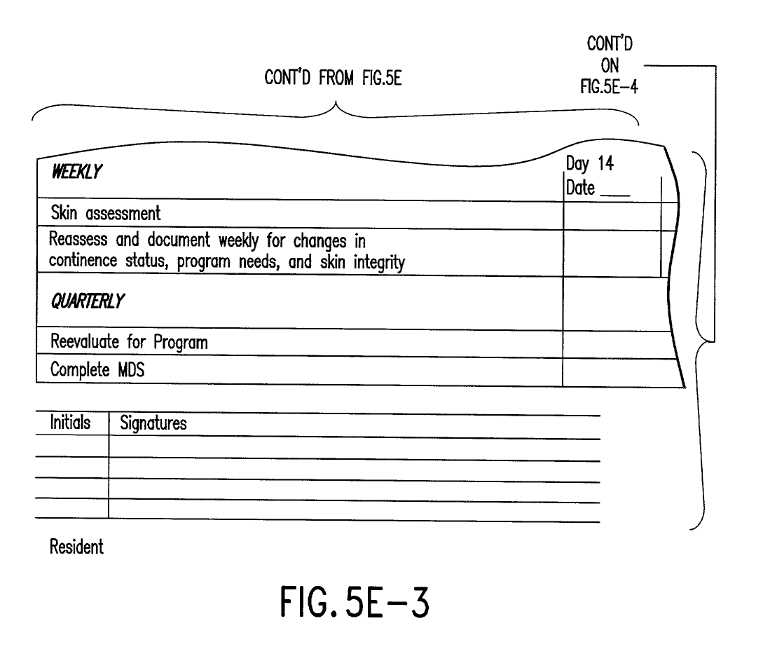

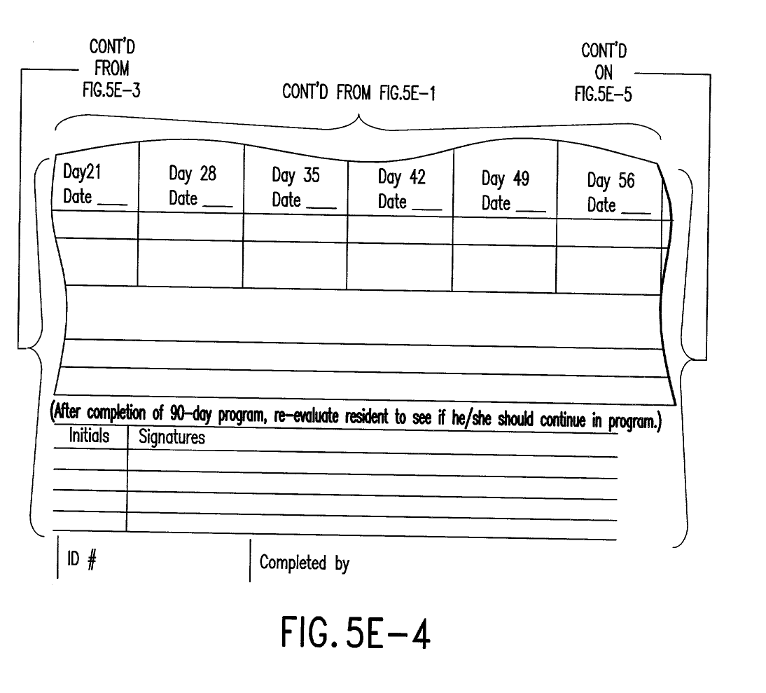

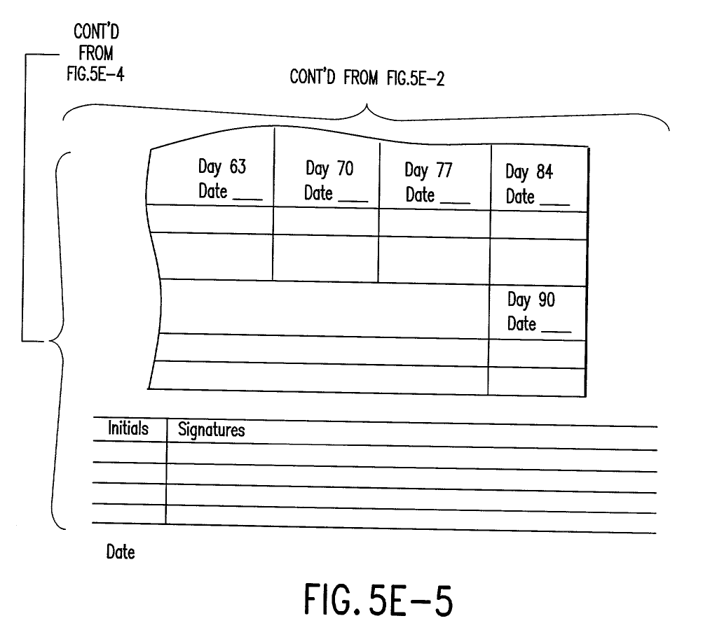

FIG. 5 illustrates a flow diagram of the second of two parts of an incontinence protocol for the prevention of pressure ulcers, specifically an incontinence management protocol 90. The incontinence management protocol 90 is directed towards treating patients once they are incontinent. In connection with the incontinence management protocol 90, the specific incontinence management triggers defined include: (1) bowel or bladder incontinence; (2) the use of external containment devices including briefs/pads or condom catheters; and/or (3) the use of an internal catheter including indwelling or intermittent. Initially, the protocol provides for the examination 92 of the patient and the patient's medical history, within 24 hours of admission, for one or more of the triggers.

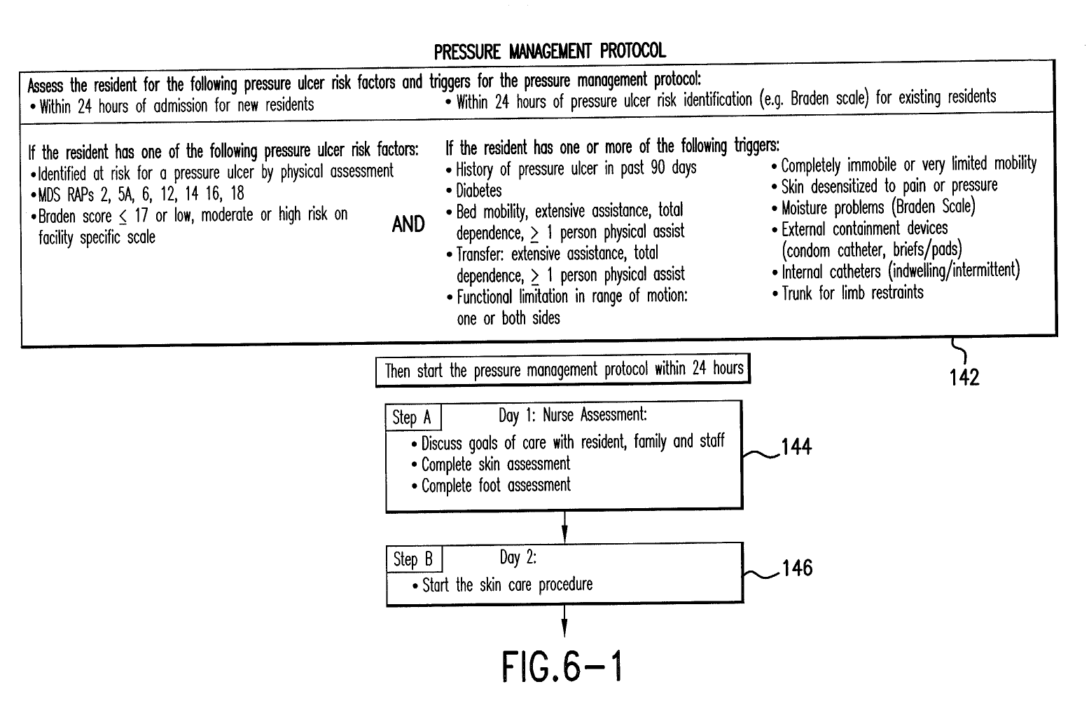

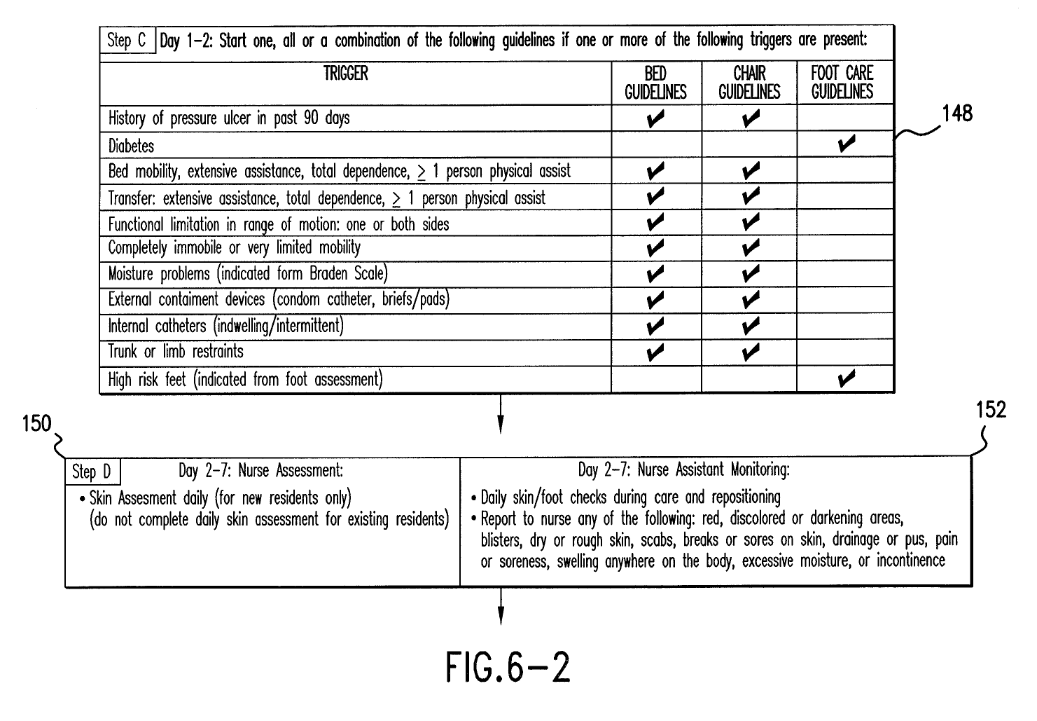

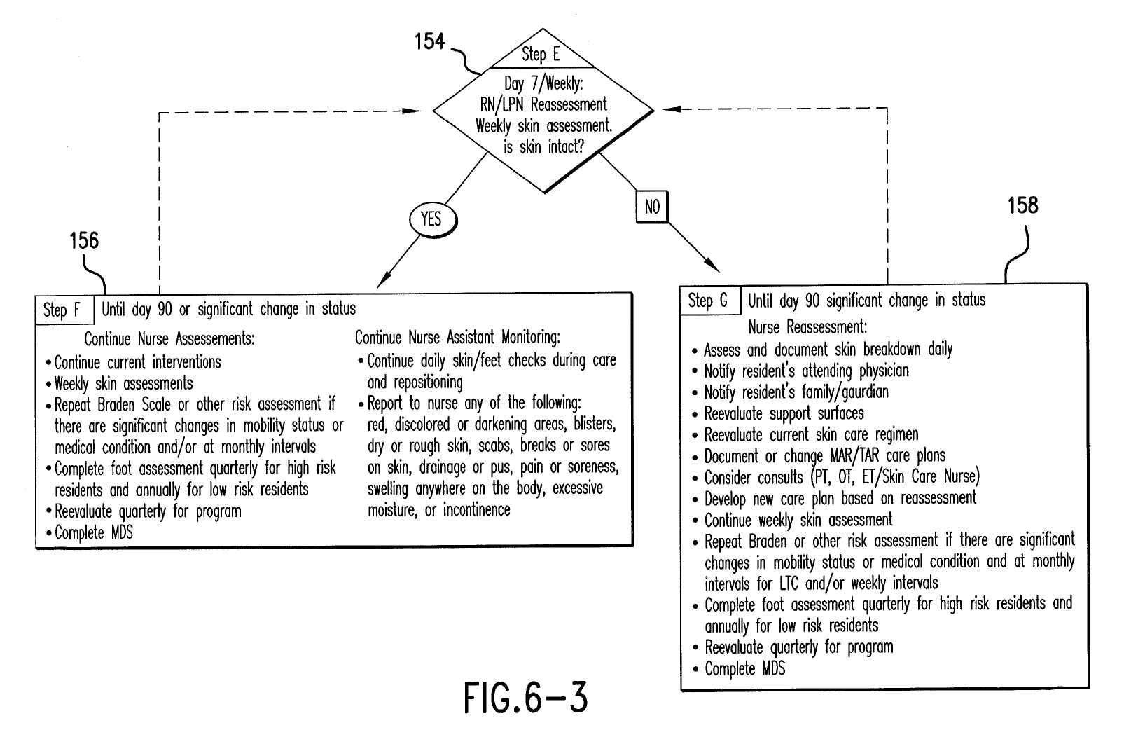

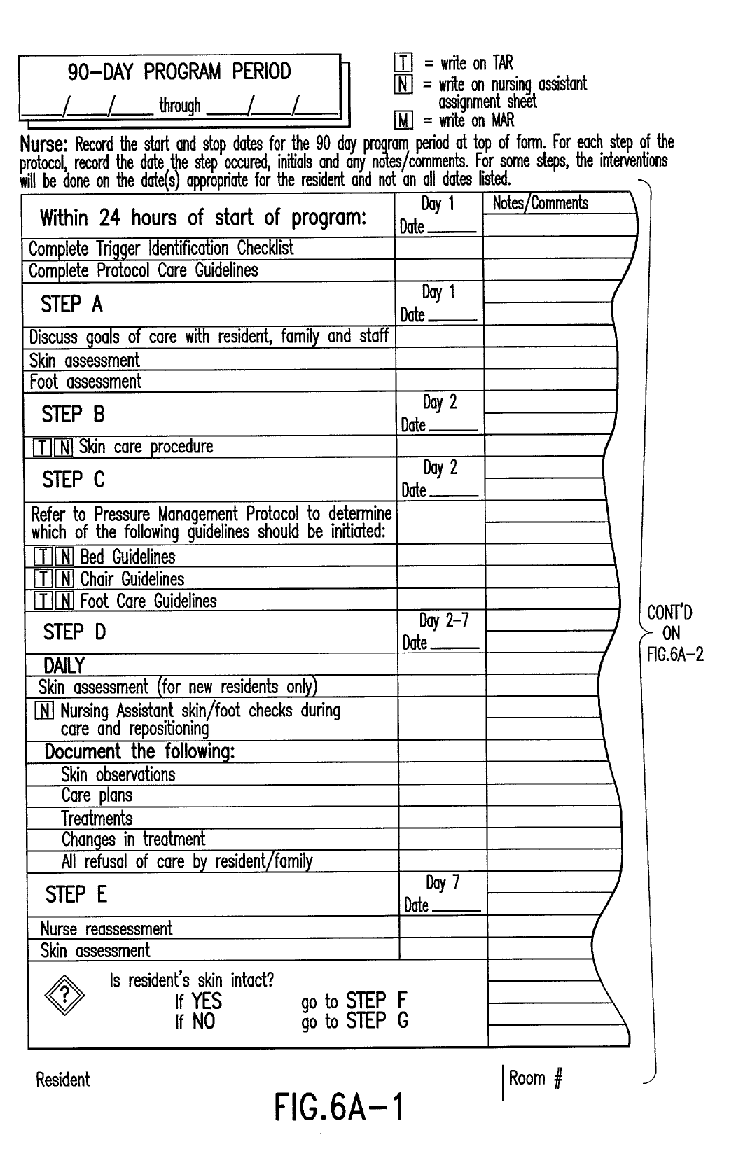

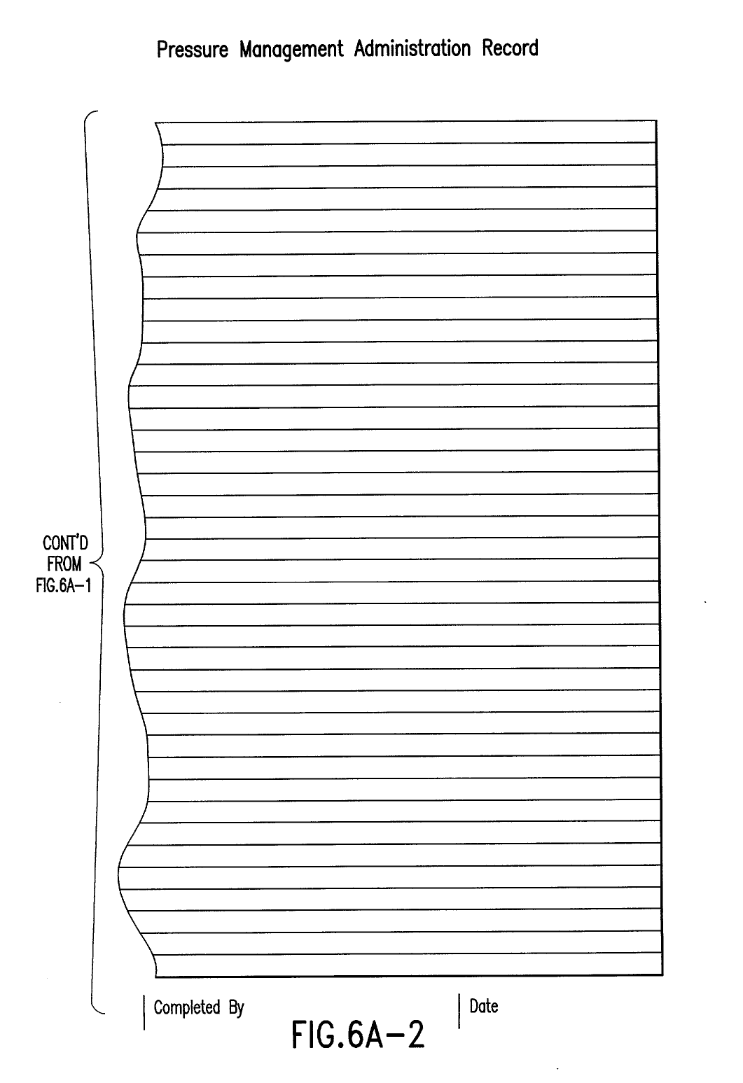

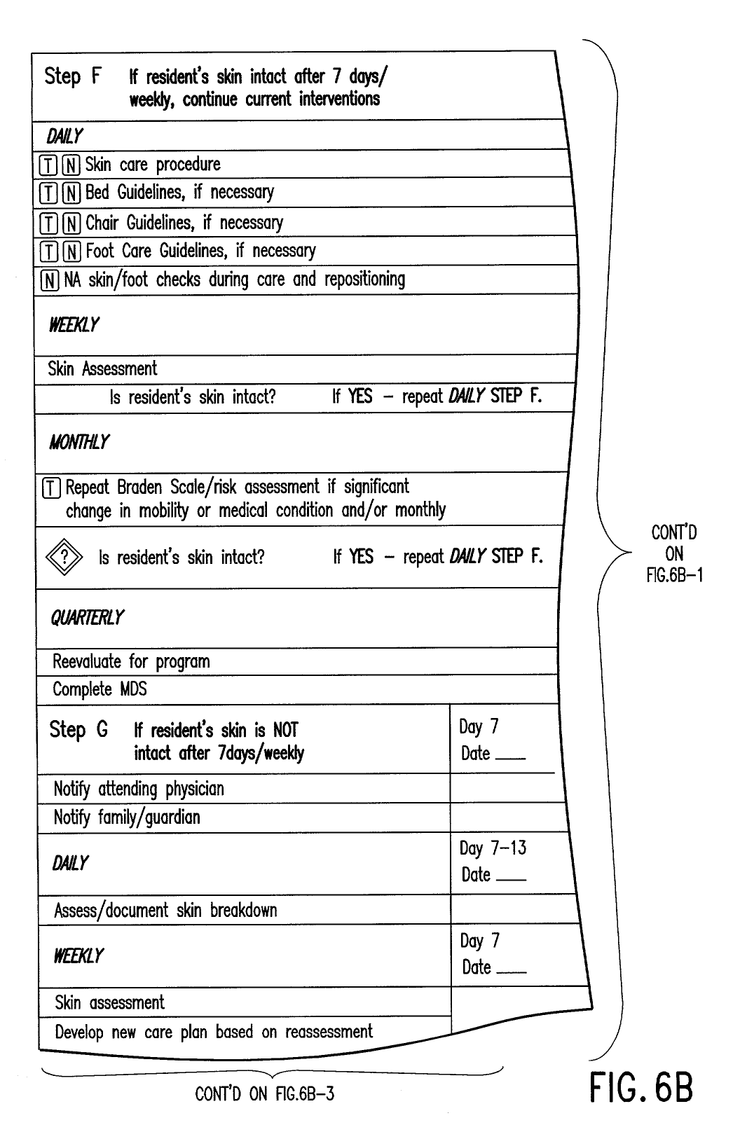

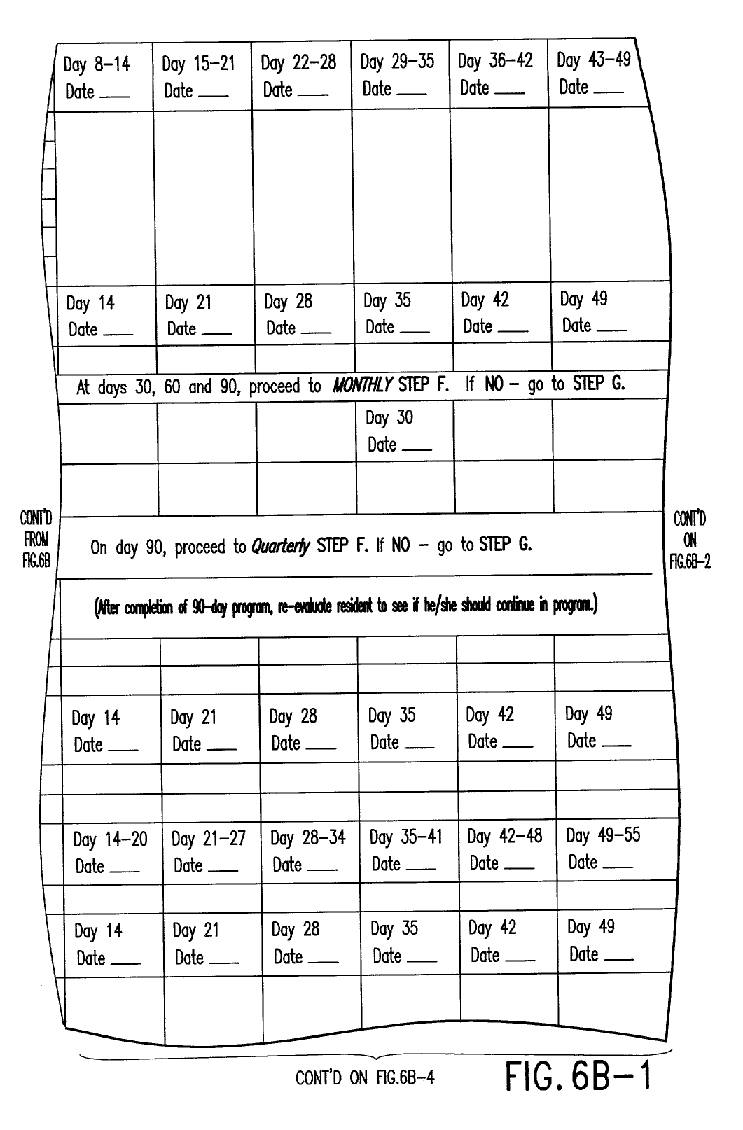

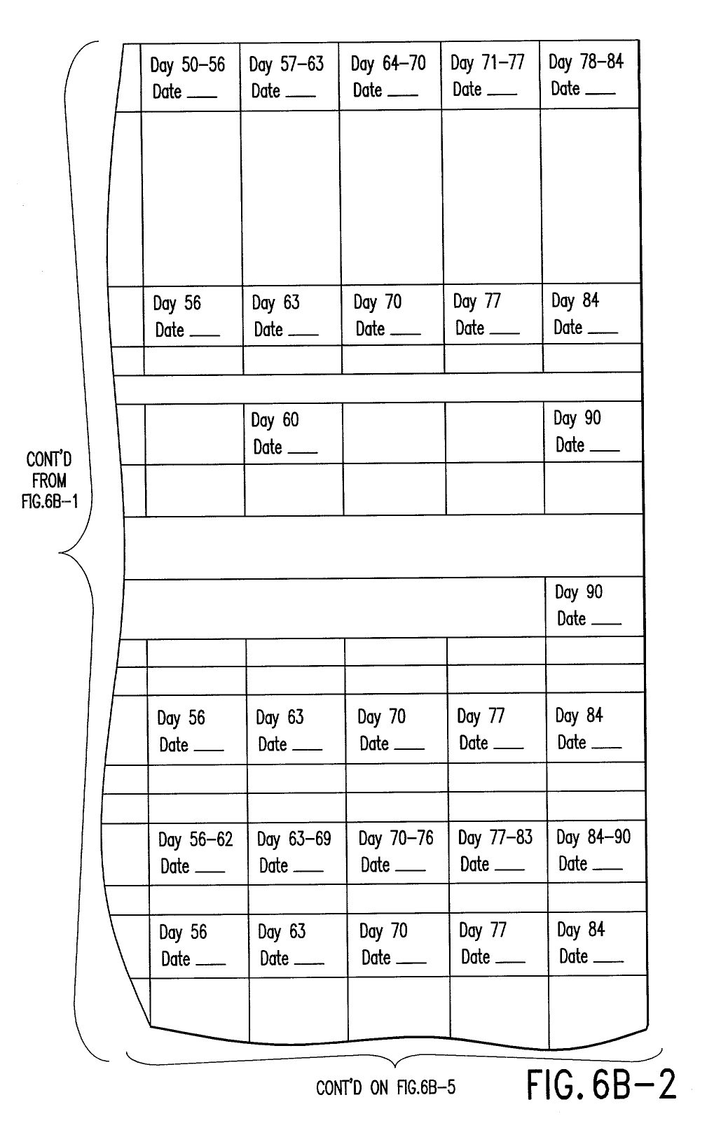

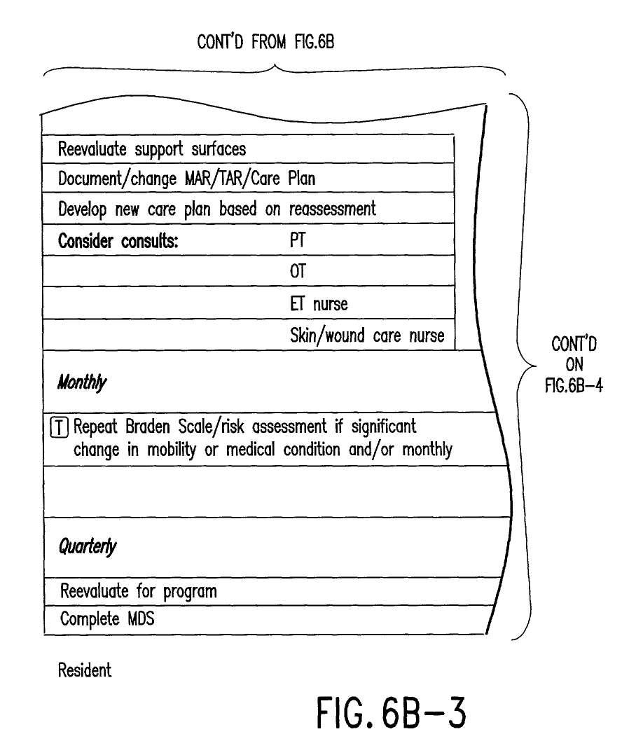

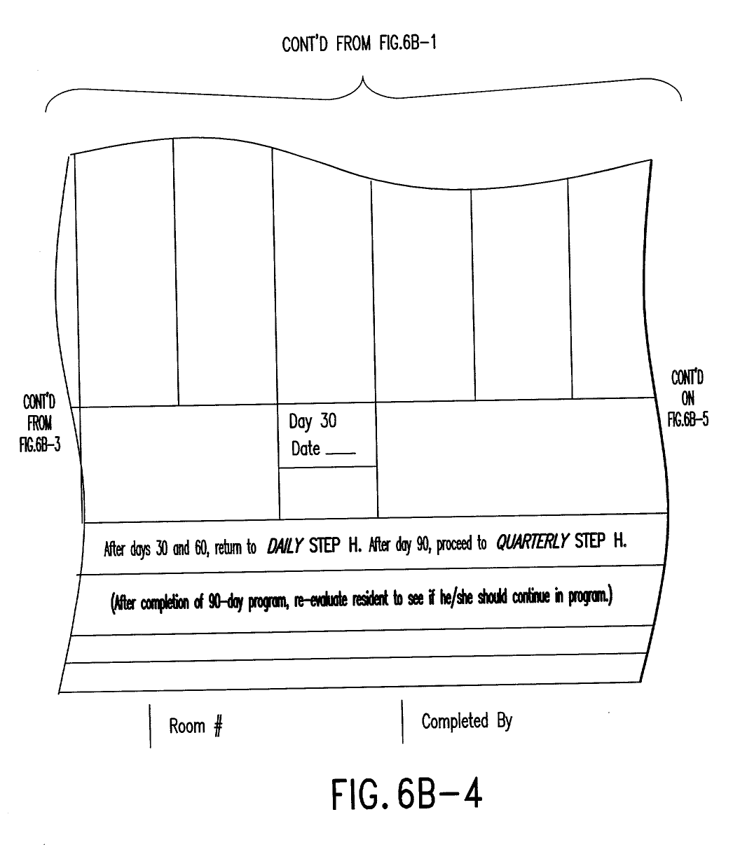

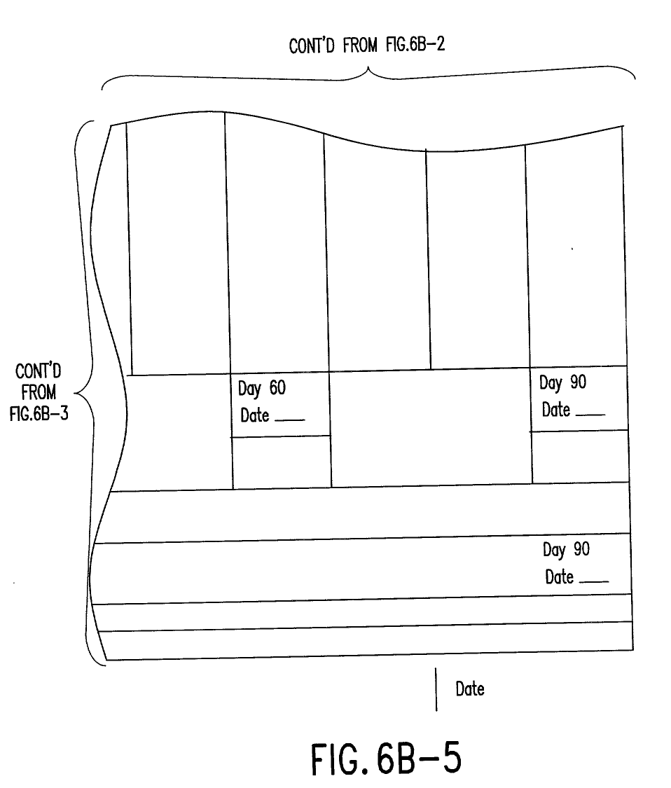

If one or more of the incontinence management triggers are present the patient is started on the incontinence management protocol. Within 24 hours of starting the patient on the incontinence management protocol, if the patient uses an internal catheter, goals are discussed with patient, patient's family and staff; an initial skin assessment of the patient is made (and weekly thereafter); a skin care procedure and internal catheter guidelines are initiated; and the pressure management protocol, discussed below in connection with FIG. 6, is initiated (the use of an internal catheter is also a trigger factor for the pressure management protocol) 94. If the internal catheter is later removed, the incontinence management protocol is continued 96, as if no internal catheter is present. The initial skin assessment is similar to the skin assessment described in connection with the nutrition management protocol.

The internal catheter guidelines include measures to insure that a properly sized catheter is used (it is recommended to use the smallest size catheter that will provide proper drainage), measures to reduce the risk of urinary tract infection, prevent/manage leakage around the catheter, reduce incidence of skin problems, educate the patient and the patient's family, and change the catheter, as necessary.

Reducing the risk of urinary tract infection includes using strict aseptic techniques to insert the catheter, minimizing urethral trauma during insertion by using a sufficient quantity of sterile lubricant and inserting the catheter to the hub before inflating the balloon, stabilizing the catheter with an adhesive anchoring system or with the catheter strap, maintaining a closed system by changing the entire system together as necessary, keeping the drainage tubing in a dependent position to facilitate urine flow, gently cleansing the perineum and proximal catheter daily and after each bowel movement, and taking measures to correct impaction and constipation.

Measures to prevent/manage leakage around the catheter include assessing the catheter for patency (if blocked, remove and replace the catheter), to get urine for a culture, removing the existing catheter and inserting a new catheter before getting the urine sample, providing adequate hydration if the urine is concentrated, checking for fecal impaction and removing any impact of stool, insuring that the balloon is inflated to the correct size, stabilizing the catheter with an adhesive anchoring system or with the catheter strap, and considering consulting the physician about an anticholinergic medication for severe bladder specimens.

Measures to reduce incidence of skin problems include gently washing and drying the periurethral area daily with a skin cleanser of choice; examining the area for signs of catheter irritation, inflammation, ulceration, pressure necrosis, leakage, and unusual drainage around the tube site; anchoring the catheter to prevent inadvertent removal, repositioning the taping every three to five days; using a moistened cotton swab to remove encrustation around the catheter, as needed; and if perineal skin irritation is presented identified as yeast, obtaining a physician order for topical antifungal treatment (apply the topical antifungal treatment first, and the moisture barrier second).

If the patient does not use an internal catheter, within 24 hours of starting the patient on the incontinence management protocol, goals are discussed with the patient, patient's family and staff; an initial skin assessment should be made; a skin care procedure, the use of disposable briefs, nurse prevention/management interventions, the use of external catheter/containment guidelines as necessary, and an assessment of incontinence status are initiated 96.

The skin care procedures include beginning a bowel and/or bladder program that best fits the patient's individual needs, giving perineal skin care approximately every two hours and whenever there is soilage, cleaning the skin immediately after soiling, applying a moisture barrier in a thin layer over the skin, putting a quick-drying absorbent pad beneath a patient who is on bed rest or in a chair, giving ambulatory residents absorbent, quick-drying briefs or pads, changing moist or soiled linen clothing promptly, if a rash develops on the skin around the perineum, applying a moisture barrier after cleansing (apply the topical antifungal treatment first and the moisture barrier second), considering use of an external containment device, and if necessary consulting a nurse specializing in skin care or enterostomal therapy.

The nurse prevention/management interventions are the same as the nurse prevention/management interventions identified above in connection with the incontinence prevention protocol and include the education of the patient and the patient's family; the provision of adequate fluids; the removal of barriers to toileting access; the provision of visual and verbal reminders to toilet; the consideration of the use of a bedside commode and urinal; a review of medications; measures to be taken to normalize stool consistency and volume; and the possible initiation of a bowel program. If necessary late evening fluids can be decreased, caffeine intake limited, use of restraints evaluated, use of rapid-acting diuretic considered, intervention for lower extremity edema considered, or consultation with other specialists considered.

The assessment of incontinence status includes the medical records of the patient being reviewed, the patient and the patient's family being interviewed, a focused physical examination being completed, an assessment of the patient's cognitive skills, mobility limitations, and environment being made, and a physician order for a urinalysis and a post-void residual being obtained.

Within 48 hours of starting the patient on the incontinence management protocol, the assessment of incontinence status is to be completed, any transient causes of bowel and bladder incontinence are to be treated, and nurse prevention/management interventions 98 are to be continued. During days 3-6, the incontinence status is monitored, the transient causes of bowel and bladder incontinence are continued to be treated per physician, and the nurse prevention/management interventions are further continued 99. On day 7, the continence status of the patient 100 is determined.

Transient and potentially reversible causes of incontinence include urinary tract infections; dehydration and fluid imbalance; constipation, diarrhea and fecal impaction; use of certain medications; delirium; endocrine abnormalities; atrophic urethritis and vaginitis; restricted mobility; and environmental barriers.

If the patient has fewer than two incidents per week, the patient is considered dry. By day 7, for a patient considered dry, the continence status of the patient is continued to be monitored, nurse prevention/management interventions, and weekly skin assessments 102 are also continued. The patient is then reevaluated quarterly or as necessary for the protocol, and the Minimum Data Set (MDS) completed as indicated. If thereafter the patient becomes wet of stool or urine, the incontinence management protocol is continued from near the beginning 98, as if entering day 2 of the incontinence management protocol 90.

If the patient has two or more incidents per week, the patient is considered wet. By day 7, for a patient considered wet, weekly skin assessments are continued. Additionally, a bowel and bladder diary is completed, and an appropriate toileting program 104 is determined. To determine an appropriate toileting program a series of criteria are considered.

The bowel and bladder diary includes questions directed towards the patient's ability to recognize the need to toilet at least once in a 12 hour period, whether the patient is dry at least once per twelve hour period, whether the patient can cooperate in toileting at least once in a 12 hour period, whether the patient can delay toileting for a two-hour period at least once in a 12 hour period, whether the patient is able to hold between approximately 150 cc to approximately 200 cc of urine at least once in a 12 hour period, whether the patient is able to recognize the need to toilet at least once in a 12 hour period, and whether the patient can toilet without help.

On day 9, a determination is made with regard to the appropriate toileting program based upon a review of the bowel and bladder diary 105.

If the patient can toilet without help, can recognize the need to toilet, is dry at least once per 12-hour period, and can cooperate with toileting 106, bowel and bladder retraining is started. As part of bowel and bladder retraining program goals are set, specialists are consulted as necessary, weekly skin assessments are performed, and the continence status of the patient is monitored. If as a result of the bowel and bladder retraining program two day trial, continence is improved 107, the bowel and bladder retraining program should be continued, program goals set, nurse prevention/management interventions continued, and skin assessments and monitoring of continence status performed weekly, until day 90 or a significant change in status occurs 108. The patient should also be reevaluated quarterly or as necessary for the protocol, and the Minimum Data Set (MDS) completed as indicated.

If the patient is unable to meet the individualized goals other specialists 109 should be consulted for further evaluation and a less intensive toileting program should be considered.

The bowel and bladder retraining program teaches the patient to resist the sensation of urgency, to postpone urination, and to urinate by the clock. The patient keeps track of toileting intervals with the timer. By gradually lengthening toileting intervals, the habit of frequent urination is broken, the bladder is stabilized, and the sensation of urgency is diminished. The bowel and bladder retraining program may additionally include pelvic muscle exercises, biofeedback, and/or electrical stimulation.

If the patient cannot toilet without help, but can recognize the need to toilet, is dry at least once per 12-hour period, and can cooperate with toileting, a prompted toileting program is started for a two day trial 110. If as a result of the prompted toileting program two day trial, continence is improved 114, the prompted toileting program should be continued, the toileting record maintained, weekly skin assessments performed, changes in continence status and skin integrity reassessed and documented weekly, the protocol reevaluated quarterly or as necessary, and the Minimum Data Set (MDS) completed as indicated until day 90 or a significant change in status occurs 116.

The prompted toileting program includes checking with the patient every two hours and asking if the patient is wet or dry. The patient's response is verified by checking the patient for wetness. Feedback is provided to the patient about the accuracy of the response.

The patient should be asked if he or she would like to use the toilet. If the answer is yes, any necessary assistance should be provided. The patient should be told that you will return in two hours. The results should be recorded on the bowel and bladder diary. Upon return in two hours, the above steps should be repeated. The patient should be toileted prior to bedtime.

If as a result of the prompted toileting program two day trial, continence does not improve 114, a scheduled toileting program should be started for a two day trial 122.

A scheduled toileting program two day trial 122 should also be started if the patient cannot toilet without help, cannot recognize the need to toilet, is dry at least once per 12-hour period, and can cooperate with toileting.

The scheduled toileting program includes taking the patient to toilet every two hours during the day, and changing the patient as necessary. The results should be recorded in the bowel and bladder diary. During nighttime, the patient should be toileted before bedtime, during sleep hours as necessary based on the patient's toileting pattern, and upon awakening in the morning.

If the scheduled toileting program two day trial 120 does not improve the continence status of the patient 124, the toileting program for the patient should be changed to a check and change toileting program 126. If the continence status of the patient 124 does improve, the scheduled toileting program 122 should be continued, the toileting record maintained, weekly skin assessments performed, changes in continence status and skin integrity reassessed and documented weekly, the protocol reevaluated quarterly or as necessary, and the Minimum Data Set (MDS) completed as indicated until day 90 or a significant change in status occurs 116.

The check and change toileting program 126 should be initiated if the patient cannot toilet without help, cannot recognize the need to toilet, is wet most of the time, and cannot cooperate with toileting 128.

The check and change program includes checking the patient for wetness every two hours, changing the patient's pad or garment as soon as becomes wet or soiled, gently cleansing the skin with a mild cleansing agent, using a topical barrier ointment or cream to protect skin from moisture, especially if there are signs of irritation, inspecting the patient's skin daily for evidence of skin breakdown, reporting any skin problems, repositioning the patient regularly, providing mobility and gait training, checking and changing the patient during nighttime pursuant to the patient's individualized needs. If the patient has a skin impairment, the patient should be changed every two hours. If the patient does not have a skin impairment, the patient should be changed every three to four hours dependent upon the patient's needs.

As part of the check and change program 126, a specialist may need to be consulted, the continence status of the patient reassessed weekly, the skin integrity of the patient assessed daily, in addition to regular weekly skin assessments, the patient protocol should be reevaluated quarterly or as necessary, and the Minimum Data Set (MDS) completed as indicated until day 90 or a significant change in status occurs.

By following the incontinence protocols for pressure ulcer prevention when the patient exhibits the incontinence prevention or management triggers, extra care can be provided to the patient for improved incontinence prevention and/or management, when improved incontinence prevention and/or management is likely to reduce the patient's likelihood of developing a pressure ulcer.

FIGS. 5A-5E illustrate a suitable form for use in the management and record keeping of the patient's progress in regards to the incontinence management protocol.

FIG. 6 illustrates a flow diagram of a pressure management protocol 140 for the prevention of pressure ulcers. The pressure management protocol is directed toward treating patients at risk for experiencing prolonged physical contact with at least one portion of the body against a hard surface. In connection with the pressure management protocol 140, the specific pressure triggers defined include whether the patient: (1) has a history of pressure ulcers in the past 90 days; (2) has diabetes; (3) requires assistance from one or more caregivers for bed mobility, including turning and repositioning; (4) requires assistance from one or more caregivers for transfering, including repositioning, and shifting weight; (5) has functional limitations in range of motion; (6) is completely immobile or has very limited mobility; (7) has skin which is desensitized to pain or pressure; (8) has moisture problems such as heavy sweating; (9) uses an external containment device including briefs, pads or condom catheter; (10) uses an internal catheter; or (11) has trunk or limb restraints. Initially, the protocol provides for the examination 142 of the patient and their medical history, within 24 hours of admission, for one or more of the triggers.

If one or more of the pressure triggers are present the patient is started on the pressure management protocol. Within 24 hours of starting the patient on the pressure management protocol goals are discussed with the patient, the patient's family and staff; an initial skin and foot assessment of the patient is made 144; and the skin care procedure is started 146.

The skin and foot assessments are generally the same as the skin assessment described above in connection with the nutrition management protocol. When performing the skin and foot assessments, special attention should be paid to areas where pressure ulcers often develop. These areas include the ears/earlobes (including the tops of ears where glasses and nasal cannula may rest), the chin, the back of the head, the shoulder blades, the elbows, the spine, the hip bones, the tail bone, the hips, the buttocks, the knees, the pelvis, the ankles, and the heels.

Based upon the pressure triggers present and the results of the skin and foot assessment, within 24-48 hours, one or more of the bed guidelines, chair guidelines, and/or foot care guidelines 148 is started. If the patient exhibits pressure triggers corresponding to high-risk feet or has diabetes, foot care guidelines should be initiated. If any other pressure triggers are present bed guidelines and chair guidelines should be initiated.

The bed guidelines include the use of a special mattress, a repositioning schedule corresponding to when the patient is repositioned (preferably every 2 hours or as necessary), and keeping the head of the bed as low as possible (at an angle of 30 degrees or less). The bed guidelines further include the use of pillows or foam wedges to keep bony prominences, such as knees and ankles, from direct contact with each other, devices which relieve pressure on the heals, and the use of a “hand check” to insure that the mattress is not “bottoming out” (i.e. providing less than an inch of support material).

The chair guidelines are similar to the bed guidelines, and include the use of a special chair cushion, a repositioning schedule where the patient is periodically repositioned (preferably every hour or as necessary), positioning the patient to avoid sliding, and teaching the patient to shift self.

The foot care guidelines include daily removal of all coverings and inspections of the patient's feet including the heels and between the toes, the use of lotion or creams on the feet at regular intervals, reporting and treating the presence of other foot ailments including swelling, blisters, bruises, discolorations, breaks, rashes, etc.

More specifically, in connection with the foot care guidelines, the patient's feet should be washed every day with a mild soap and warm water (do not use hot water), rinsed and dried well, especially between and under the toes. A rich moisturizing lotion or cream should be used 1 to 2 times a day (do not use the cream between the toes), and the feet inspected every day. The feet should not be soaked for long periods or the patient permitted to go barefoot or walk on hot sand or pavement. Any injury, skin changes, open wounds, dryness, cracks, blisters, rashes, discolorations between the toes, redness over pressure points, calluses, and foreign bodies should be looked for and reported. If any condition is observed, an order for immediate evaluation by the physician or specialist, such as a podiatrist or foot/ankle orthopedic surgeon should be obtained. Until the physician or specialist sees the patient and orders treatment, any wounds should be cleansed with normal saline, and covered with a dry sterile dressing.

When treating calluses, the corners of the calluses should be gently filed leaving some of the callus, while being careful not to break the skin.

When caring for the nails, low-risk patients should be encouraged to file rather than cut their own nails. The nails should be filed to match the shape of the toe, until all sharp edges are smooth. The smoothness of the nail should be checked with the tip of a finger. High-risk patients or those unable to perform self-care should see the podiatrist or foot/ankle orthopedic surgeon every two to three months for nail care.

The patient should wear clean white cotton socks without seams. All footwear, including house slippers, should have thick, cushioned, protective soles. Shoes with pointed toes and high heels should not be worn.

During days 2-7 of the pressure management protocol, skin assessments are performed daily (generally just for new patients) 150, as well as the continuation of the applicable bed, chair and foot care guidelines 152. Each week, a skin reassessment is performed, and a determination is made whether the skin is intact 154.

If the skin is intact, 156 current bed, chair and foot care guidelines, and weekly skin assessments are continued and the protocol is periodically reassessed as necessary, and the Minimum Data Set (MDS) completed as indicated.

If the skin is not intact, skin breakdown should be assessed and documented, support surfaces and care guidelines reevaluated, the attending physician notified, specialists consulted as necessary, a new plan should be developed based upon the reassessment and implemented daily 158. Additionally, the protocol should be reevaluated quarterly or as necessary, and the Minimum Data Set (MDS) completed as indicated 158.

FIGS. 6A-6B illustrate a suitable form for use in the management and record keeping of the patient's progress in regards to the pressure management protocol 140.

By implementing one or more of the targeted protocols illustrated in FIGS. 2-6, a targeted pressure ulcer prevention program can be created which is implemented when the treatment program is likely to be effective in reducing the patient's susceptibility to developing a pressure ulcer based on an observed deficiency in the patient's present status. This enables the cost associated with implementing the program including the increased level of intrusiveness to the patient to be balanced with the benefits derived from the corresponding reduction in the likelihood of developing a pressure ulcer.

As an additional tool in assisting the facility in making effective implementation choices, an economic model is provided which evaluates the financial costs for implementing a particular pressure ulcer prevention protocol.

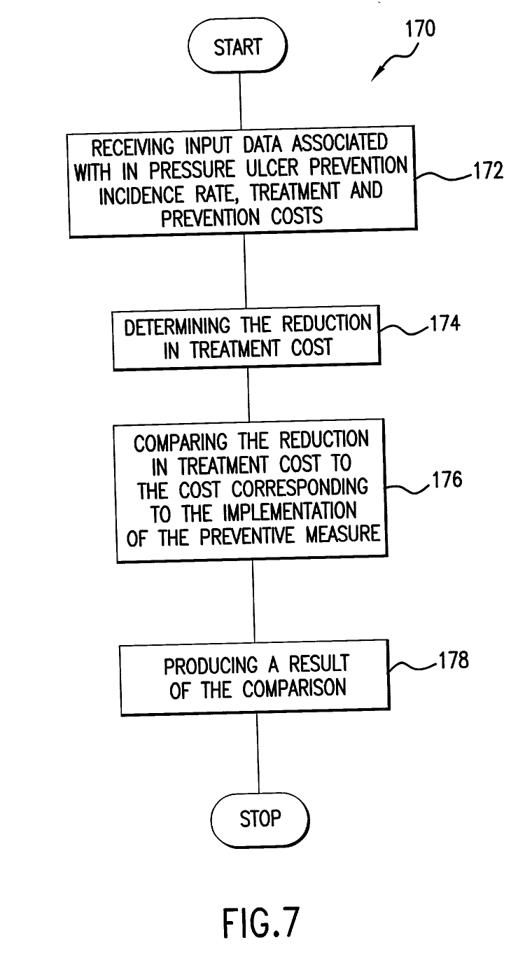

A flow diagram of the economic model 170 is illustrated in FIG. 7. The economic model 170 allows default data, data specific to a particular facility, or a combination thereof to be input into the model for the determination of the anticipated costs for implementing a particular pressure ulcer prevention protocol in a particular facility. More specifically the model provides for receiving input data 172, including the incidence rate of pressure ulcers among the current patients, the average costs for treating a pressure ulcer, the costs for implementing a pressure ulcer prevention program, and the rate at which the program is likely to reduce the occurrence of pressure ulcers.

After receiving the input data and the type of preventive measure to be implemented, the economic model determines the anticipated reduction in treatment cost by determining the number of pressure ulcers which will likely be prevented, and multiplies this number by the average cost for treating a pressure ulcer 174. The number of pressure ulcers which will likely be prevented is determined by computing the difference between the incidence rate of developing a pressure ulcer without implementing the preventative measure and the anticipated incidence rate of developing a pressure ulcer after implementing the preventative measure, and multiplying the difference in the incidence rate by the total number of residences.

The anticipated reduction in treatment cost can further be adjusted to take into account the pressure ulcers which still occur but are reduced in severity as a result of implementation of the preventative measure and any reduced treatment cost resulting therefrom. As previously noted in the background of the invention, at least one study has reported a reduction of 20 percent in healing times based upon the implementation of nutrition support (Van Risjwijk et al., 1994). Correspondingly, a more conservative estimate of a 15 percent reduction is very realistic, when all prevention protocols disclosed herein are implemented.

The reduction in treatment cost is then compared 176 against the cost for implementing the preventative measure to determine the overall financial cost to the facility. The result of the comparison is then produced for the user 178.

The cost for implementing the preventative measure, determined by the economic model, includes such factors as anticipated training costs, supply costs, and labor costs. Training costs are largely incurred up front when initiating a new preventative measure. Thereafter training costs tend to be limited to the costs of training new employees as they are hired. Supply costs correspond to materials and supplies consumed during implementation of the preventative measure. Labor costs are associated with the labor rates of the person performing each of the tasks associated with implementation of the preventative measure multiplied by the time required to perform the task and the frequency with which the task needs to be performed. To determine the total labor costs, the costs associated with each task of the preventative measure are added together.

In connection with producing the results for the user, a break even cost point could be provided assuming certain inputs are fixed. Furthermore the computed costs could be reported as a range of values.

The economic model provides a default setting for most input variables including the amount of the anticipated reduction in the incidence rate of pressure ulcers. The default setting for the anticipated reduction for a particular preventative measure will be determined based on the empirical results obtained from the pressure ulcer study noted above. As more data from the above noted study or other studies becomes available, these numbers could be further updated to incorporate the results obtained from the larger set of data.

In the absence of specific data received, the program includes default values based on predetermined averages. The default values can be further adjusted by a more specific default set taking into account one or more factors specific to a particular facility like the location, or type of facility. For example one of the factors which contributes to the cost of implementing a preventative measure is the labor rate, which may vary based on the type of community and the geographical region where the facility is located. A default set consistent with the appropriate parameters can be used or the user can supply facility specific data more closely analogous with the actual costs.

While in many instances the user will make use of default values provided by the system, the model enables the user to replace one or more default values with alternative user defined values. In this way, the economic model can be tailored to more accurately reflect the actual experiences of a particular facility.

In at least one embodiment the economic model is implemented, at least in part, by programming instructions being executed upon a computer system. FIG. 7 illustrates an example of one such computer system 200. The exemplary computer system 200 includes a processing unit 202, data input devices, and data output devices. In the exemplary computer system the processing unit 202 includes a programable processor, one or more data storage devices, an interface for receiving input data, and an interface for supplying output data.

The data storage devices includes such devices as memory devices and fixed or removable auxiliary storage devices. The data storage devices can be used for storing program instructions and program data.

The input devices include such devices as a keyboard 204, and a mouse 206. Other types of input devices could include a touch screen, a microphone, a sensor, or any other device by which input data can be received by a computer system. The output devices include such devices as a computer display 208, and a printer 210. Similarly, the output devices could additionally include any other types of devices by which output data can be supplied by a computer system.

In addition to implementing at least in part the economic model, the computer system preferably includes a patient care management program. The patient care management program enables a care giver to input data concerning the present status and medical histories of one or more patients. The patient care management program then preferably processes the data, compares the processed data with the plurality of predetermined triggers, and identifies which ones of the one or more protocols should be executed in connection with a particular patient.

Furthermore the patient care management program can manage the progress of the patient with respect to each of the protocols, wherein the patient care management program prompts the appropriate care giver when tasks need to be performed, or additional information from the patient obtained.

For example in connection with the nutrition management protocol, the patient care management program would prompt the care giver to obtain a weight measurement for the patient on a weekly basis, and would determine if the patient has experienced sufficient weight loss to warrant further investigation. Similar analysis is preferably performed in connection with the other protocols.

By implementing at least portions of the management of one or more protocols within a computer system, the implementation and management of the patient's care can be greatly simplified and handled in a cost effective manner.

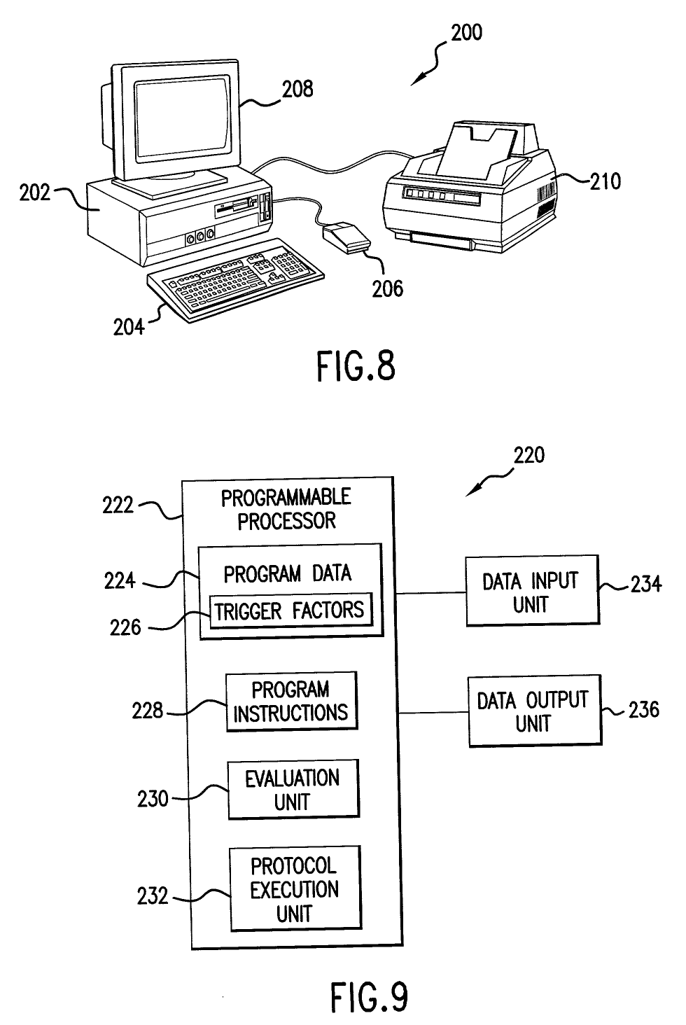

FIG. 9 illustrates a schematic diagram 220 corresponding to the system 200 illustrated in FIG. 8. The schematic diagram 220 includes a programmable processor 222. In the illustrated embodiment, the programmable processor 222 comprises program data 224 including one or more triggers 226, and program instructions 228 for executing one or more programs in connection with the economic model and the patient care management program. The program data 224 and program instructions 228, are preferably implemented in the above noted memory devices and/or on fixed or removable auxiliary storage devices. The programmable processor 222 preferably further comprises an evaluation unit 230 for managing the execution of the economic model, and one or more protocol execution units 232 for managing the execution of the one or more protocols.

The programmable processor is coupled to a data input unit 234 comprising one or more data input devices. The programmable processor is further coupled to a data output unit 236 comprising one or more data output devices.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed:

1. A process for reducing the cost associated with providing patient care including the costs associated with the prevention and treatment of pressure ulcers comprising:
reviewing the present status and medical history of a patient;
evaluating the presence of one or more triggers;
matching each of the triggers with a plurality of protocols;
performing one or more protocols, dependent upon each of the triggers matched;
monitoring the ongoing status of the patient and determining any change therein; and
adjusting the performance of the one or more protocols.

2. A process as in claim 1 wherein said triggers include at least one of a recent history of a pressure ulcer, diabetes, use of diuretics, cognitive loss, a requirement for extensive assistance in activities of daily living, compromised nutritional status, problems with chewing or swallowing, dehydration, excessive moisture problems, urinary incontinence, having skin that is desensitized to pain or pressure, being completely immobile or having very limited mobility, and use of physical restraints.

3. A process as in claim 2 wherein said triggers corresponding to said recent history of a pressure ulcer include having had a pressure ulcer within the last ninety days.

4. A process as in claim 2 wherein said triggers corresponding to the requirement for extensive assistance in activities of daily living include extensive assistance for bed mobility, transferring, using a toilet, and eating.

5. A process as in claim 2 wherein said triggers corresponding to urinary incontinence include bowel and/or bladder incontinence, the use of an external containment device, and the use of an internal catheter.

6. A process as in claim 2 wherein said triggers corresponding to compromised nutritional status include weight loss greater than or equal to five percent in the last thirty days, weight loss greater than or equal to ten percent in the last one hundred and eighty days, and the patient leaves twenty-five percent or more of food uneaten at most meals.

7. A process as in claim 1 wherein reviewing the present status of the patient includes at least one of gathering patient statistics, monitoring the activity of the patient, and obtaining opinions concerning the patient from other care providers.

8. A process as in claim 7 wherein gathering patient statistics includes at least one of obtaining the weight of the patient and maintaining a bowel and bladder diary.

9. A process as in claim 7 wherein monitoring the activity of the patient includes monitoring the level of daily living assistance required and monitoring the continence activity of the patient.

10. A process as in claim 1 wherein performing one or more protocols includes at least one of educating the patient or family, adjusting the nutrition provided to the patient, insuring convenient access for use of necessary facilities, and providing reminders and assistance for performing certain tasks.

11. A process as in claim 1 wherein said one or more protocols include a nutrition management protocol, an incontinence prevention protocol, an incontinence management protocol and a pressure management protocol.

12. A process as in claim 11 wherein performing a pressure management protocol includes performing one or more of bed guidelines, chair guidelines, a skin care procedure, and foot care guidelines.

13. A process as in claim 1 wherein reviewing the present status and medical history includes an initial review of the patient within 24 to 48 hours of admission, and daily review of the patient through approximately the first week.

14. A process as in claim 13 wherein the daily review of the patient includes monitoring the oral status, swallowing and feeding capabilities of the patient.

15. A process as in claim 13 wherein the daily review of the patient includes monitoring the continence status of the patient.

16. A process as in claim 13 wherein the daily review of the patient includes performing daily skin assessments.

17. A process as in claim 13 wherein reviewing the present status and medical history further includes, at approximately day 7, reviewing the ability of the patient to control and cooperate with toileting and wherein performing one or more protocols includes a toileting program based upon the ability of the patient.

18. A process as in claim 1 wherein monitoring the ongoing status of the patient includes weekly monitoring and reassessment of the patient after the initial week of review.

19. A process as in claim 18 wherein the weekly monitoring and reassessment includes obtaining weight measurements of the patient.

20. A process as in claim 19 wherein obtaining weight measurements of the patient occurs starting at approximately day 7, and approximately every 7 days thereafter.

21. A process as in claim 19 wherein the weekly monitoring and reassessment includes determining weight loss, if any, and if the patient loses weight, adjusting the performance of the one or more protocols to include additional nutritional supplements.

22. A process as in claim 21 wherein the additional nutritional supplements include at least one of a daily vitamin supplement, a standard medical nutritional supplement, a daily snack, and nutritional formula via tube feeding.

23. A process as in claim 18 wherein the weekly monitoring and reassessment includes reassessing the incontinence status and skin integrity of the patient.

24. A process as in claim 23 wherein if the incontinent status of the patient changes the performance of the one or more protocols is adjusted to alter the toileting program based on the change in the incontinent status of the patient.

25. A process as in claim 18 wherein the weekly monitoring and reassessment includes reassessing the skin condition of the patient.

26. A process as in claim 25 wherein if the skin in not intact the performance of the one or more protocols is adjusted to document and treat the skin breakdown.

27. A process for reducing the risk of developing pressure ulcers comprising:
reviewing the present status and medical history of a patient;
supplying the information associated with the present status and medical history to a risk evaluation unit including;
evaluating the presence of one or more triggers;
matching each of the triggers with one or more protocols;
performing one or more protocols dependent upon each of the triggers matched;
generating a report including an intervention schedule;
monitoring the ongoing status of the patient and determining any change therein;
supplying at least a portion of the additional information associated with the ongoing status to the risk-evaluation unit; and
adjusting the performance of the one or more protocols.

28. A process as in claim 27 wherein said triggers include at least one of a recent history of a pressure ulcer, diabetes, a use of diuretics, cognitive loss or dementia, a requirement for extensive assistance in activities of daily living, compromised nutritional status, problems with chewing or swallowing, dehydration, excessive moisture problems, urinary incontinence, having skin that is desensitized to pain or pressure, being completely immobile or having very limited mobility, and a use of physical restraints.

29. A process as in claim 28 wherein said triggers corresponding to said recent history of a pressure ulcer include having had a pressure ulcer within the last ninety days.

30. A process as in claim 28 wherein said triggers corresponding to the requirement for extensive assistance in activities of daily living include extensive assistance for bed mobility, transferring, using a toilet, and eating.

31. A process as in claim 28 wherein said triggers corresponding to urinary incontinence include bowel and/or bladder incontinence, the use of an external containment device, and the use of an internal catheter.

32. A process as in claim 28 wherein said triggers corresponding to compromised nutritional status include weight loss greater than or equal to five percent in the last thirty days, weight loss greater than or equal to ten percent in the last one hundred and eighty days, and the patient leaves twenty-five percent or more of food uneaten at most meals.

33. A process as in claim 27 wherein reviewing the present status of the patient includes at least one of gathering patient statistics, monitoring the activity of the patient, and obtaining opinions concerning the patient from other caregivers.

34. A process as in claim 33 wherein gathering patient statistics includes at least one of obtaining the weight of the patient and maintaining a bowel and bladder diary.

35. A process as in claim 33 wherein monitoring the activity of the patient includes monitoring the level of daily living assistance required and monitoring the continence activity of the patient.

36. A process as in claim 27 wherein performing one or more protocols includes at least one of educating the patient or family, adjusting the nutrition provided to the patient, insuring convenient access for use of necessary facilities, and providing reminders and assistance for performing periodic tasks.

37. A process as in claim 27 wherein said one or more protocols include a nutrition management protocol, an incontinence prevention protocol, an incontinence management protocol and a pressure management protocol.

38. A process as in claim 37 wherein performing a pressure management protocol includes performing one or more of bed guidelines, chair guidelines, a skin care procedure, and foot care guidelines.

39. A process as in claim 27 wherein said intervention schedule includes instructions for providing patient care, and prompts for receiving additional status information.

40. A process for reducing the risk of developing pressure ulcers comprising:
reviewing the present status and medical history of a patient;
supplying the information associated with the present status and medical history to a risk evaluation unit;
evaluating the presence of one or more nutrition management protocol triggers;
performing a nutrition management protocol in the event one or more nutrition management protocol triggers are present, the nutrition management protocol comprising:
generating an output report providing a prompt for additional status information of a patient including obtaining a periodic weight measurement of the patient, and the identification of any contraindications to liberalizing fluid intake;
generating a further output report including instructions for providing additional fluids to the patient, if no contraindications to liberalizing fluid intake exist;
monitoring the additional status information; and
in the event of unintentional weight loss, adjusting the performance of the nutrition management protocol and the output report to include instructions for providing additional nutritional supplement.

41. A process as in claim 40 wherein the nutrition management protocol triggers include at least one of a recent history of a pressure ulcer, compromised nutritional status, a requirement for extensive assistance in eating, problems with chewing or swallowing, and dehydration.

42. A process as in claim 41 wherein said triggers corresponding to said recent history of a pressure ulcer includes having had a pressure ulcer within the last 90 days.

43. A process as in claim 40 wherein reviewing the present status of the patient further includes a review of the patient by a registered dietitian.

44. A process as in claim 40 wherein the nutrition management protocol further includes providing instructions for a daily multivitamin/mineral supplement.

45. A process as in claim 40 wherein monitoring the additional status of the patient includes monitoring for poor patient eating intake.

46. A process as in claim 40 wherein the additional nutritional supplement is one of a high-calorie/high-protein supplement and a disease specific supplement.

47. A process as in claim 40 wherein the additional nutritional supplement is supplied via tube feeding.

48. A process for reducing the risk of developing pressure ulcers comprising:
reviewing the present status and medical history of a patient;
supplying the information associated with the present status and medical history to a risk evaluation unit;
evaluating the presence of one or more incontinence prevention protocol triggers;
performing an incontinence prevention protocol in the event one or more incontinence prevention protocol triggers are present, the incontinence prevention protocol comprising:
generating an output report for providing a prompt for additional status information of a patient including the presence of any barriers to toileting access, and the present medications of the patient;
generating a further output report including instructions for providing adequate fluids, insuring convenient access for use of necessary facilities, and implementing measures to normalize stool consistency;
monitoring the additional status information; and
adjusting as necessary the performance of the incontinence prevention protocol, based on the monitoring of the additional status.

49. A process as in claim 48 wherein the incontinence prevention protocol triggers include at least one of cognitive loss, a requirement for extensive assistance in using a toilet, a use of diuretics, and trunk or limb restraint of the patient.

50. A process for reducing the risk of developing pressure ulcers comprising:
reviewing the present status and medical history of a patient;
supplying the information associated with the present status and medical history to a risk evaluation unit;
evaluating the presence of one or more incontinence management protocol triggers;
performing an incontinence management protocol in the event one or more incontinence management protocol triggers are present, the incontinence management protocol comprising:
generating an output report providing a prompt for additional status information including known transient causes of bowel and bladder incontinence, and further bowel or bladder incontinence;
generating a further output report including instructions for initiating an incontinence skin care procedure, and instructions for treating any transient causes of bowel and bladder incontinence;
monitoring the additional status information; and
if significant bowel or bladder incontinence is continuing to occur, providing instructions for developing a suitable toileting procedure.

51. A process as in claim 50 wherein the incontinence management protocol triggers include at least one of bowel or bladder incontinence, the use of external containment devices, and the use of internal catheters.

52. A process as in claim 50 wherein the incontinence management protocol further includes generating instructions for initiating external catheter/external containment device guidelines.

53. A process as in claim 50 wherein said suitable toileting procedure includes:
generating a prompt for additional information on a patient including determining whether the patient can toilet without help, the patient is able to recognize the need to use the toilet, whether the patient is dry at least once per twelve-hour period, and the patient can cooperate with toileting;
if the patient can toilet without help, is able to recognize the need to use the toilet, is dry at least once per 12-hour period, and can cooperate with toileting, starting a bowel and bladder retraining program;
if the patient cannot toilet without help, can recognize the need to use the toilet, is dry at least once per 12-hour period, and can cooperate with toileting, start prompted toileting program;
if the patient cannot toilet without help, cannot recognize the need to void, is dry at least once per twelve-hour period and can cooperate with toileting, start scheduled toileting program; and
if the patient cannot toilet without help, cannot recognize the need to void, is mostly wet, and cannot cooperate with toileting, start check and change toileting program.

54. A process for reducing the risk of developing pressure ulcers comprising:
reviewing the present status and medical history of a patient;
supplying the information associated with the present status and medical history to a risk evaluation unit;
evaluating the presence of one or more pressure management protocol triggers;
performing a pressure management protocol in the event one or more pressure management protocol triggers are present, the pressure management protocol comprising:
generating an output report including instructions for performing a skin assessment and a foot examination of the patient and a prompt for additional status information associated therewith;
generating a further output report including instructions for executing a treatment procedure including one or more of bed guidelines, chair guidelines, a skin care procedure, and foot care guidelines;
monitoring the additional status information;
updating as necessary the treatment procedure, based on the monitoring of the additional status.

55. A process as in claim 54 wherein the pressure management protocol triggers include at least one of a recent history of a pressure ulcer, diabetes, a requirement for extensive assistance in bed mobility or transferring of the patient, functional limitation in range of motion of the patient, complete immobility, trunk or limb restraint, skin desensitized to pain or pressure, excessive moisture problems, the use of external containment devices, and the use of internal catheters.

56. A process as in claim 54 wherein the skin care procedure is implemented, if during the skin assessment, the patient is determined to have a high risk skin assessment.

57. A process as in claim 54 wherein the foot care guidelines are implemented, if during the foot examination, the patient is determined to have high risk feet.

58. A process as in claim 54 wherein the bed guidelines include repositioning the patient every two hours.

59. A process as in claim 54 wherein the chair guidelines include repositioning the patient every hour.

60. A system for reducing the risk of developing pressure ulcers comprising:
one or more input devices for receiving data associated with the present status and medical history of a patient;
a storage device for storing the received data and predetermined triggers;
a processing unit including:
processing circuitry for processing the received data;
comparison circuitry for comparing the processed data with a plurality of predetermined triggers; and
one or more protocol execution units, which are selectively activated by the presence of one or more corresponding triggers; and
one or more output devices for generating one or more reports including instructions for providing patient care, and prompts for receiving additional status information.

61. A system as in claim 60 wherein one or more input devices includes one or more of a keyboard, a mouse, a microphone, a touch screen, and sensors.

62. A system as in claim 60 wherein one or more output devices includes one or more of a display and a printer.

63. A system as in claim 60 wherein the storage device includes one or more of a memory and auxiliary storage unit.

64. A system as in claim 60 wherein the processing unit includes a programmable processor and instructions for execution within the programmable processor.

65. A system as in claim 60 wherein said prestored triggers include at least one of a recent history of a pressure ulcer, diabetes, a use of diuretics, cognitive loss, a requirement for extensive assistance in activities of daily living, compromised nutritional status, problems with chewing or swallowing, dehydration, excessive moisture problems, urinary incontinence, having skin that is desensitized to pain or pressure, being completely immobile or having very limited mobility, and a use of physical restraints.

66. A system as in claim 65 wherein said triggers corresponding to said recent history of a pressure ulcer include having had a pressure ulcer within the last ninety days.

67. A system as in claim 65 wherein said triggers corresponding to the requirement for extensive assistance in activities of daily living include extensive assistance for bed mobility, transferring, using a toilet, and eating.

68. A system as in claim 65 wherein said triggers corresponding to urinary incontinence include bowel and/or bladder incontinence, the use of an external containment device, and the use of an internal catheter.

69. A system as in claim 65 wherein said triggers corresponding to compromised nutritional status include weight loss greater than or equal to five percent in the last thirty days, weight loss greater than or equal to ten percent in the last one hundred and eighty days, and the patient leaves twenty-five percent or more of food uneaten at most meals.

70. A system as in claim 60 wherein said one or more protocol execution units include a nutrition management protocol execution unit, an incontinence prevention protocol execution unit, an incontinence management protocol execution unit and a pressure management protocol execution unit.

71. A system as in claim 70 wherein said pressure management protocol execution unit includes one or more of a bed guidelines execution unit, a chair guidelines execution unit, a skin care procedure execution unit, and a foot care guidelines execution unit.

72. A process for reducing the cost associated with providing patient care including the costs associated with the prevention and treatment of pressure ulcers comprising:
providing data to an economic model including the incidence rates of patients developing a pressure ulcer, costs for treating a pressure ulcer, cost associated with implementing a preventative measure, and an adjustment factor to the incidence rate corresponding to implementation of the preventative measure;
wherein the economic model determines the change in treatment costs associated with implementing the preventative measure, compares the change in treatment costs to the cost of implementing the corresponding preventative measure, and produces the results of the comparison.

73. A process as in claim 72 wherein the cost associated with implementing a preventative measure includes at least one of training costs, supply costs, and labor costs.

74. A process as in claim 73 wherein the labor costs is the sum of one or more task labor costs associated with each of the tasks required for implementing the preventative measure, each task labor cost being the product of the labor rate of the individual performing the task, the time required by the individual to perform the task, and the number of times the task needs to be performed.

75. A process as in claim 74 wherein the labor rate of the individual performing the task is identified by the title and/or professional qualifications of the person performing the task.

76. A process as in claim 74 wherein the labor rates are identified geographically, and the particular geographical labor rate is selected based upon the geographical location of the facility implementing the preventative measure.

77. A process as in claim 72 wherein the determination in the change in treatment costs associated with implementing the preventative measure includes the product of the number of patients, the difference between the incidence rate without implementing the preventative measure and the incidence rate implementing the preventative measure, and the cost associated with treating a pressure ulcer.

78. A process as in claim 77 wherein the determination in the change in treatment costs associated with implementing the preventative measure further includes a cost adjustment for the difference in cost associated with treating a determined number of pressure ulcers which still develop, but have a reduction in severity as a result of implementing the preventative measure.

79. A process as in claim 72 wherein the results produced additionally includes a breakeven point.

80. A process as in claim 72 wherein the results produced additionally includes a range of values for the change in the expected costs.

81. A process as in claim 72 wherein the results produced are presented to the user in the form of a report.

82. A process as in claim 72 wherein the economic model is performed in a cost evaluation unit.

83. A process as in claim 82 wherein the cost evaluation unit includes a programmable processor and instruction for execution within the programmable processor.
